(19) United States
(12) Patent Application Publication
(10) Pub. No.: US 2008/0314270 A1
(43) Pub. Date: Dec. 25, 2008

(54) Ink supply amount adjustment method and system for relief printing press

(75) Inventors: Akehiro Kusaka, Noda-shi (JP); Hiromitsu Numauchi, Tsukuba-shi (JP)

Correspondence Address: BIRCH STEWART KOLASCH & BIRCH, PO BOX 747, FALLS CHURCH, VA, 22040-0747, US

(73) Assignee: KOMORI CORPORATION

(21) Appl. No.: 12/213,445

(22) Filed: Jun. 19, 2008

(30) Foreign Application Priority Data
Jun. 21, 2007 (JP) 2007-163378

(51) Int. Cl. B41F 31/02

(52) U.S. Cl. 101/367

(57) ABSTRACT

Provided are an ink supply amount adjustment method and system for a relief printing press which enable a reduction in a burden of the operator by enabling automatic adjustment of an ink fountain key opening degree and an ink fountain roller rotation speed on the basis of the width or the area of a line portion measured in advance, and a reduction in costs by reducing the amount of waste paper to be produced, the relief printing press including: an ink fountain for storing ink; and ink fountain keys and an ink fountain roller for adjusting the amount of ink supplied from the ink fountain. The width of a line portion printed on paper by the relief printing press is measured by a width measuring camera, and the ink fountain key opening degrees and the ink fountain roller rotation speed are controlled on the basis of the obtained line-portion width.

### BACKGROUND OF THE INVENTION

1. Field of the Invention

The present invention relates to an ink supply amount adjustment method and system for a relief printing press.

2. Description of the Related Art

It is known that normal printing products sometimes cannot be produced in a conventional relief printing press because ink spreads to the outside of the printing pattern, or a portion of the pattern is not printed, due to an oversupply or undersupply of ink.

For example, the following printing troubles occur. In a case where the amount of ink to be supplied to a raised portion of a plate is too much, ink spreads outside from the raised portion. On the other hand, in a case where the amount of ink to be supplied is too little, ink is not printed in some portions, or a patchy or thin line is printed.

Accordingly, in the conventional relief printing, it is necessary for the operator to check printing products while repeating printing many times, in order to adjust the opening degree of the ink fountain key and the rotation speed of the ink fountain roller thereby to adjust an ink supply amount.

This leads to a problem that a heavy burden is imposed on the operator. In addition, since adjustment is performed in accordance with the operator's intuition, quality varies and a large amount of waste paper is produced, due to adjustment errors. This leads to another problem, an increase in costs.

### SUMMARY OF THE INVENTION

An object of the present invention is to provide an ink supply amount adjustment method and system for a relief printing press which can reduce a burden of the operator by enabling automatic adjustment of an opening degree of the ink fountain key and the rotation speed of the ink fountain roller according to the width or the area of a line portion obtained in advance, and which can also achieve a reduction in costs by reducing the amount of waste paper produced during the adjustment.

A first aspect of the present invention for achieving the above-described object provides an ink supply amount adjustment method for a relief printing press including an ink storage in which ink is stored, and ink supply amount adjustment means for adjusting the amount of ink to be supplied from the ink storage. The ink supply amount adjustment method comprises: measuring, by using width measurement means, the width of a line portion printed on a print member by the relief printing press; and controlling the ink supply amount adjustment means on the basis of the width of the line portion thus measured.

A second aspect of the present invention provides an ink supply amount adjustment method for a relief printing press including an ink storage in which ink is stored, and ink supply amount adjustment means for adjusting the amount of ink to be supplied from the ink storage. The ink supply amount adjustment method comprises: measuring, by using area measurement means, the area of a printed portion printed on a predetermined section of a printed member by using the relief printing press; and controlling the ink supply amount adjustment means on the basis of the obtained area of the printed portion thus measured.

A third aspect of the present invention for achieving the above-described object provides an ink supply amount adjustment system for a relief printing press including an ink storage in which ink is stored, and ink supply amount adjustment means for adjusting the amount of ink to be supplied from the ink storage. The ink supply amount adjustment system comprises: width measurement means for measuring the width of a line portion printed on a print member by the relief printing press; and control means for controlling the ink supply amount adjustment means on the basis of the width of the line portion measured by the width measurement means.

A fourth aspect of the present invention provides an ink supply amount adjustment system for a relief printing press including an ink storage in which ink is stored, and ink supply amount adjustment means for adjusting the amount of ink to be supplied from the ink storage. The ink supply amount adjustment system comprises: area measurement means for measuring the area of a printed portion printed on a predetermined section of a printed member by using the relief printing press; and control means for controlling the ink supply amount adjustment means on the basis of the area of the printed portion measured by the area measurement means.

By using the ink supply amount adjustment method and system for a relief printing press which are configured as described above, the width of a printed line portion or the area of a printed portion printed in a predetermined range on a print member is measured by the measuring camera or the like, and the amount of ink to be supplied is automatically adjusted on the basis of the measurement result. With this configuration, it is possible to avoid anticipated troubles, for example, that ink spreads to the outside of the printing pattern, and that a portion of the pattern is not printed, due to an oversupply or undersupply of ink. Consequently, it is possible to reduce the burden of the operator, and also to reduce the amount of waste paper to be produced, by preventing errors in manual adjustment.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1(a) is a control block diagram of an ink supply amount control device showing a first embodiment of the present invention;

FIG. 1(b) is a control block diagram of the ink supply amount control device;

FIG. 2 is a control block diagram of each ink fountain key opening degree control device;

FIG. 3 is a control block diagram of each ink fountain roller rotation speed control device;

FIG. 4(a) is an operation flowchart of the ink supply amount control device;

FIG. 4(b) is an operation flowchart of the ink supply amount control device;

FIG. 4(c) is an operation flowchart of the ink supply amount control device;

FIG. 5(a) is an operation flowchart of the ink supply amount control device;

FIG. 5(b) is an operation flowchart of the ink supply amount control device;

FIG. 5(c) is an operation flowchart of the ink supply amount control device;

FIG. 5(d) is an operation flowchart of the ink supply amount control device;

FIG. 6(a) is an operation flowchart of the ink supply amount control device;

FIG. 6(b) is an operation flowchart of the ink supply amount control device.

FIG. 6C is an operation flowchart of the ink supply amount control device;

FIG. 7 is an operation flowchart of the ink supply amount control device;

FIG. 8(a) is an operation flowchart of the ink fountain key opening degree control device;

FIG. 8(b) is an operation flowchart of the ink fountain key opening degree control device;

FIG. 9 is an operation flowchart of the ink fountain roller rotation speed control device;

FIG. 10(a) is a control block diagram of an ink supply amount control device showing a second embodiment of the present invention;

FIG. 10(b) is a control block diagram of the ink supply amount control device;

FIG. 11 is a control block diagram of each ink fountain key opening degree control device;

FIG. 12 is a control block diagram of each ink fountain roller rotation speed control device;

FIG. 13(a) is an operation flowchart of the ink supply amount control device;

FIG. 13(b) is an operation flowchart of the ink supply amount control device;

FIG. 13(c) is an operation flowchart of the ink supply amount control device;

FIG. 14(a) is an operation flowchart of the ink supply amount control device;

FIG. 14(b) is an operation flowchart of the ink supply amount control device;

FIG. 14(c) is an operation flowchart of the ink supply amount control device;

FIG. 14(d) is an operation flowchart of the ink supply amount control device;

FIG. 15(a) is an operation flowchart of the ink supply amount control device;

FIG. 15(b) is an operation flowchart of the ink supply amount control device;

FIG. 15(c) is an operation flowchart of the ink supply amount control device;

FIG. 15(d) is an operation flowchart of the ink supply amount control device;

FIG. 16 is an operation flowchart of the ink supply amount control device;

FIG. 17(a) is an operation flowchart of the ink fountain key opening degree control device;

FIG. 17(b) is an operation flowchart of the ink fountain key opening degree control device;

FIG. 18 is an operation flowchart of the ink fountain roller rotation speed control device;

FIG. 19(a) is a control block diagram of an ink supply amount control device showing a third embodiment of the present invention;

FIG. 19(b) is a control block diagram of the ink supply amount control device;

FIG. 20 is a control block diagram of each ink fountain key opening degree control device;

FIG. 21 is a control block diagram of each ink fountain roller rotation speed control device;

FIG. 22(a) is an operation flowchart of the ink supply amount control device;

FIG. 22(b) is an operation flowchart of the ink supply amount control device;

FIG. 22(c) is an operation flowchart of the ink supply amount control device;

FIG. 23(a) is an operation flowchart of the ink supply amount control device;

FIG. 23(b) is an operation flowchart of the ink supply amount control device;

FIG. 23(c) is an operation flowchart of the ink supply amount control device;

FIG. 23(d) is an operation flowchart of the ink supply amount control device;

FIG. 24(a) is an operation flowchart of the ink supply amount control device;

FIG. 24(b) is an operation flowchart of the ink supply amount control device;

FIG. 24(c) is an operation flowchart of the ink supply amount control device;

FIG. 25 is an operation flowchart of the ink supply amount control device;

FIG. 26(a) is an operation flowchart of the ink fountain key opening degree control device;

FIG. 26(b) is an operation flowchart of the ink fountain key opening degree control device;

FIG. 27 is an operation flowchart of the ink fountain roller rotation speed control device;

FIG. 28(a) is a control block diagram of an ink supply amount control device showing a fourth embodiment of the present invention;

FIG. 28(b) is a control block diagram of the ink supply amount control device;

FIG. 29 is a control block diagram of each ink fountain key opening degree control device;

FIG. 30 is a control block diagram of each ink fountain roller rotation speed control device;

FIG. 31(a) is an operation flowchart of the ink supply amount control device;

FIG. 31(b) is an operation flowchart of the ink supply amount control device;

FIG. 31(c) is an operation flowchart of the ink supply amount control device;

FIG. 32(a) is an operation flowchart of the ink supply amount control device;

FIG. 32(b) is an operation flowchart of the ink supply amount control device;

FIG. 32(c) is an operation flowchart of the ink supply amount control device;

FIG. 32(d) is an operation flowchart of the ink supply amount control device;

FIG. 33(a) is an operation flowchart of the ink supply amount control device;

FIG. 33(b) is an operation flowchart of the ink supply amount control device;

FIG. 33(c) is an operation flowchart of the ink supply amount control device;

FIG. 34 is an operation flowchart of the ink supply amount control device;

FIG. 35(a) is an operation flowchart of the ink fountain key opening degree control device;

FIG. 35(b) is an operation flowchart of the ink fountain key opening degree control device;

FIG. 36 is an operation flowchart of the ink fountain roller rotation speed control device;

FIG. 37 is a view showing a main part of an ink supply device in a printing unit of each color;

FIG. 38(a) is an explanatory view of image judgment;

FIG. 38(b) is an explanatory view of image judgment; and

FIG. 38(c) is an explanatory view of image judgment.

### DETAILED DESCRIPTION OF THE INVENTION

An ink supply amount adjustment method and system for a relief printing press according to the present invention will be described below in detail on the basis of embodiments with reference to the drawings.

### First Embodiment

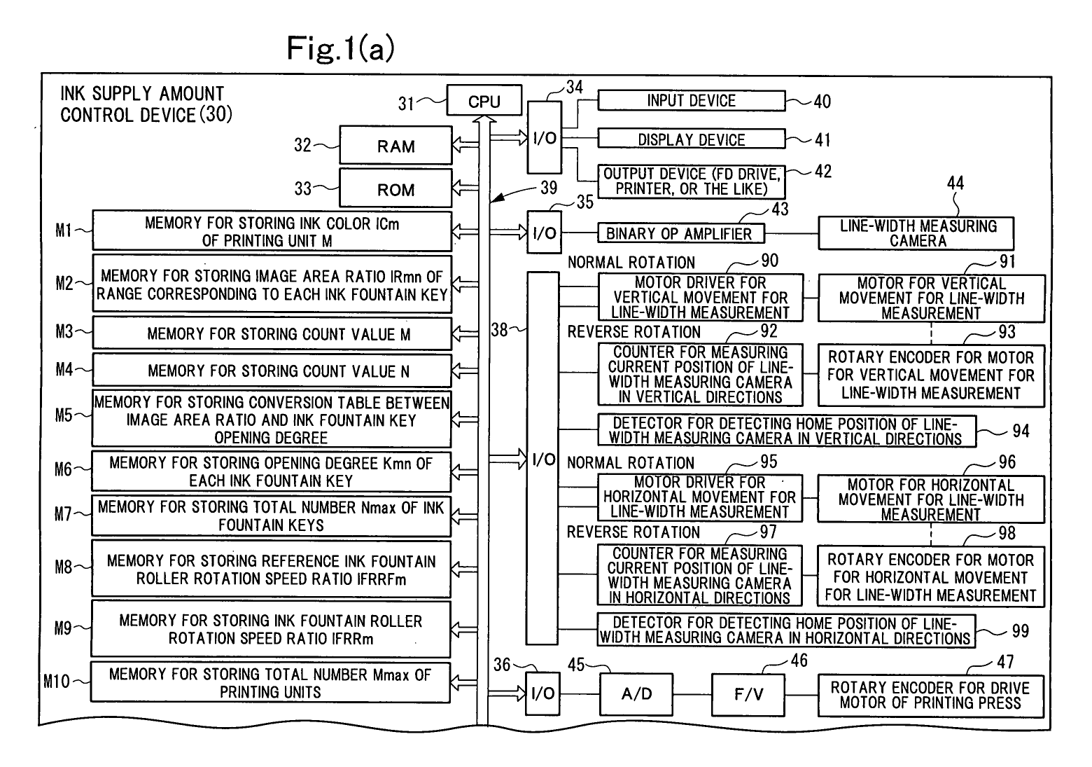

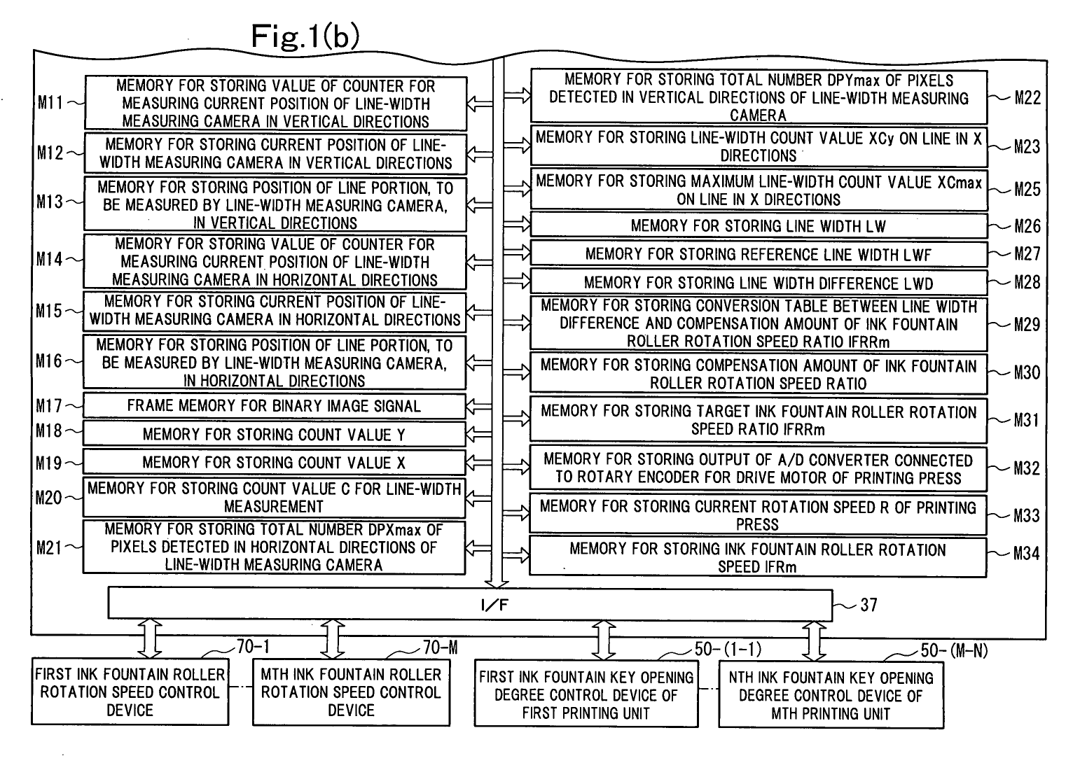

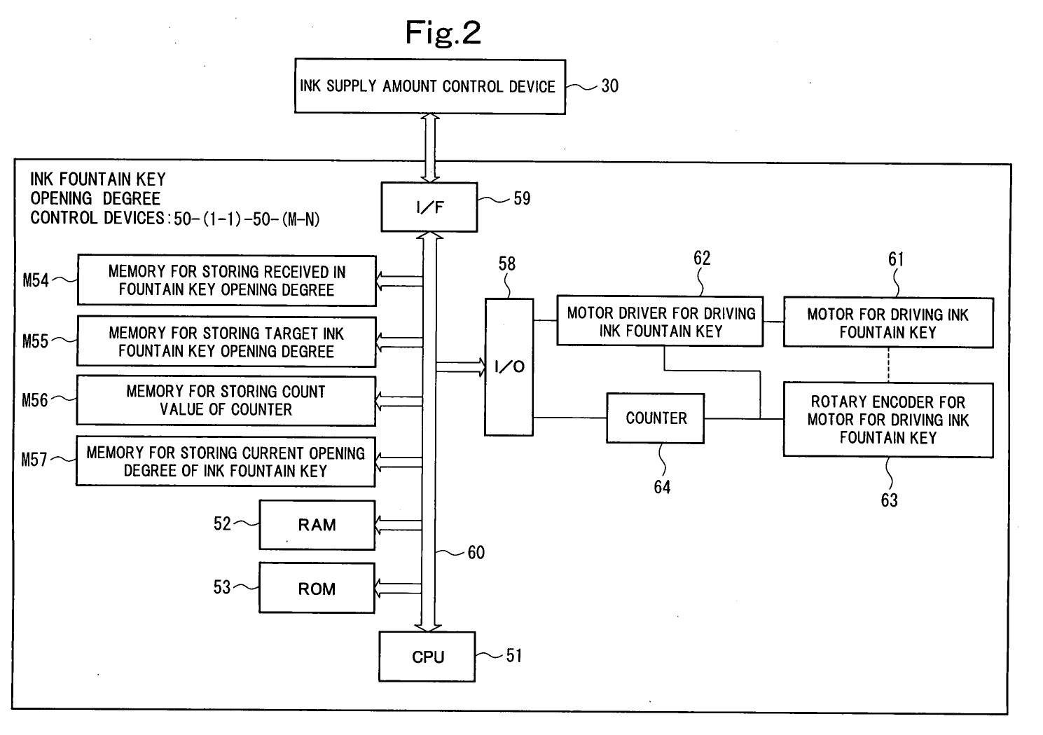

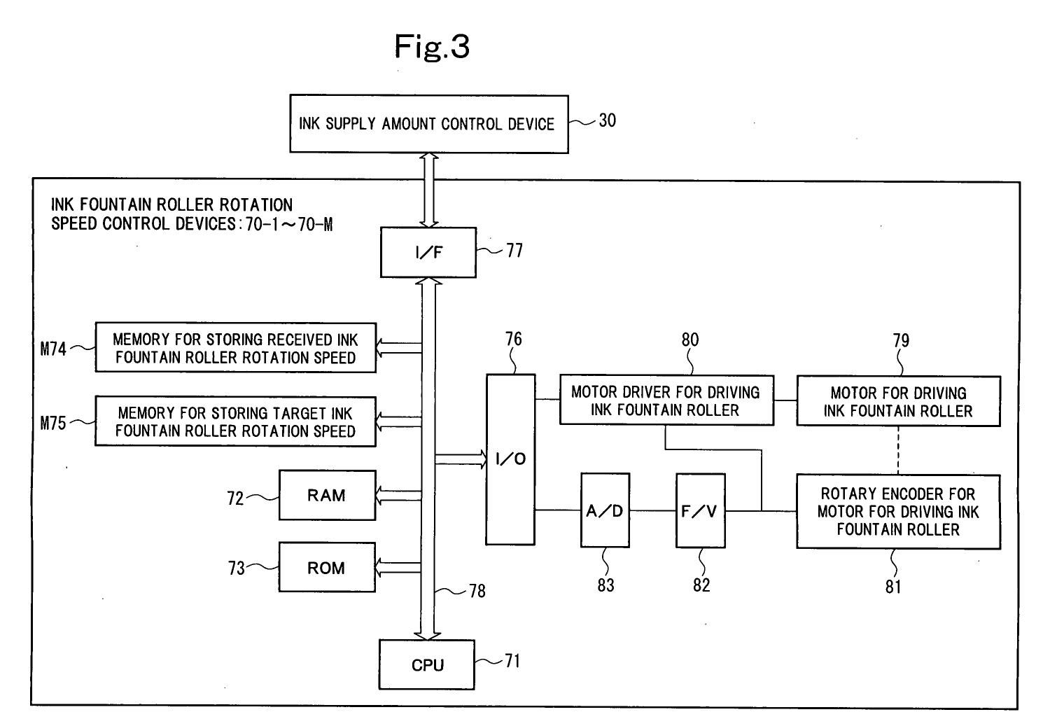

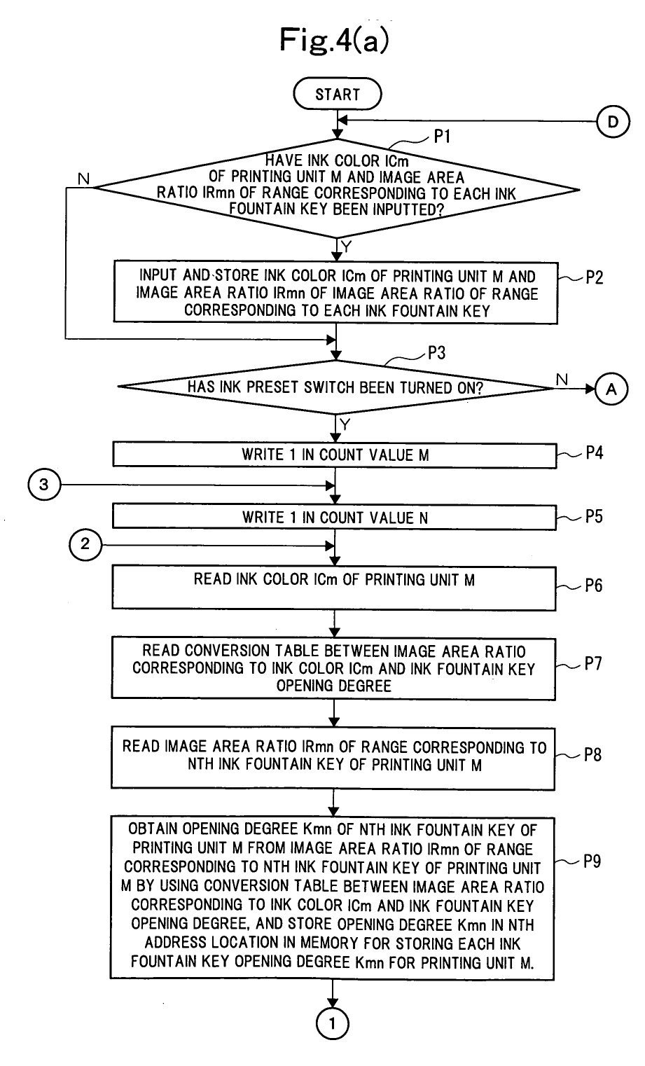

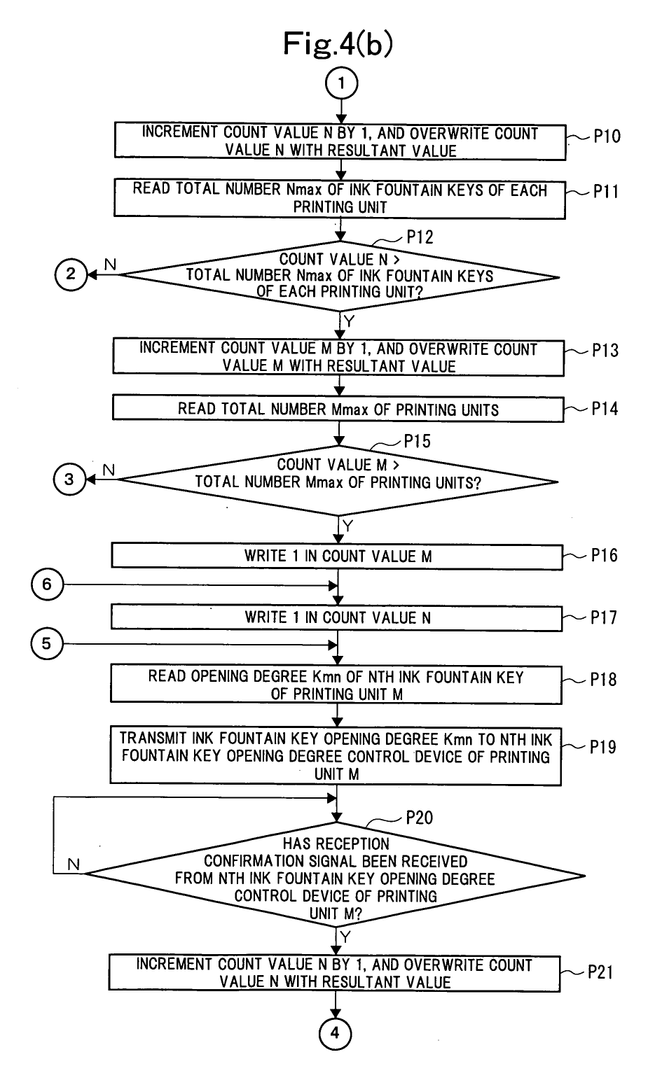

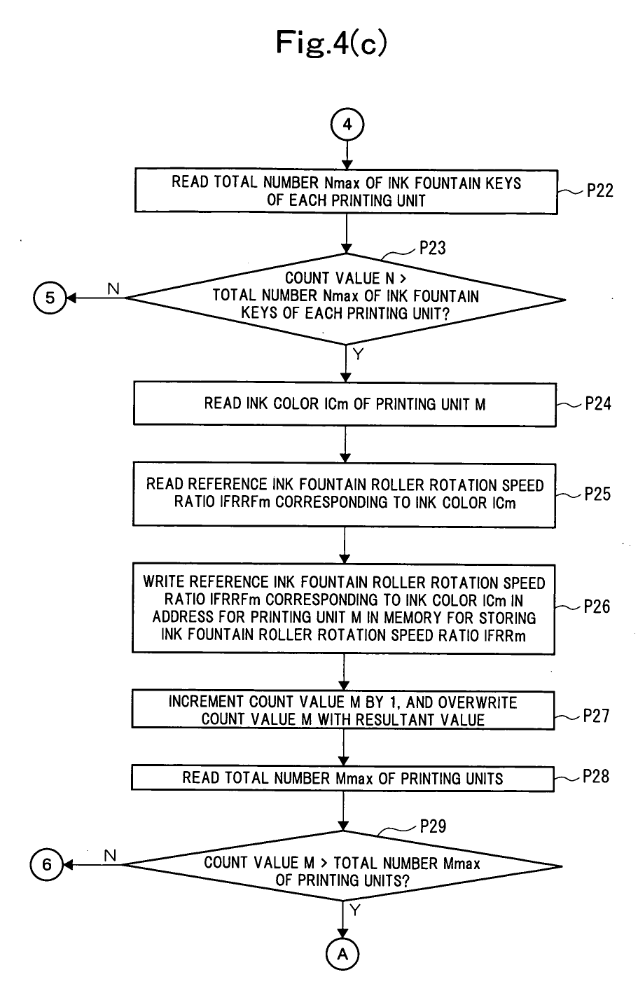

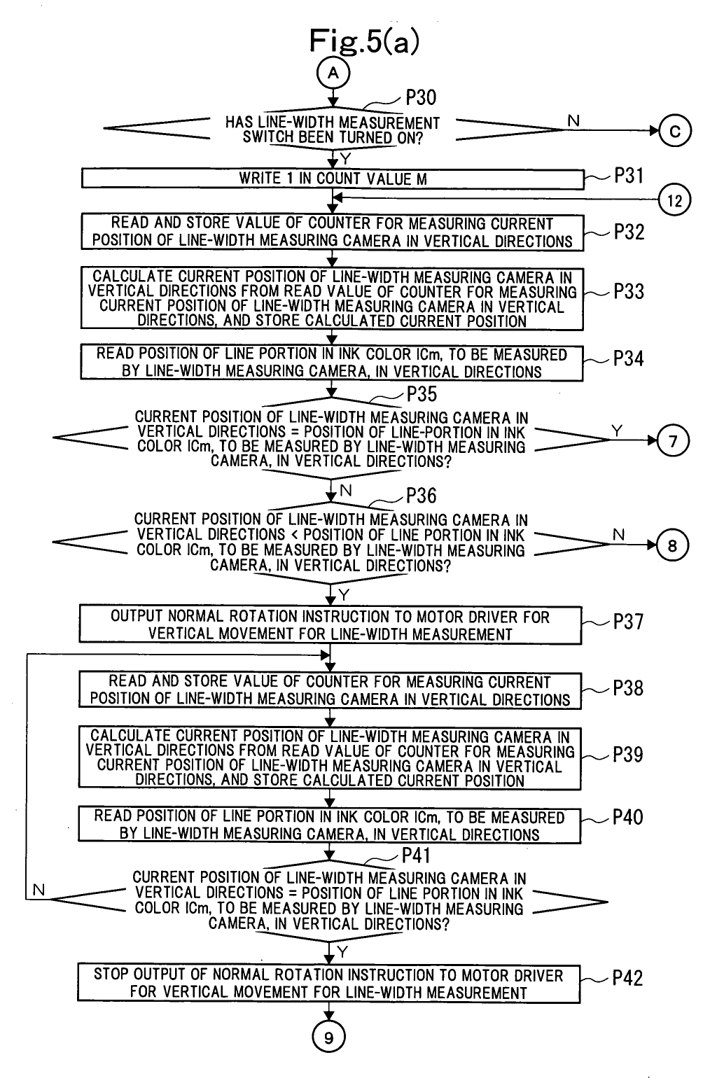

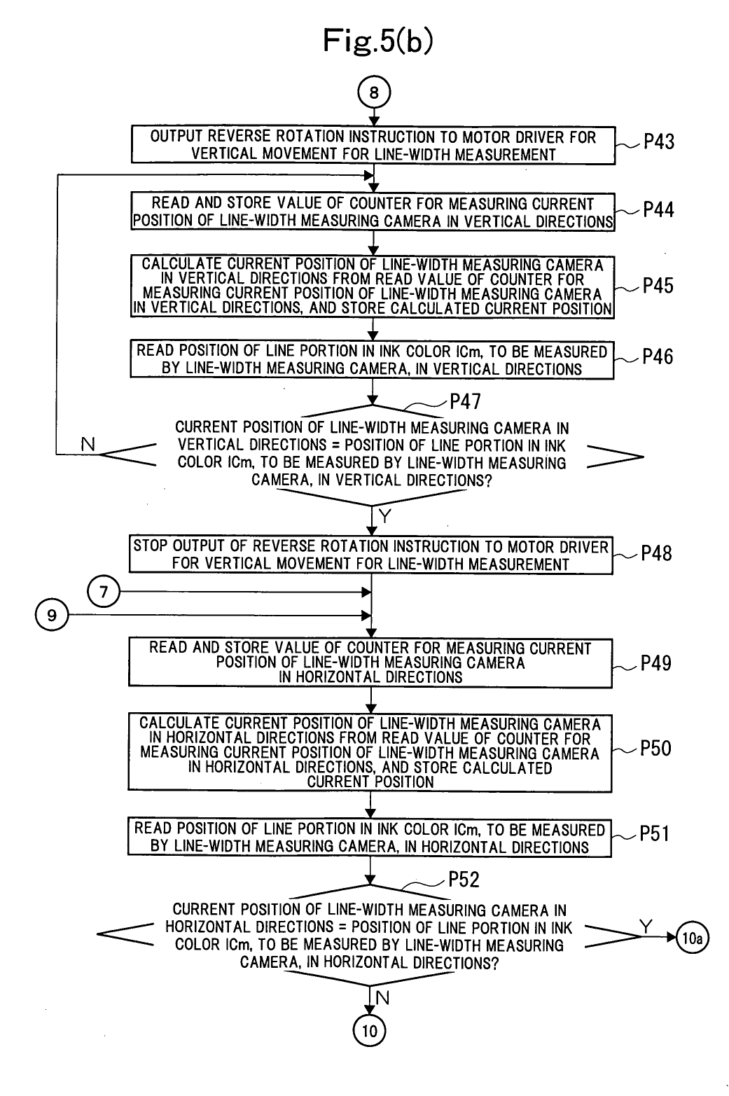

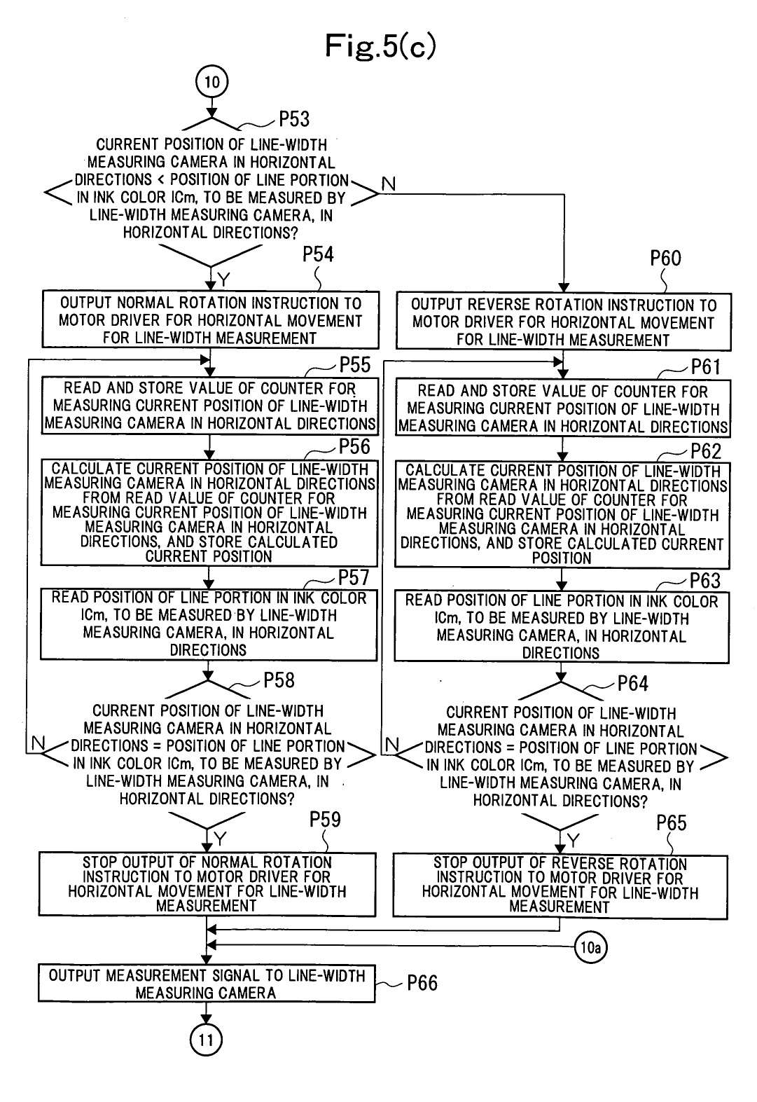

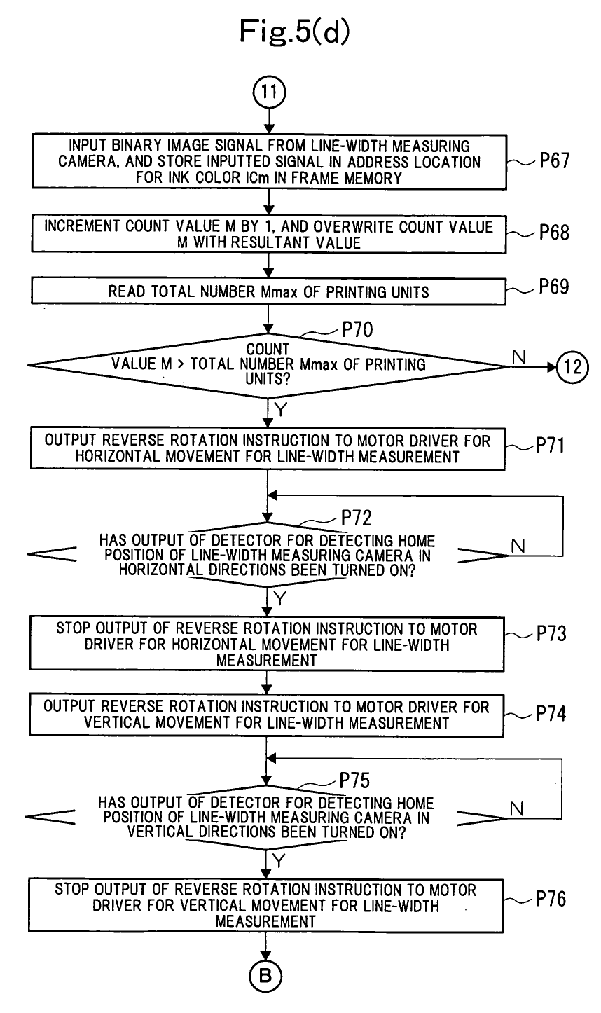

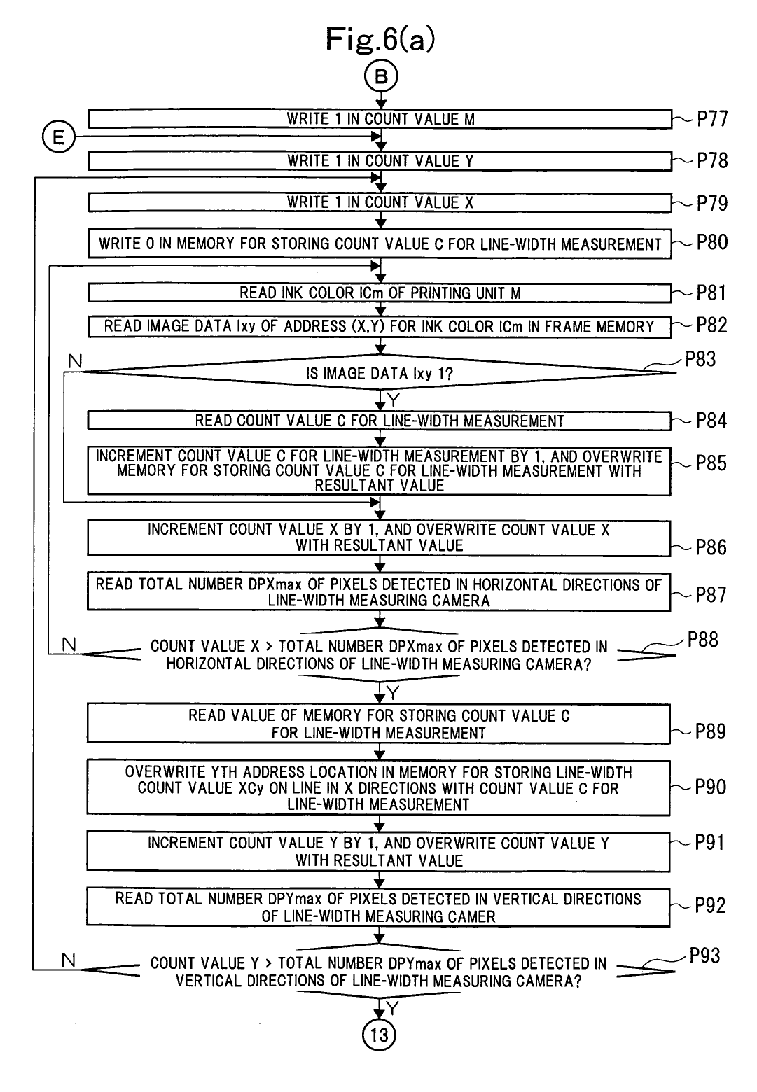

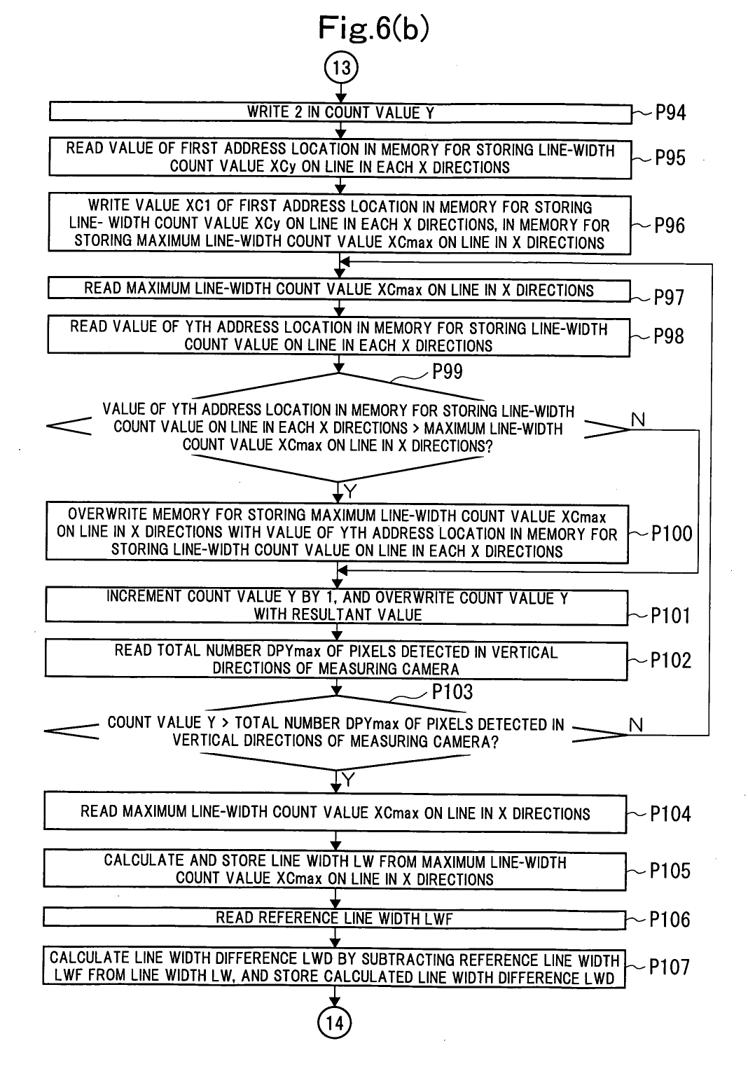

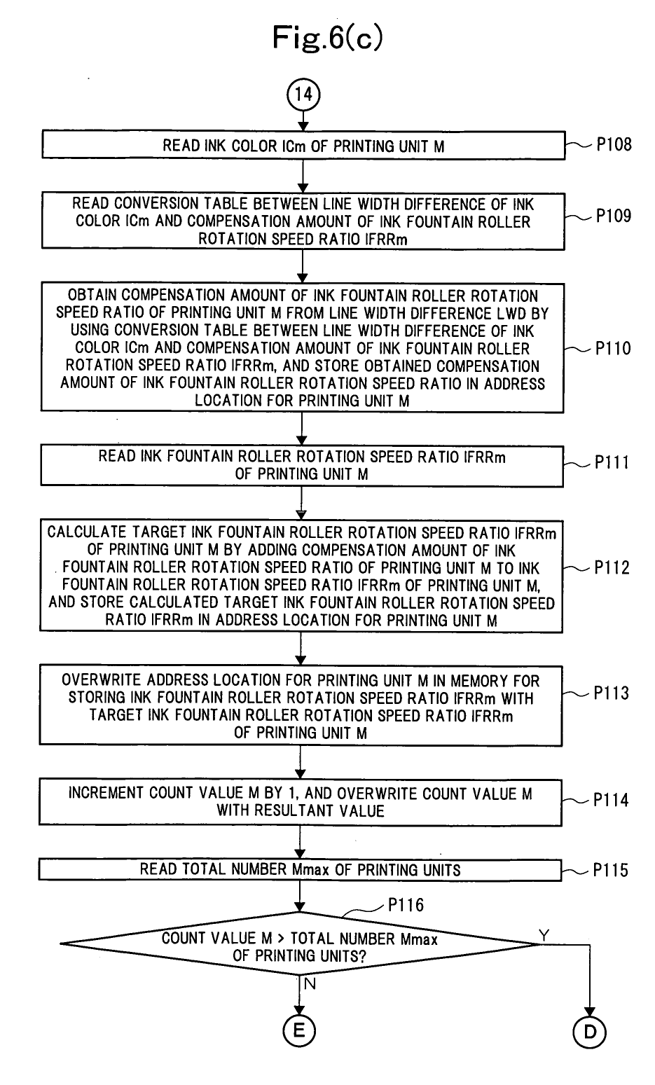

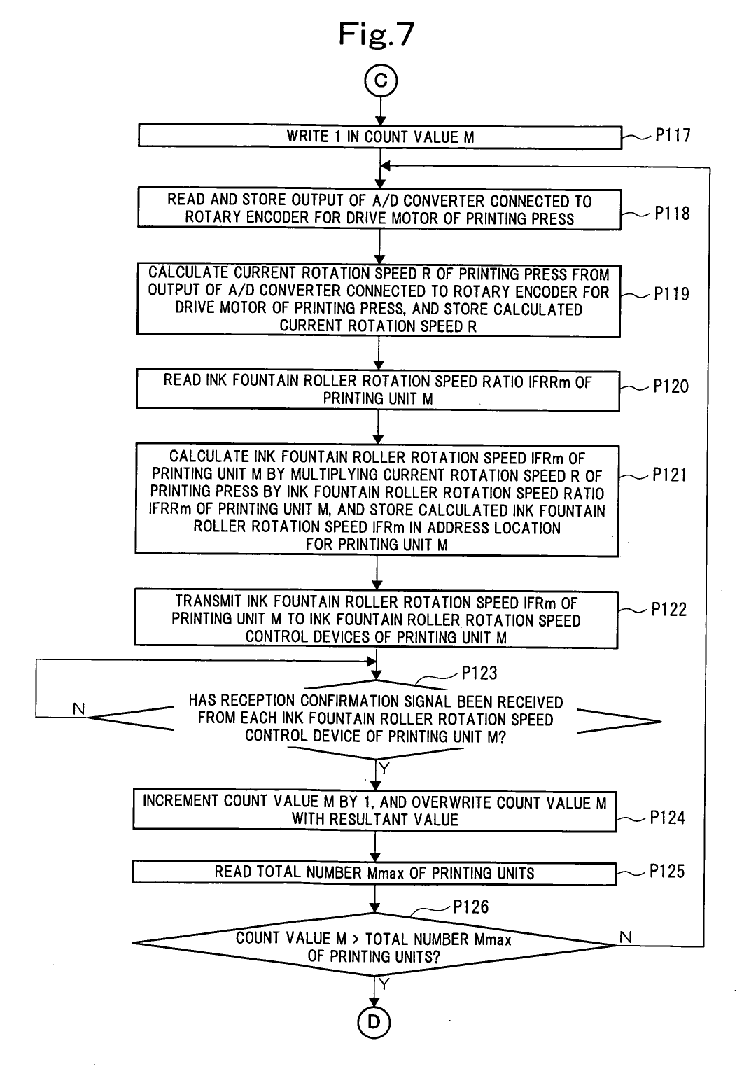

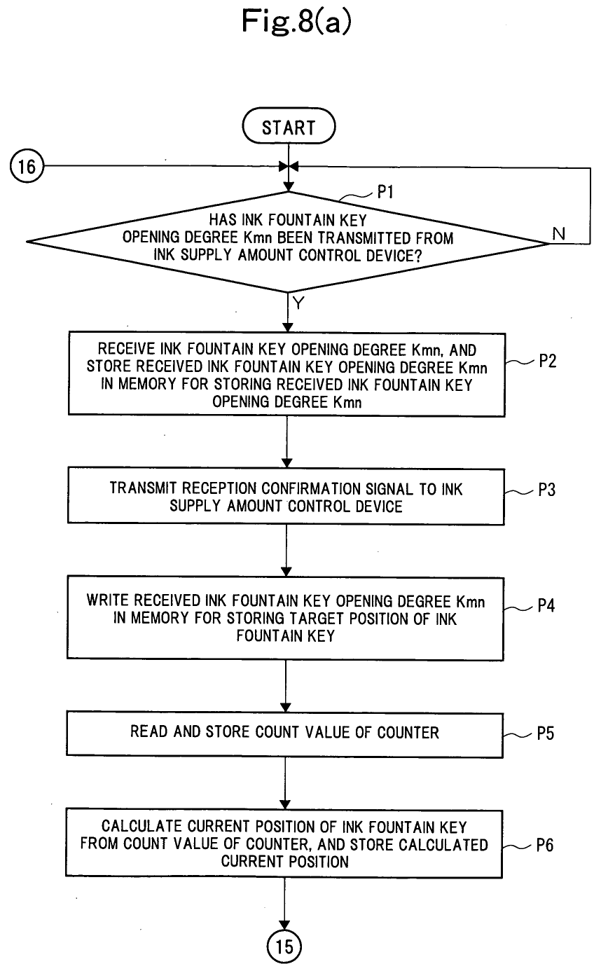

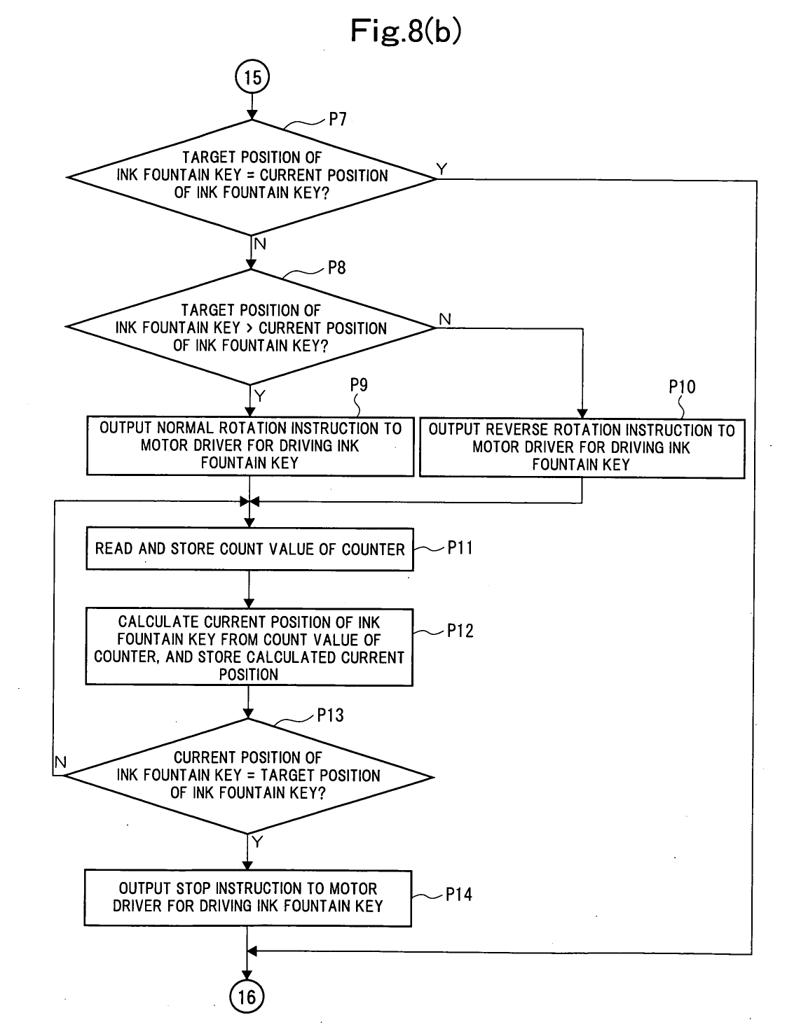

FIGS. 1(a) and 1(b) are control block diagrams of an ink supply amount control device showing a first embodiment of the present invention. FIG. 2 is a control block diagram of each ink fountain key opening degree control device. FIG. 3 is a control block diagram of each ink fountain roller rotation speed control device. FIGS. 4(a) to 4(c), FIGS. 5(a) to 5(d), FIGS. 6(a) to 6(c), and FIG. 7 are operation flowcharts of the ink supply amount control device. FIGS. 8(a) and 8(b) are operation flowcharts of the ink fountain key opening degree control device.

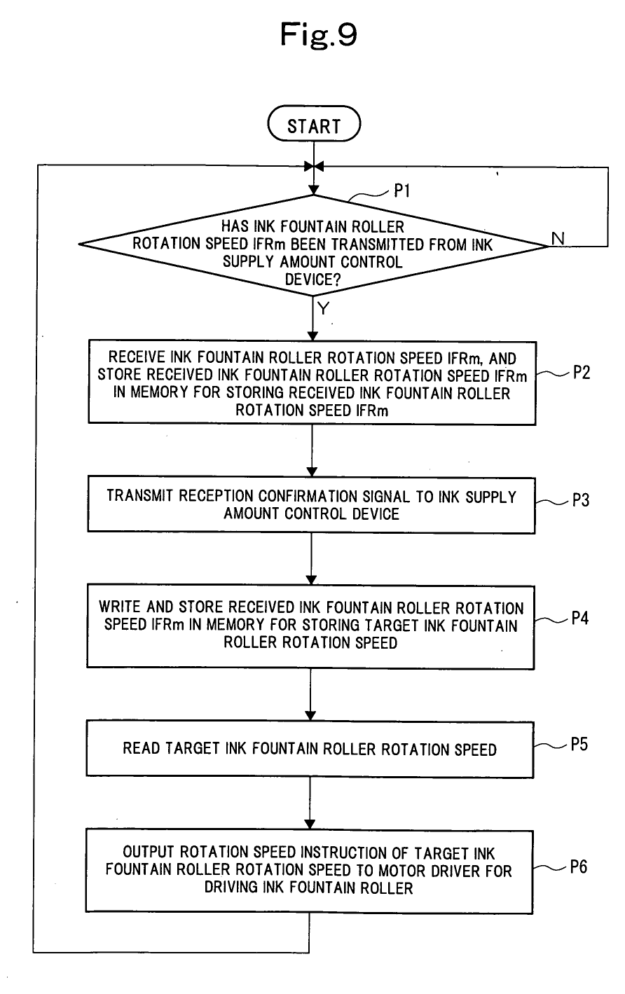

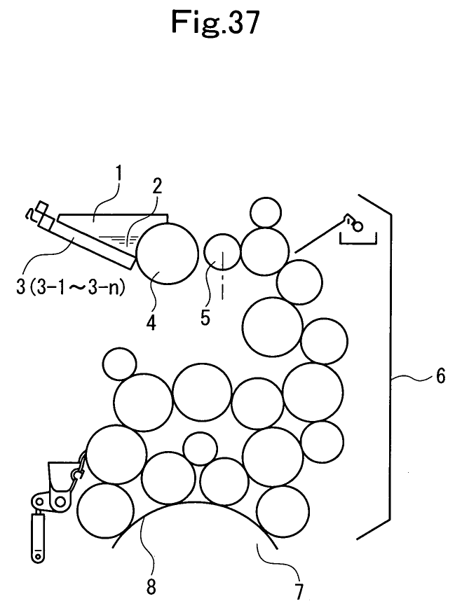

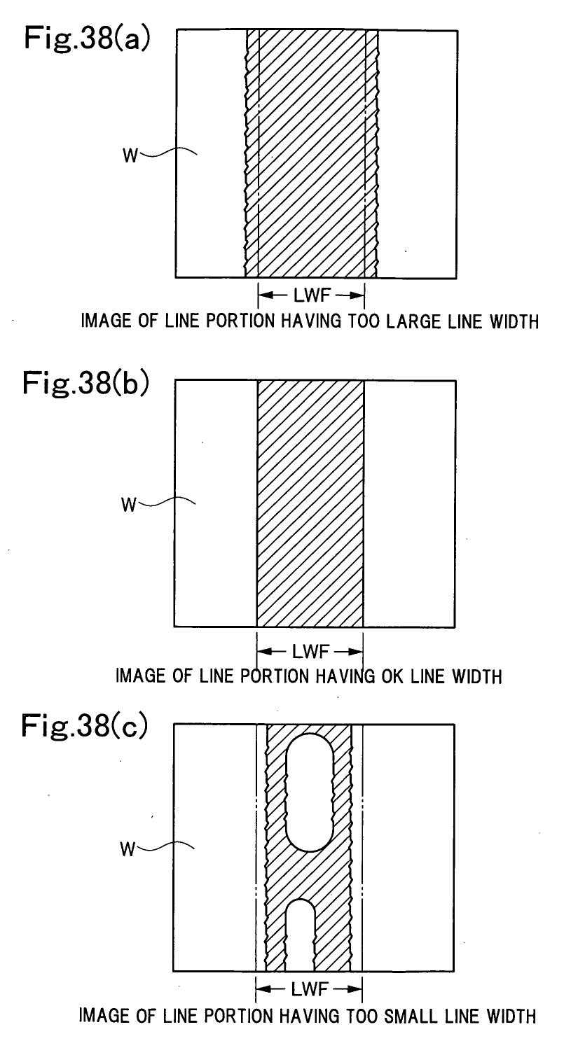

FIG. 9 is an operation flowchart of the ink fountain roller rotation speed control device. FIG. 37 is a view showing a main part of an ink supply device in a printing unit of each color. FIGS. 38(a) to 38(c) are explanatory views of image judgment.

As shown in FIG. 37, in an ink supply device (inker) in a printing unit of each color in a relief (web) printing press, ink 2 stored in an ink fountain (ink storage) 1 is supplied to an ink fountain roller (ink supply amount adjustment means) from the openings of ink fountain keys (ink supply amount adjustment means) 3 (3-1 to 3-n), and is further supplied to a printing plate 8 attached to a plate cylinder 7, through an ink ductor roller 5 and a group of rollers 6.

The amount of ink supplied from the ink fountain 1 to the ink fountain roller 4 is adjusted by adjusting the opening degrees of ink fountain keys 3-1 to 3-n, and the amount of ink supplied from the ink fountain roller 4 to the printing plate 8 through the group of ink rollers 6 is adjusted by adjusting the rotation speed of the ink fountain roller 4. Thereafter, the ink supplied to the printing plate 8 is printed on paper (print member).

The opening degrees of the ink fountain keys 3-1 to 3-n are each determined in accordance with the image area ratio of a range, of the printing plate 8, corresponding to each of the ink fountain keys 3-1 to 3-n on the basis of a predetermined “conversion curve (table) between an image area ratio and an ink fountain key opening degree.” Moreover, the rotation speed (ink feed rate) of the ink fountain roller 4 is determined in accordance with a predetermined reference ink feed rate.

The opening degrees of the ink fountain keys 3-1 to 3-n and the rotation speed of the ink fountain roller 4 are determined for each printing unit of a different color. In other words, a “conversion curve (table) between an image area ratio and an ink fountain key opening degree” and a reference ink feed rate are determined for each color, and are fixed.

In the first embodiment, the ink fountain keys 3-1 to 3-n are driven by a motor 61 (see FIG. 2), and the drive of the motor 61 is controlled by an ink supply amount control device (control means) 30 and ink fountain key opening degree control devices (control means) 50-(1-1) to 50-(M-N) to be described later. Moreover, the ink fountain roller 4 is driven by a motor 79 (see FIG. 3), and the drive of the motor 79 is controlled by the ink supply amount control device (control means) 30 and ink fountain roller rotation speed control devices (control means) 70-1 to 70-M to be described later.

As shown in FIGS. 1(a) and 1(b), in the ink supply amount control device 30, a CPU 31, a RAM 32, a ROM 33, input/output (I/O) devices 34 to 36, and 38, and an interface 37 are connected through a bus 39. Moreover, memories M1 to M10 are connected to the bus 39. In the memory M1, an ink color ICm of a printing unit M is stored. In the memory M2, the image area ratio IRmn of a range corresponding to each ink fountain key is stored. In the memory M3, a count value M is stored. In the memory M4, a count value N is stored. In the memory M5, a conversion table between an image area ratio and an ink fountain key opening degree is stored. In the memory M6, the opening degree Kmn of each ink fountain key is stored. In the memory M7, the total number Nmax of ink fountain keys is stored. In the memory M8, a reference ink fountain roller rotation speed ratio IFRRFm is stored. In the memory M9, an ink fountain roller rotation speed ratio IFRRm is stored. In the memory M10, the total number Mmax of printing units is stored.

Furthermore, memories M11 to M20 are also connected to the bus 39. In the memory M1, a value of a counter for measuring the current position of a line-width measuring camera in the vertical directions is stored. In the memory M12, the current position of the line-width measuring camera in the vertical directions is stored. In the memory M13, the position of a line portion, to be measured by the line-width measuring camera, in the vertical directions is stored. In the memory M14, a value of a counter for measuring the current position of the line-width measuring camera in the horizontal directions is stored. In the memory M15, the current position of the line-width measuring camera in the horizontal directions is stored. In the memory M16, the position of the line portion, to be measured by the line-width measuring camera, in the horizontal directions is stored. In the frame memory M17, a binary image signal is stored. In the memory M18, a count value Y is stored. In the memory M19, a count value X is stored. In the memory M20, a count value C for line-width measurement is stored.

Furthermore, memories M21 to M23 and M25 to M28 are also connected to the bus 39. In the memory M21, the total number DPXmax of pixels detected in the horizontal directions of the line-width measuring camera is stored. In the memory M22, the total number DPYmax of pixels detected in the vertical directions of the line-width measuring camera is stored. In the memory M23, a line-width count value XCy of a line in the X directions is stored. In the memory M25, a maximum line-width count value XCmax of a line in the X directions is stored. In the memory M26, a line width LW is stored. In the memory M27, a reference line width LWF is stored. In the memory M28, a line width difference LWD is stored.

Furthermore, memories M29 to M34 are also connected to the bus 39. In the memory M29, a conversion table between a line width difference and a compensation amount of the rotation speed ratio of the ink fountain roller is stored. In the memory M30, a compensation amount of an ink fountain roller rotation speed ratio is stored. In the memory M31, a target ink fountain roller rotation speed ratio IFRRm is stored. In the memory M32, an output of an A/D convertor connected to a rotary encoder for a drive motor of the printing press is stored. In the memory M33, the current rotation speed R of the printing press is stored. In the memory M34, an ink fountain roller rotation speed IFRm is stored.

An input device 40 such as a keyboard, a display device 41 such as a CRT or a display, and an output device 42 such as a printer or a floppy disk (registered trademark) drive are connected to the I/O device 34. A line-width measuring camera (width measurement means) 44 for line-width measurement is connected to the I/O device 35 through a binary OP amplifier 43. Moreover, a rotary encoder 47 for a drive motor of the printing press is connected to the I/O device 36 through an A/D converter 45 and an F/V converter 46.

A motor 91 for vertical movement for line-width measurement is connected to the I/O device 38 through a motor driver 90 for vertical movement for line-width measurement. Moreover, a rotary encoder 93 for the motor for vertical movement for line-width measurement is also connected to the I/O device 38 through a counter 92 for measuring the current position of the line-width measuring camera in the vertical directions, the rotary encoder 93 being connected to and driven by the motor 91. Furthermore, a detector 94 for detecting the home position of the line-width measuring camera in the vertical directions is also connected to the I/O device 38.

In addition, a motor 96 for horizontal movement for line-width measurement is also connected to the I/O device 38 through a motor driver 95 for horizontal movement for line-width measurement. Moreover, a rotary encoder 98 for the motor for horizontal movement for line-width measurement is also connected to the I/O device 38 through a counter 97 for measuring the current position of the line-width measuring camera in the horizontal directions, the rotary encoder 98 being connected to and driven by the motor 96. Furthermore, a detector 99 for detecting the home position of the line-width measuring camera in the horizontal directions is also connected to the I/O device 38.

The first ink fountain key opening degree control device 50-(1-1) of a first printing unit to the Nth ink fountain key opening degree control device 50-(M-N) of an Mth printing unit, and the first (printing unit) ink fountain roller rotation speed control device 70-1 to the Mth (printing unit) ink fountain roller rotation speed control device 70-M are connected to the interface 37.

As shown in FIG. 2, in each of the first ink fountain key opening degree control device 50-(1-1) of the first printing unit to the Nth ink fountain key opening degree control device 50-(M-N) of the Mth printing unit, memories M54 to M57, in addition to a CPU 51, a RAM 52 and a ROM 53, are connected through a bus 60, together with an I/O device 58 and an interface 59. In the memory M54, a received ink fountain key opening degree is stored. In the memory MS5, a target ink fountain key opening degree is stored. In the memory M56, a count value of a counter is stored. In the memory M57, a current ink fountain key opening degree is stored.

The motor 61 for driving the ink fountain key is connected to the I/O device 58 through a motor driver 62 for driving the ink fountain key. Moreover, a rotary encoder 63 for the motor for driving the ink fountain key is also connected to the I/O device 58 through a counter 64, the rotary encoder 63 being connected to and driven by the motor 61 for driving the ink fountain key. A detection signal from the rotary encoder 63 for the motor for driving the ink fountain key is also inputted to the motor driver 62 for driving the ink fountain key. Furthermore, the ink supply amount control device 30 is also connected to the interface 59.

As shown in FIG. 3, in each of the first ink fountain roller rotation speed control device 70-1 to the Mth ink fountain roller rotation speed control device 70-M, memories M74 and M75, in addition to a CPU 71, a RAM 72 and a ROM 73, are connected through a bus 78 together with an I/O device 76 and an interface 77. In the memory M74, a received ink fountain roller rotation speed is stored. In the memory M75, a target ink fountain roller rotation speed is stored.

The motor 79 for driving the ink fountain roller is connected to the I/O device 76 through a motor driver 80 for driving the ink fountain roller. Moreover, a rotary encoder 81 for the motor for driving the ink fountain roller is also connected to the I/O device 76 through an F/V converter 82 and an A/D converter 83, the rotary encoder 81 being connected to and driven by the motor 79 for driving the ink fountain roller. A detection signal from the rotary encoder 81 for the motor for driving the ink fountain roller is also inputted to the motor driver 80 for driving the ink fountain roller. Furthermore, the ink supply amount control device 30 is connected to the interface 77.

In the first embodiment, the rotation speed of the ink fountain roller 4 in the ink supply device in the printing unit of each color can be adjusted (compensated) automatically on the basis of a measurement result obtained by the line-width measuring camera 44 serving as width measurement means for measuring the maximum width of the line portion printed on paper W, by using the ink supply amount control device 30 (including the first ink fountain key opening degree control device 50-(1-1) of the first printing unit to the Nth ink fountain key opening degree control device 50-(M-N) of the Mth printing unit and the first ink fountain roller rotation speed control device 70-1 to the Mth ink fountain roller rotation speed control device 70-M, to be exact).

The line-width measuring camera 44 is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 38(a) to 38(c), the line-width measuring camera 44 can directly measure the maximum width of the line portion (the region indicated by hatching in each of FIGS. 38(a) to 38(c)) printed on the paper (print member) W placed on the main body of the checking apparatus (for details, refer to operation flowcharts to be described later). In FIGS. 38(a) to 38(c), LWF denotes a reference line width.

The ink supply amount control device 30 is configured as described above, and operates as in the operation flow shown in FIGS. 4(a) to 4(c), FIGS. 5(a) to 5(d), FIGS. 6(a) to 6(c), and FIG. 7.

Firstly, in Step P1, it is determined whether or not the ink color ICm of the printing unit M and an image area ratio IRmn of a range corresponding to each ink fountain key have been inputted. When the determination in Step P1 is YES, in Step P2, the ink color ICm of the printing unit M and the image area ratio IRmn of the range corresponding to each ink fountain key are inputted and stored respectively in the memories M1 and M2. On the other hand, when the determination in Step P1 is NO, the process proceeds to Step P3.

Then, in Step P3, it is determined whether or not an ink preset switch has been turned on. When the determination in Step P3 is YES, in Step P4, 1 is written in the count value M in the memory M3. When the determination in Step P3 is NO, the process proceeds to Step P30.

In Step P5, 1 is written in the count value N in the memory M4. Thereafter, in Step P6, the ink color ICm of the printing unit M is read from the memory M1. Then, in Step P7, the conversion table between an image area ratio corresponding to the ink color ICm and an ink fountain key opening degree is read from the memory M5.

In Step P8, the image area ratio IRmn of the range corresponding to the Nth ink fountain key of the printing unit M is read from the memory M2. Thereafter, in Step P9, the opening degree Kmn of the Nth ink fountain key of the printing unit M is obtained from the image area ratio IRmn of the range corresponding to the Nth ink fountain key of the printing unit M by using the conversion table between an image area ratio corresponding to the ink color ICm and an ink fountain key opening degree, and is then stored in the Nth address location for the printing unit M in the memory M6 for storing the opening degree Kmn of each ink fountain key.

In Step P10, the count value N in the memory M4 is incremented by 1, and is then overwritten with the resultant value. Thereafter, in Step P11, the total number Nmax of the ink fountain keys of each printing unit is read from the memory M7. Then, in Step P12, it is determined whether or not the count value N is larger than the total number Nmax of the ink fountain keys of each printing unit.

When the determination in Step P12 is YES, in Step P13, the count value M in the memory M3 is incremented by 1, and is then overwritten with the resultant value. On the other hand, when the determination in Step P12 is NO, the process returns to Step P6. Thereafter, in Step P14, the total number Mmax of the printing units is read from the memory M10. Then, in Step P15, it is determined whether or not the count value M is larger than the total number Mmax of the printing units.

When the determination in Step P15 is YES, in Step P16, 1 is written in the count value M in the memory M3. On the other hand, when the determination in Step P15 is NO, the process returns to Step P5. Thereafter, in Step P17, 1 is written in the count value N in the memory M4. Then, in Step P18, the opening degree Kmn of the Nth ink fountain key of the printing unit M is read from the memory M6.

Then, in Step P19, the opening degree Kmn of the ink fountain key is transmitted to the Nth ink fountain key opening degree control device of the printing unit M. Thereafter, when a reception confirmation signal is received from the Nth ink fountain key opening degree control device of the printing unit M in Step P20, in Step P21, the count value N in the memory M4 is incremented by 1, and is then overwritten with the resultant value.

In Step P22, the total number Nmax of the ink fountain keys of each printing unit is read from the memory M7. Thereafter, in Step P23, it is determined whether or not the count value N is larger than the total number Nmax of the ink fountain keys of each printing unit. When the determination in Step P23 is YES, in Step P24, the ink color ICm of the printing unit M is read from the memory M1. On the other hand, when the determination in Step P23 is NO, the process returns to Step P18.

In Step P25, the reference ink fountain roller rotation speed ratio IFRRFm corresponding to the ink color ICm is read from the memory M8. Thereafter, in Step P26, the reference ink fountain roller rotation speed ratio IFRRFm corresponding to the ink color ICm is written in the address for the printing unit M in the memory M9 for storing the ink fountain roller rotation speed ratio IFRRm.

In Step P27, the count value M in the memory M3 is incremented by 1, and is then overwritten with the resultant value. Thereafter, in Step P28, the total number Mmax of the printing units is read from the memory M10. Then, in Step P29, it is determined whether or not the count value M is larger than the total number Mmax of the printing units. When the determination in Step P29 is YES, the process proceeds to Step P30. On the other hand, when the determination in Step P29 is NO, the process returns to Step P17.

Through the above-described steps, the opening degree Kmn of each ink fountain key is transmitted to the corresponding one of the ink fountain key opening degree control devices 50-(1-1) to 50-(M-N), and a preset value of each ink fountain roller rotation speed ratio IFRRm is obtained.

Next, in Step P30, it is determined whether or not a line-width measurement switch has been turned on. When the determination in Step P30 is YES, in Step P31, 1 is written in the count value M in the memory M3. On the other hand, when the determination in Step P30 is NO, the process proceeds to Step P117.

In Step P32, the value of the counter 92 for measuring the current position of the line-width measuring camera in the vertical directions is read, and is then stored in the memory M11. Thereafter, in Step P33, the current position of the line-width measuring camera 44 in the vertical directions is calculated from the read value of the counter 92 for measuring the current position of the line-width measuring camera in the vertical directions, and is then stored in the memory M12.

In Step P34, the position of the line portion in the ink color ICm, to be measured by the line-width measuring camera, in the vertical directions is read from the memory M13. Thereafter, in Step P35, it is determined whether or not the current position of the line-width measuring camera 44 in the vertical directions is equal to the position of the line portion in the ink color ICm, to be measured by the line-width measuring camera, in the vertical directions. When the determination in Step P35 is YES, the process proceeds to Step P49. On the other hand, when the determination in Step P35 is NO, it is determined, in Step P36, whether or not the current position of the line-width measuring camera 44 in the vertical directions is lower than the position of the line portion in the ink color ICm, to be measured by the line-width measuring camera, in the vertical directions.

When the determination in Step P36 is YES, in Step P37, a normal rotation instruction is outputted to the motor driver 90 for vertical movement for line-width measurement. Thereafter, in Step P38, the value of the counter 92 for measuring the current position of the line-width measuring camera in the vertical directions is read, and is then stored in the memory M11.

In Step P39, the current position of the line-width measuring camera 44 in the vertical directions is calculated from the read value of the counter 92 for measuring the current position of the line-width measuring camera in the vertical directions, and is then stored in the memory M12. Thereafter, in Step P40, the position of the line portion in the ink color ICm, to be measured by the line-width measuring camera, in the vertical directions is read from the memory M13.

In Step P41, it is determined whether or not the current position of the line-width measuring camera 44 in the vertical directions is equal to the position of the line portion in the ink color ICm, to be measured by the line-width measuring camera, in the vertical directions. When the determination in Step P41 is YES, in Step P42, the output of the normal rotation instruction to the motor driver 90 for vertical movement for line-width measurement is stopped. Thereafter, the process proceeds to Step P49. On the other hand, when the determination in Step P41 is NO, the process returns to Step P38.

When the determination in Step P36 is NO, in Step P43, a reverse rotation instruction is outputted to the motor driver 90 for vertical movement for line-width measurement. Thereafter, in Step P44, the value of the counter 92 for measuring the current position of the line-width measuring camera in the vertical directions is read, and is then stored in the memory M11.

In Step P45, the current position of the line-width measuring camera 44 in the vertical directions is calculated from the read value of the counter 92 for measuring the current position of the line-width measuring camera in the vertical directions, and is then stored in the memory M12. Thereafter, in Step P46, the position of the line portion in the ink color ICm, to be measured by the line-width measuring camera, in the vertical directions is read from the memory M13.

In Step P47, it is determined whether or not the current position of the line-width measuring camera 44 in the vertical directions is equal to the position of the line portion in the ink color ICm, to be measured by the line-width measuring camera, in the vertical directions. When the determination in Step P47 is YES, in Step P48, the output of the reverse rotation instruction to the motor driver 90 for vertical movement for line-width measurement is stopped. Thereafter, the process proceeds to Step P49. On the other hand, when the determination in Step P47 is NO, the process returns to Step P44.

In Step P49, the value of the counter 97 for measuring the current position of the line-width measuring camera in the horizontal directions is read, and is then stored in the memory M14. Thereafter, in Step P50, the current position of the line-width measuring camera 44 in the horizontal directions is calculated from the read value of the counter 97 for measuring the current position of the line-width measuring camera in the horizontal directions, and is then stored in the memory M15.

In Step P51, the position of the line portion in the ink color ICm, to be measured by the line-width measuring camera, in the horizontal directions is read from the memory M16. Thereafter, in Step P52, it is determined whether or not the current position of the line-width measuring camera 44 in the horizontal directions is equal to the position of the line portion in the ink color ICm, to be measured by the line-width measuring camera, in the horizontal directions. When the determination in Step P52 is YES, the process proceeds to Step P66. On the other hand, when the determination in Step P52 is NO, it is determined, in Step P53, whether or not the current position of the line-width measuring camera 44 in the horizontal directions is smaller than the position of the line portion in the ink color ICm, to be measured by the line-width measuring camera, in the horizontal directions.

When the determination in Step P53 is YES, in Step P54, a normal rotation instruction is outputted to the motor driver 95 for horizontal movement for line-width measurement. Thereafter, in Step P55, the value of the counter 97 for measuring the current position of the line-width measuring camera in the horizontal directions is read, and is then stored in the memory M14.

In Step P56, the current position of the line-width measuring camera 44 in the horizontal directions is calculated from the read value of the counter 97 for measuring the current position of the line-width measuring camera in the horizontal directions, and is then stored in the memory M15. Thereafter, in Step P57, the position of the line portion in the ink color ICm, to be measured by the line-width measuring camera, in the horizontal directions is read from the memory M16.

In Step P58, it is determined whether or not the current position of the line-width measuring camera 44 in the horizontal directions is equal to the position of the line portion in the ink color ICm, to be measured by the line-width measuring camera, in the horizontal directions. When the determination in Step P58 is YES, in Step P59, the output of the normal rotation instruction to the motor driver 95 for horizontal movement for line-width measurement is stopped. Thereafter, the process proceeds to Step P66. On the other hand, when the determination in Step P58 is NO, the process returns to Step P55.

When the determination in Step P53 is NO, in Step P60, a reverse rotation instruction is outputted to the motor driver 95 for horizontal movement for line-width measurement. Thereafter, in Step P61, the value of the counter 97 for measuring the current position of the line-width measuring camera in the horizontal directions is read, and is then stored in the memory M14.

In Step P62, the current position of the line-width measuring camera 44 in the horizontal directions is calculated from the read value of the counter 97 for measuring the current position of the line-width measuring camera in the horizontal directions, and is then stored in the memory M15. Thereafter, in Step P63, the position of the line portion in the ink color ICm, to be measured by the line-width measuring camera, in the horizontal directions is read from the memory M16.

In Step P64, it is determined whether or not the current position of the line-width measuring camera 44 in the horizontal directions is equal to the position of the line portion in the ink color ICm, to be measured by the line-width measuring camera, in the horizontal directions. When the determination in Step P64 is YES, in Step P65, the output of the reverse rotation instruction to the motor driver 95 for horizontal movement for line-width measurement is stopped. Thereafter, the process proceeds to Step P66. On the other hand, when the determination in Step P64 is NO, the process returns to Step P61.

In Step P66, a measurement signal is outputted to the line-width measuring camera 44. Thereafter, in Step P67, a binary image signal is received from the line-width measuring camera 44, and is then stored in the address location for the ink color ICm in the frame memory M17.

In Step P68, the count value M in the memory M3 is incremented by 1, and is then overwritten with the resultant value. Thereafter, in Step P69, the total number Mmax of the printing units is read from the memory M10. Then, in Step P70, it is determined whether or not the count value M is larger than the total number Mmax of the printing units.

When the determination in Step P70 is YES, a reverse rotation instruction is outputted to the motor driver 95 for horizontal movement for line-width measurement in Step P71. On the other hand, when the determination in Step P70 is NO, the process returns to Step P32.

When an output of the detector 99 for detecting the home position of the line-width measuring camera 44 in the horizontal directions is turned on in Step P72, in Step P73, the output of the reverse rotation instruction to the motor driver 95 for horizontal movement for line-width measurement is stopped. In Step P74, a reverse rotation instruction is outputted to the motor driver 90 for vertical movement for line-width measurement.

When an output of the detector 94 for detecting the home position of the line-width measuring camera 44 in the vertical directions is turned on in Step P75, in Step P76, the output of the reverse rotation instruction to the motor driver 90 for vertical movement for line-width measurement is stopped.

Through the above-described steps, the binary image signal of the line portion in each ink color ICm is received from the line-width measuring camera 44.

Next, in Step P77, 1 is written in the count value M in the memory M3. In Step P78, 1 is written in the count value Y in the memory M18. In Step P79, 1 is written in the count value X in the memory M19. Thereafter, in Step P80, 0 is written in the memory M20 for storing a count value C for line-width measurement.

In Step P81, the ink color ICm of the printing unit M is read from the memory M1. Then, in Step P82, an image data Ixy of the address (X,Y) for the ink color ICm is read from the frame memory M17. Thereafter, in Step P83, it is determined whether or not the image data Ixy is 1.

When the determination in Step P83 is YES, in Step P84, the count value C for line-width measurement is read from the memory M20. On the other hand, when the determination in Step P83 is NO, the process proceeds to Step P86. In Step P85, the count value C for line-width measurement is incremented by 1, and is then overwritten with the resultant value in the memory M20 for storing the count value C for line-width measurement. Thereafter, in Step P86, the count value X in the memory M19 is incremented by 1, and is then overwritten with the resultant value.

In Step P87, the total number DPXmax of the pixels detected in the horizontal directions of the line-width measuring camera is read from the memory M21. Thereafter, in Step P88, it is determined whether or not the count value X is larger than the total number DPXmax of the pixels detected in the horizontal directions of the line-width measuring camera. When the determination in Step 88 is YES, the value is read from the memory M20 for storing the count value C for line-width measurement in Step P89. On the other hand, when the determination in Step 88 is NO, the process returns to Step P81.

In Step P90, the Yth address location in the memory M23 for storing the line-width count value XCy of the line in the X directions is overwritten with the count value C for line-width measurement. Thereafter, in Step P91, the count value Y in the memory M18 is incremented by 1, and is then overwritten with the resultant value.

In Step P92, the total number DPYmax of the pixels detected in the vertical directions of the line-width measuring camera is read from the memory M22. Thereafter, in Step P93, it is determined whether or not the count value Y is larger than the total number DPYmax of the pixels detected in the vertical directions of the line-width measuring camera. When the determination in Step P93 is YES, in Step P94, 2 is written in the count value Y in the memory M18. On the other hand, when the determination in Step P93 is NO, the process returns to Step P79.

Through the above-described steps, the pixel numbers corresponding to the widths of the lines in the horizontal directions (X directions) are obtained, the lines being lined in the vertical directions (Y directions).

In Step P95, the value of the first address location in the memory M23 for storing the line-width count value XCy of the line in the X directions is read. Thereafter, in Step P96, the value XC1 of the first address location in the memory M23 for storing the line-width count value XCy of the line in the X directions is written in the memory M25 for storing the maximum line-width count value XCmax of the line in the X directions.

In Step P97, the maximum line-width count value XCmax of the line in the X directions is read. In Step P98, the value of the Yth address location in the memory M23 for storing the line-width count value of the line in the X directions is read. Thereafter, in Step P99, it is determined whether or not the value of the Yth address location in the memory for storing the line-width count value of the line in the X directions is larger than the maximum line-width count value XCmax of the line in the X directions.

When the determination in Step P99 is YES, in Step P100, the memory M25 for storing the maximum line-width count value XCmax of the line in the X directions is overwritten with the value of the Yth address location in the memory M23 for storing the line-width count value of the line in the X directions. Then, in Step P101, the count value Y in the memory M18 is incremented by 1, and is then overwritten with the resultant value. On the other hand, when the determination in Step P99 is NO, the process proceeds directly to Step P101.

In Step P102, the total number DPYmax of the pixels detected in the vertical directions of the measuring camera is read from the memory M22. Thereafter, in Step P103, it is determined whether or not the count value Y is larger than the total number DPYmax of the pixels detected in the vertical directions of the measuring camera. When the determination in Step P103 is YES, in Step P104, the maximum line-width count value XCmax of the line in the X directions is read from the memory M25. On the other hand, when the determination in Step P103 is NO, the process returns to Step P97.

Through the above-described steps, the number of pixels corresponding to the maximum line width of the lines in the horizontal directions (X directions) is obtained.

In Step P105, the line width LW is calculated from the maximum line-width count value XCmax of the line in the X directions, and is then stored in the memory M26. Thereafter, in Step P106, the reference line width LWF is read from the memory M27. Then, in Step P107, the line width difference LWD is calculated by subtracting the reference line width LWF from the line width LW, and is then stored in the memory M28.

In Step P108, the ink color ICm of the printing unit M is read from memory M1, and, in Step P109, the conversion table between a line width difference of the ink color ICm and a compensation amount of ink fountain roller rotation speed ratio IFRRm is read from the memory M29. Then, in Step P110, the compensation amount of the ink fountain roller rotation speed ratio of the printing unit M is obtained from the line width difference LWD by using the conversion table between a line width difference of the ink color ICm and a compensation amount of ink fountain roller rotation speed ratio IFRRm, and is then stored in the address location for the printing unit M in the memory M30.

In Step P111, the ink fountain roller rotation speed ratio IFRRm of the printing unit M is read from the memory M9. Thereafter, in Step P112, a target ink fountain roller rotation speed ratio IFRRm of the printing unit M is calculated by adding the compensation amount of the ink fountain roller rotation speed ratio of the printing unit M to the ink fountain roller rotation speed ratio IFRRm of the printing unit M, and is then stored in the address location for the printing unit M in the memory M31.

In Step P113, the address location for the printing unit M in the memory M9 for storing the ink fountain roller rotation speed ratio IFRRm is overwritten with the target ink fountain roller rotation speed ratio IFRRm of the printing unit M. Thereafter, in Step P114, the count value M in the memory M3 is incremented by 1, and is then overwritten with the resultant value.

In Step P115, the total number Mmax of the printing units is read from the memory M10. Thereafter, in Step P116, it is determined whether or not the count value M is larger than the total number Mmax of the printing units. When the determination in Step P116 is YES, the process returns to Step P1. On the other hand, when the determination in Step P116 is NO, the process returns to Step P78.

Through the above-described steps, the ink fountain roller rotation speed ratio IFRRm which is compensated in accordance with the maximum line width of the line portion is obtained for each printing unit.

When the determinations in Step P1, Step P3 and Step P30 are NO, in Step P117, 1 is written in the count value M in the memory M3. Thereafter, in Step P118, an output of the A/D converter 45 connected to the rotary encoder 47 for the drive motor of the printing press is read, and is stored in the memory M32. Then, in Step P119, the current rotation speed R of the printing press is calculated from the output of the A/D converter 45 connected to the rotary encoder 47 for the drive motor of the printing press, and is then stored in the memory M33.

In Step P120, the ink fountain roller rotation speed ratio IFRRm of the printing unit M is read from the memory M9. Thereafter, in Step P121, the ink fountain roller rotation speed IFRm of the printing unit M is calculated by multiplying the current rotation speed R of the printing press by the ink fountain roller rotation speed ratio IFRRm of the printing unit M, and is then stored in the address location for the printing unit M in the memory M34.

In Step P122, the ink fountain roller rotation speed IFRm of the printing unit M is transmitted to the ink fountain roller rotation speed control device 70-M of the printing unit M. Thereafter, when a reception confirmation signal is transmitted from the ink fountain roller rotation speed control device of the printing unit M in Step P123, the count value M in the memory M3 is incremented by 1, and is then overwritten with the resultant value, in Step P124.

In Step P125, the total number Mmax of the printing units is read from the memory M10. Thereafter, in Step P126, it is determined whether or not the count value M is larger than the total number Mmax of the printing units. When the determination in Step P126 is YES, the process returns to Step P1. On the other hand, when the determination in Step P126 is NO, the process returns to Step P118. Thereafter, this process is repeated.

Through the above-described steps, the ink fountain roller rotation speed IFRm according to the current rotation speed R of the printing press is transmitted to the corresponding one of the ink fountain roller rotation speed control devices 70-1 to 70-M.

The first ink fountain key opening degree control device 50-(1-1) of the first printing unit to the Nth ink fountain key opening degree control device 50-(M-N) of the Mth printing unit each operate as in the operation flow shown in FIGS. 8(a) and 8(b).

Specifically, when an ink fountain key opening degree Kmn is transmitted from the ink supply amount control device 30 in Step P1, in Step P2, the ink fountain key opening degree Kmn is received, and is then stored in the memory M54 for storing the received ink fountain key opening degree Kmn. Thereafter, in Step P3, a reception confirmation signal is transmitted to the ink supply amount control device 30.

In Step P4, the received ink fountain key opening degree Kmn is written in the memory M55 for storing the target ink fountain key opening degree (position). Thereafter, in Step P5, the count value of the counter 64 is read, and is then stored in the memory M56. Then, in Step P6, the current ink fountain key opening degree (position) is calculated from the count value of the counter 64, and is then stored in the memory M57.

In Step P7, it is determined whether or not the target position of the ink fountain key is equal to the current position of the ink fountain key. When the determination in Step P7 is YES, the process returns to Step P1. On the other hand, when the determination in Step P7 is NO, it is determined, in Step P8, whether or not the target position of the ink fountain key is larger than the current position of the ink fountain key.

When the determination in Step P8 is YES, in Step P9 a normal rotation instruction is outputted to the motor driver 62 for driving the ink fountain key. When the determination in Step P8 is NO, in Step P10, a reverse rotation instruction is outputted to the motor driver 62 for driving the ink fountain key.

In Step P11, the count value of the counter 64 is read, and is then stored in the memory M56. Thereafter, in Step P12, the current position of the ink fountain key is calculated from the count value of the counter 64, and is then stored in the memory M57.

In Step P13, it is determined whether or not the current position of the ink fountain key is equal to the target position of the ink fountain key. When the determination in Step P13 is YES, in Step P14, a stop instruction is outputted to the motor driver 62 for driving the ink fountain key. Then, the process returns to Step P1. When the determination in Step P13 is NO, the process returns to Step P11. Thereafter, this process is repeated.

The first ink fountain roller rotation speed control device to the Mth ink fountain roller rotation speed control device each operate as in the operation flow shown in FIG. 9.

Specifically, when an ink fountain roller rotation speed IFRm is transmitted from the ink supply amount control device 30 in Step P1, in Step P2, the ink fountain roller rotation speed IFRm is received, and is then stored in the memory M74 for storing the received ink fountain roller rotation speed IFRm. Thereafter, in Step P3, a reception confirmation signal is transmitted to the ink supply amount control device 30.

In Step P4, the received ink fountain roller rotation speed IFRm is written and stored in the memory M75 for storing the target ink fountain roller rotation speed. Thereafter, in Step P5, the target ink fountain roller rotation speed is read from the memory M75.

In Step P6, a rotation speed instruction of the target ink fountain roller rotation speed is outputted to the motor driver 80 for driving the ink fountain roller. Then, the process returns to Step P1. Thereafter, this process is repeated.

As described above, in the first embodiment, the maximum line width of the printed line portion is measured by the line-width measuring camera 44. Then, the ink supply amount control device 30 (or the ink fountain roller rotation speed control devices 70-1 to 70-M, to be exact) controls the drive of the motor 79 on the basis of the measurement result. Thereby, the rotation speed of the ink fountain roller 4 is automatically adjusted. With this configuration, it is possible to avoid anticipated troubles due to an oversupply or undersupply of ink. The troubles are for example, that ink spreads to the outside of the printing pattern, and that a portion of the pattern is not printed. Consequently, it is possible to reduce the burden of the operator, and also to reduce the amount of waste paper to be produced, by preventing errors in manual adjustment.

### Second Embodiment

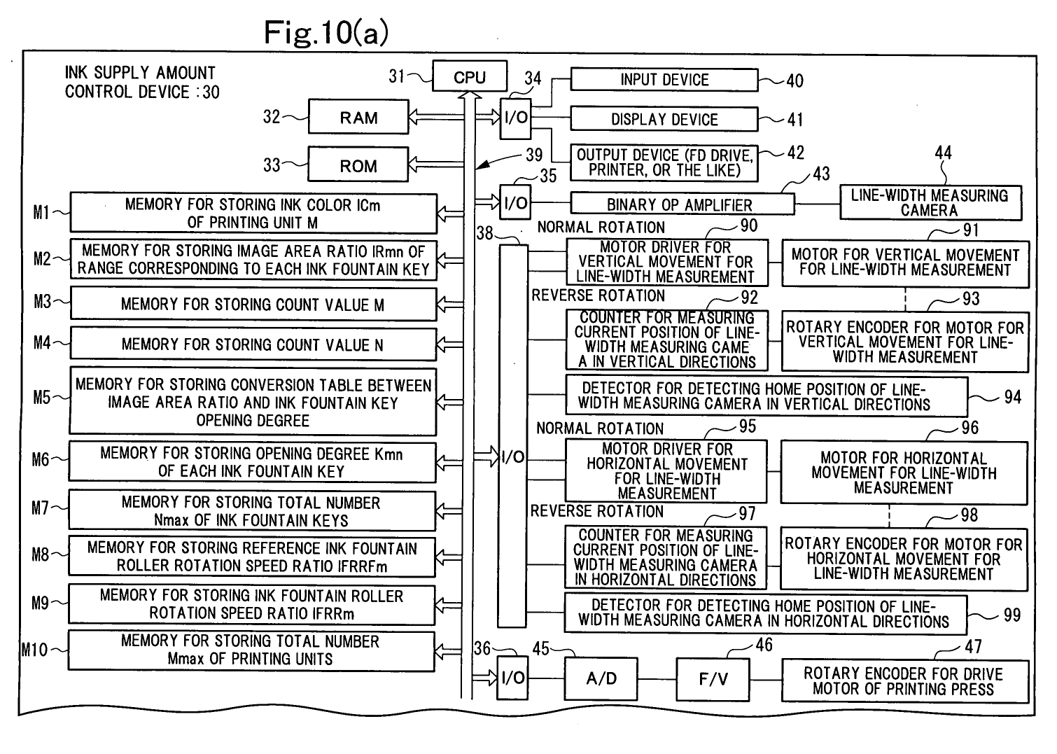

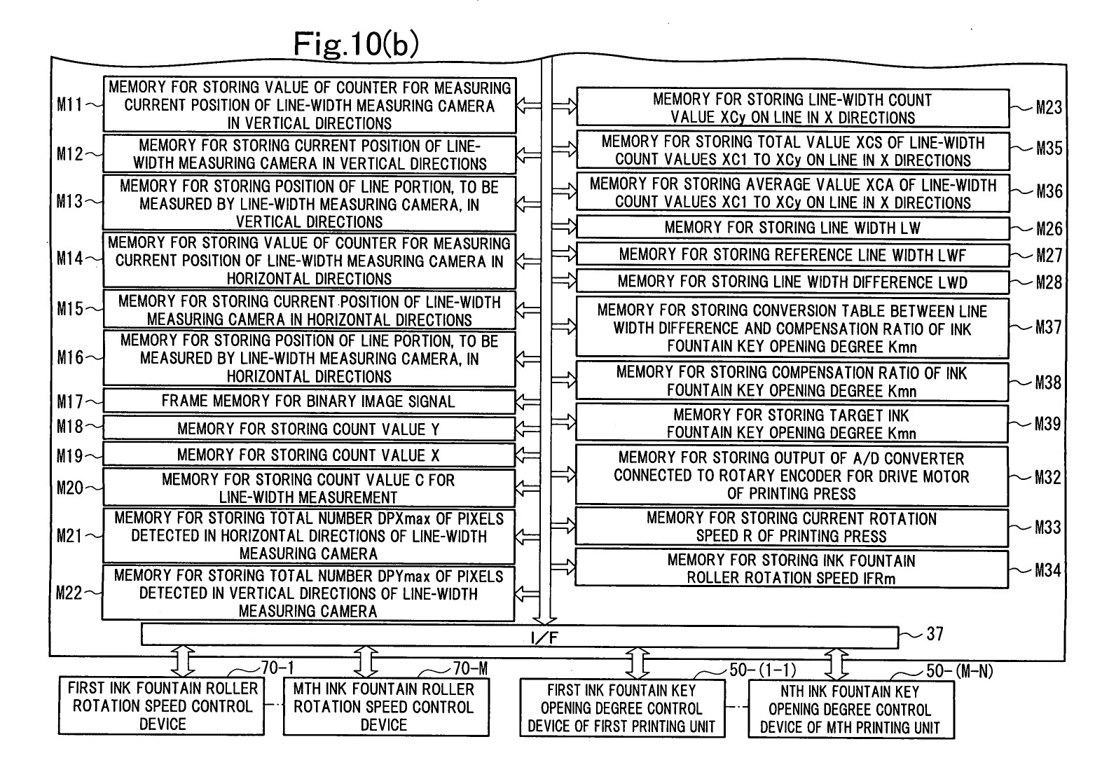

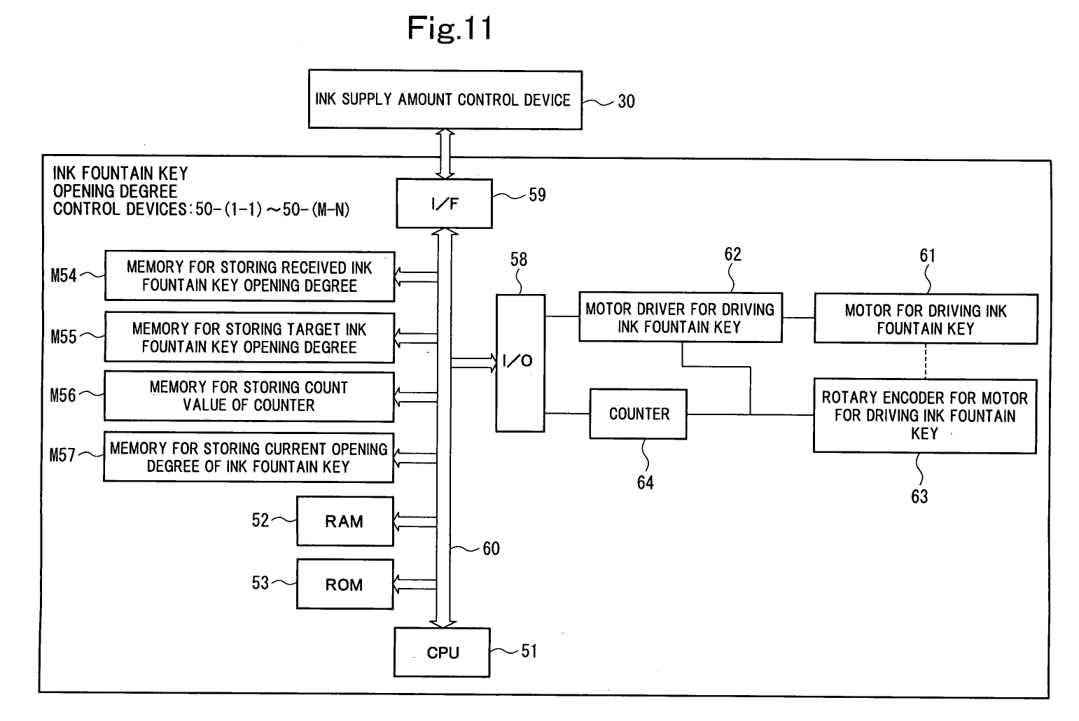

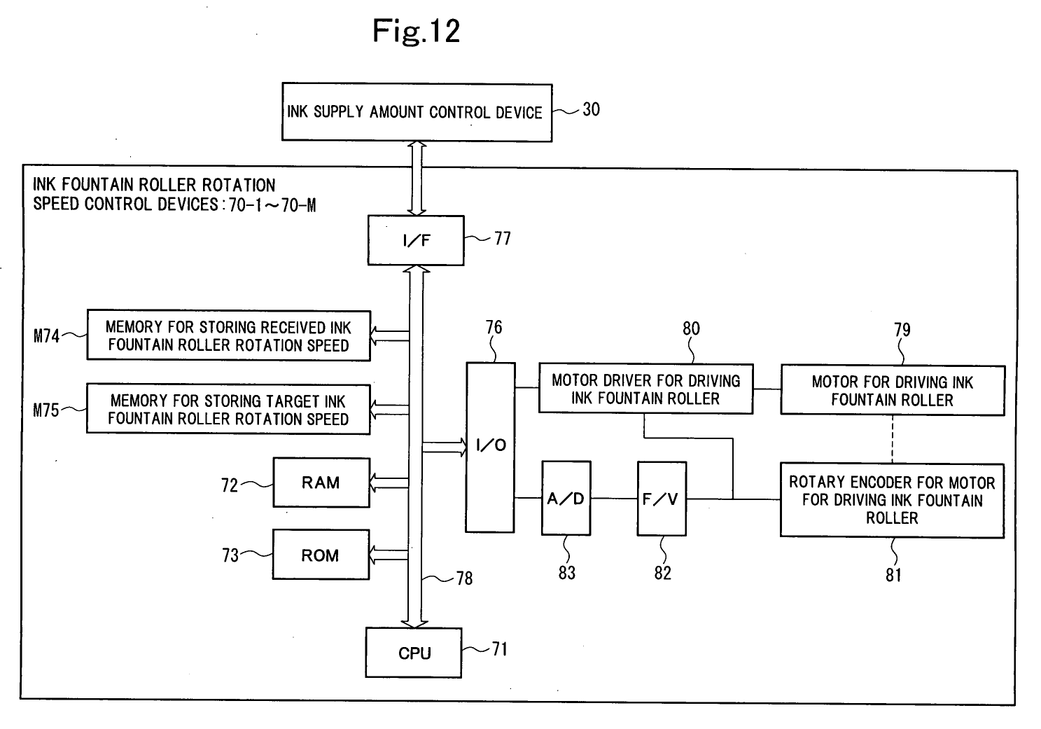

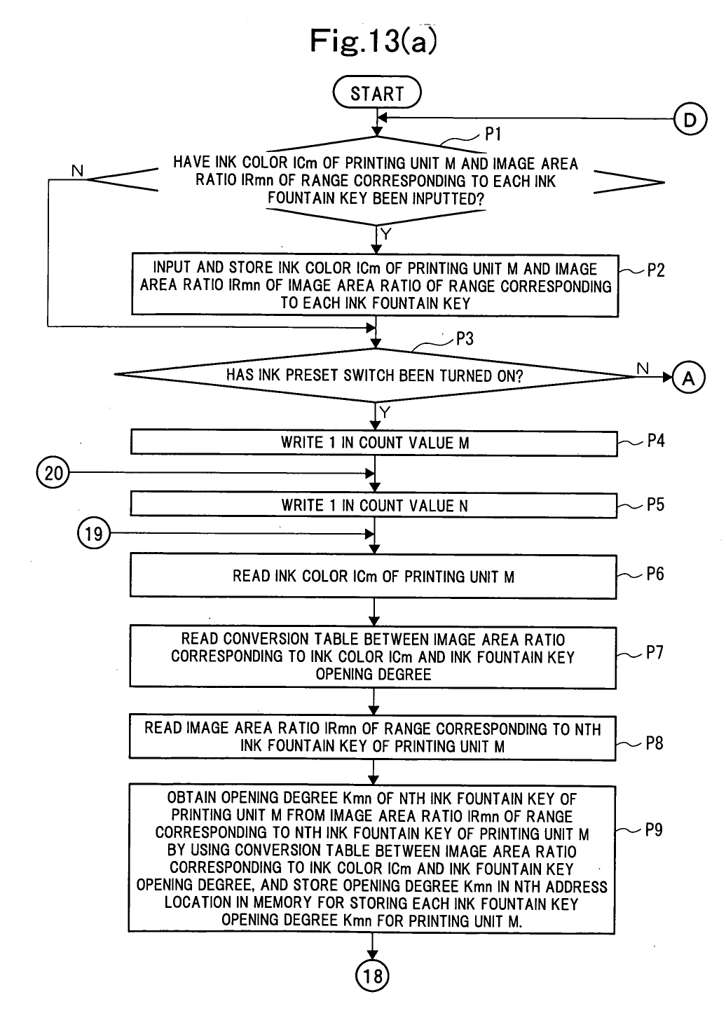

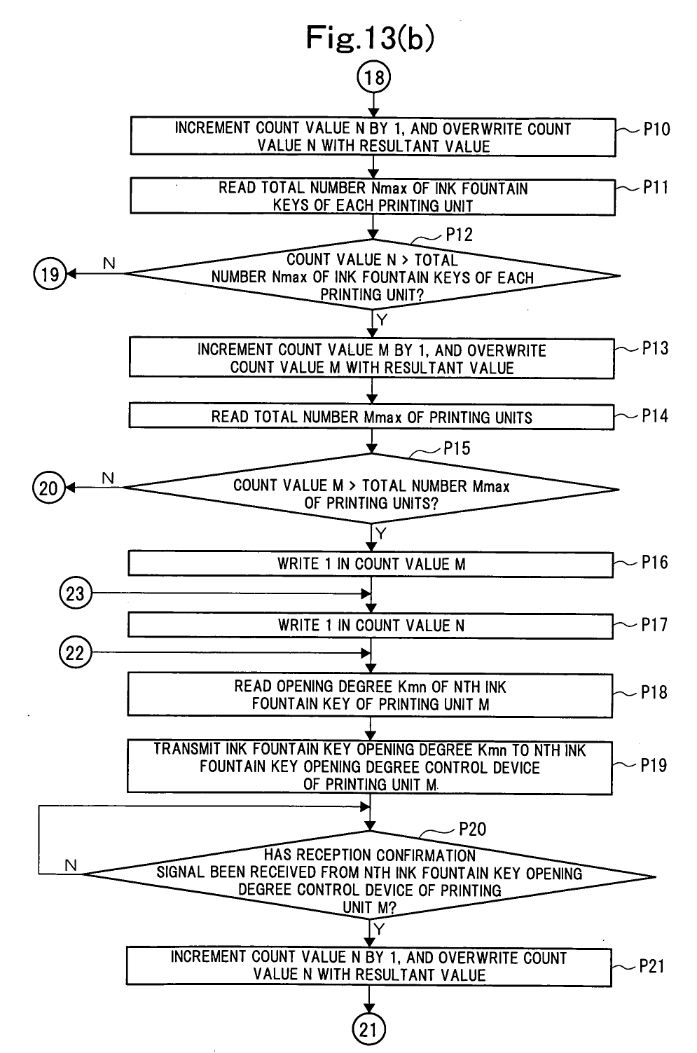

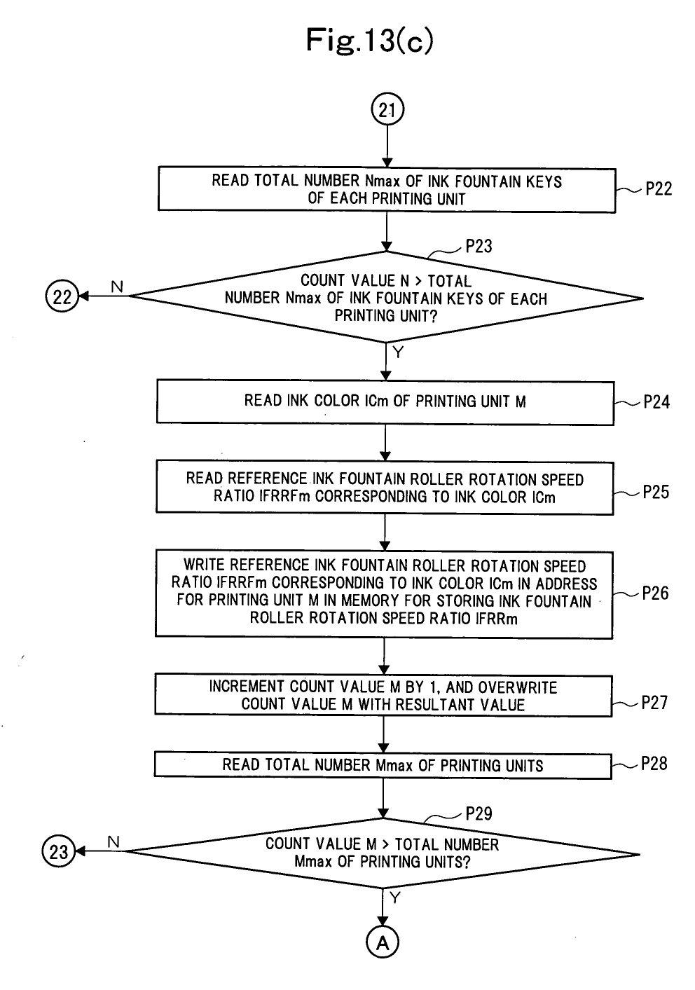

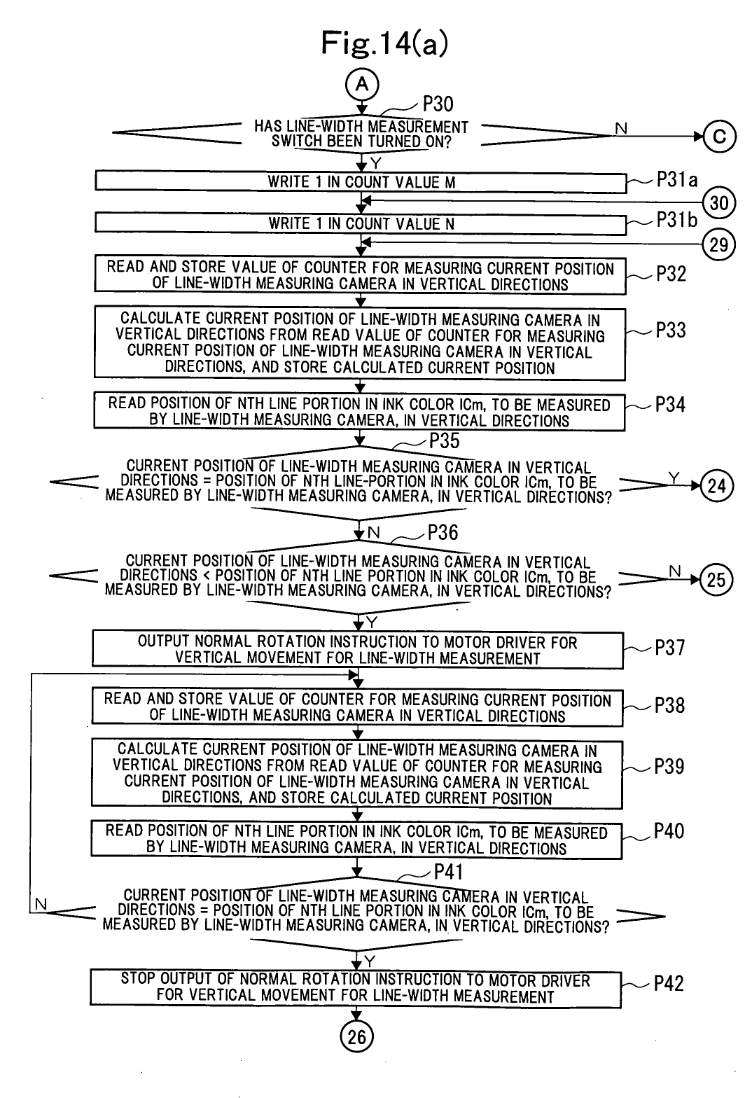

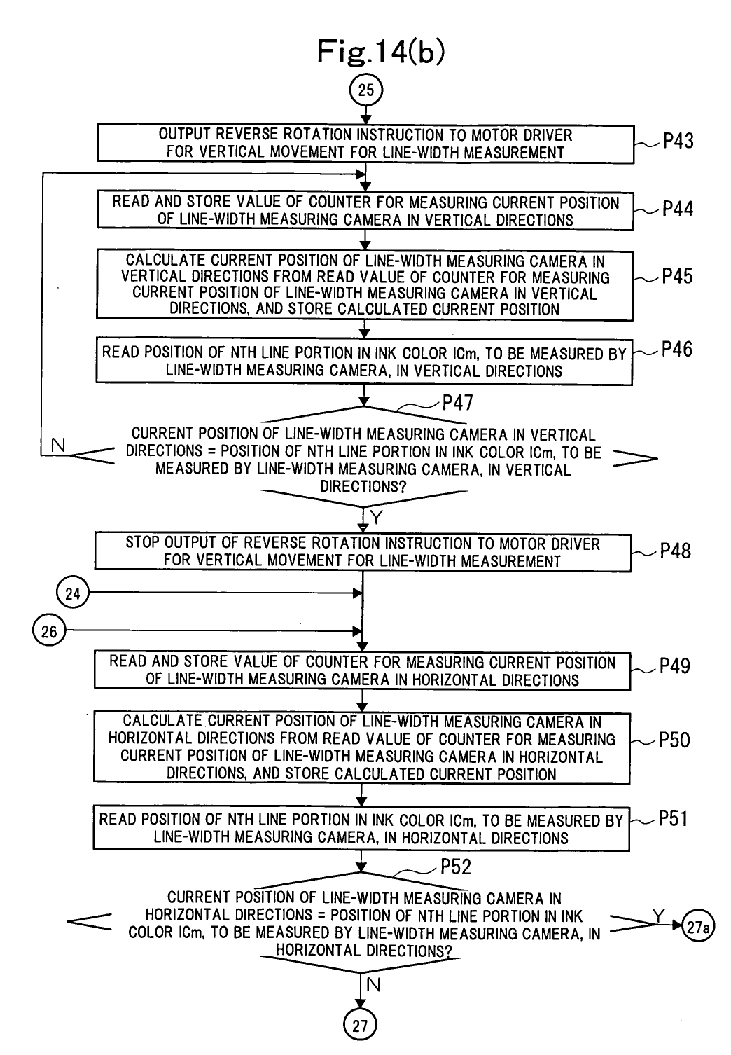

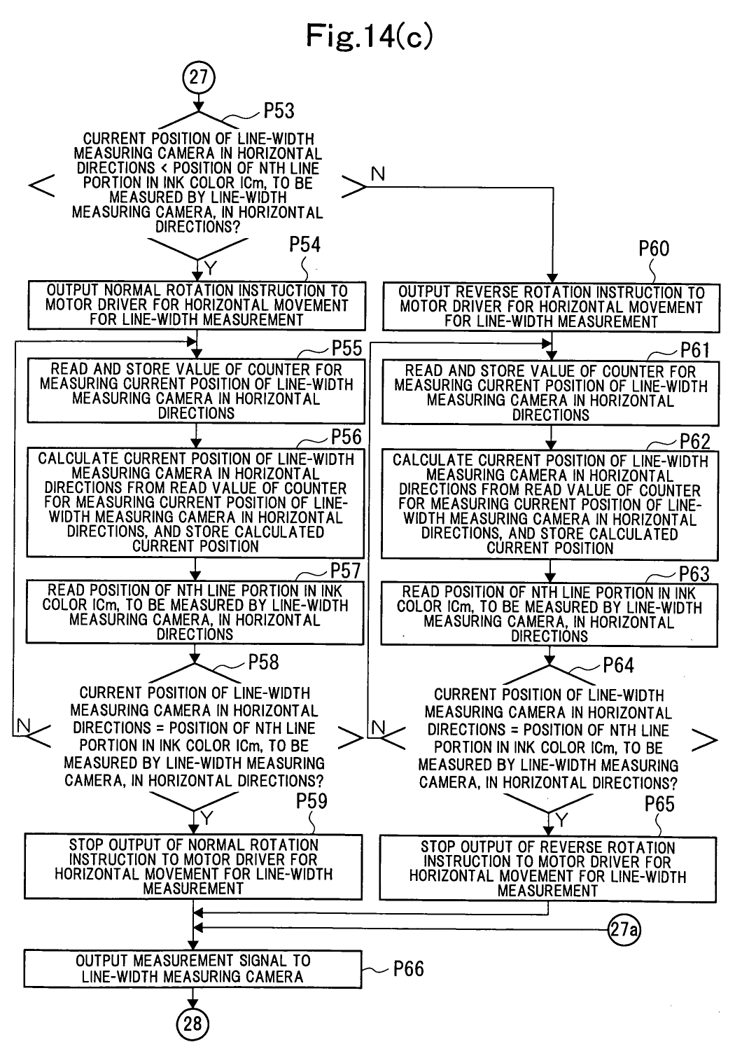

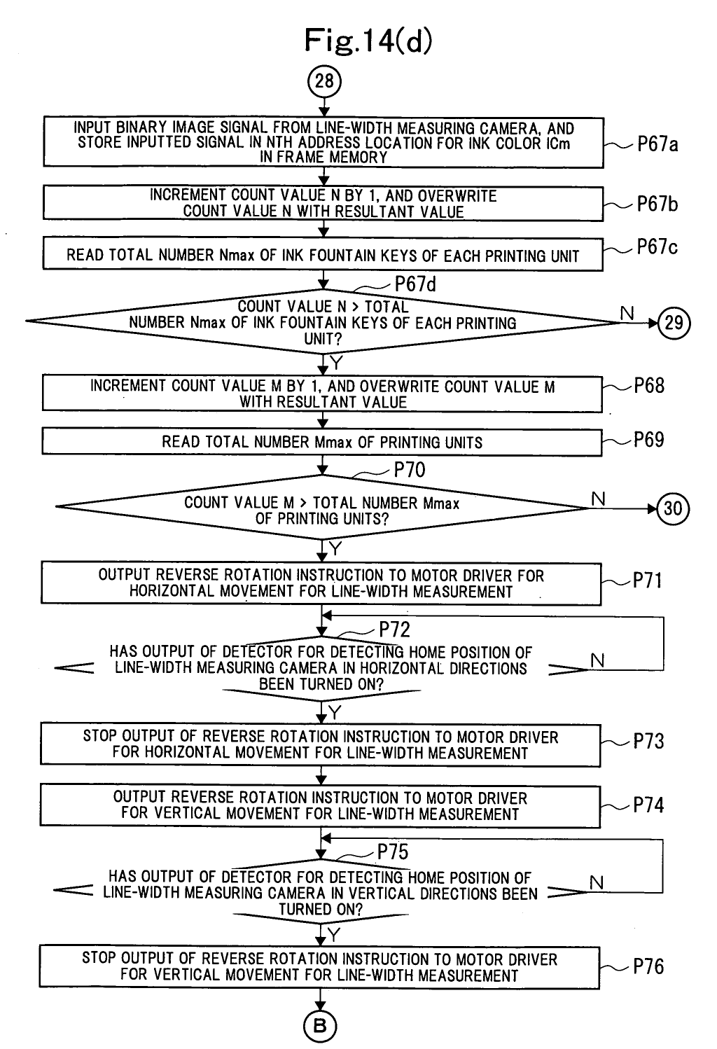

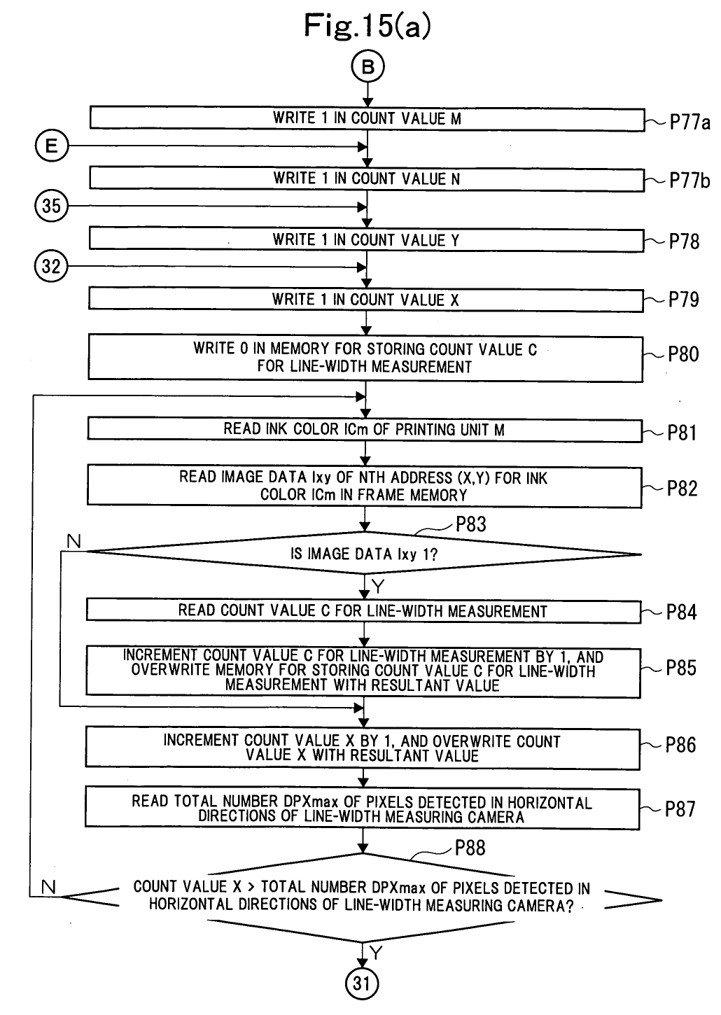

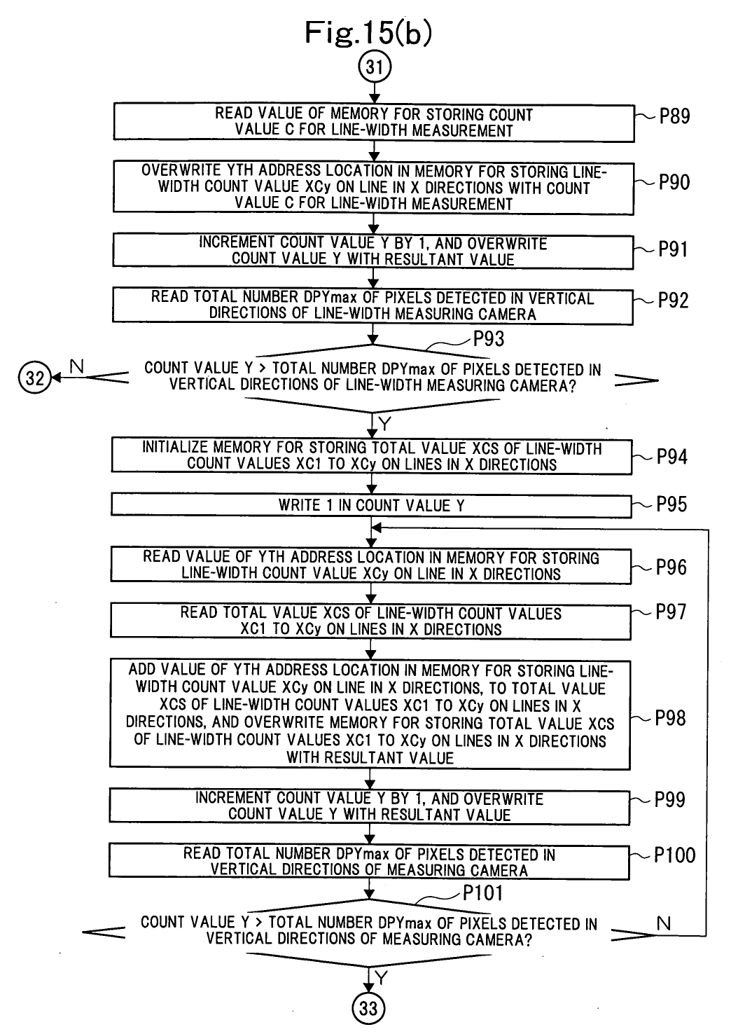

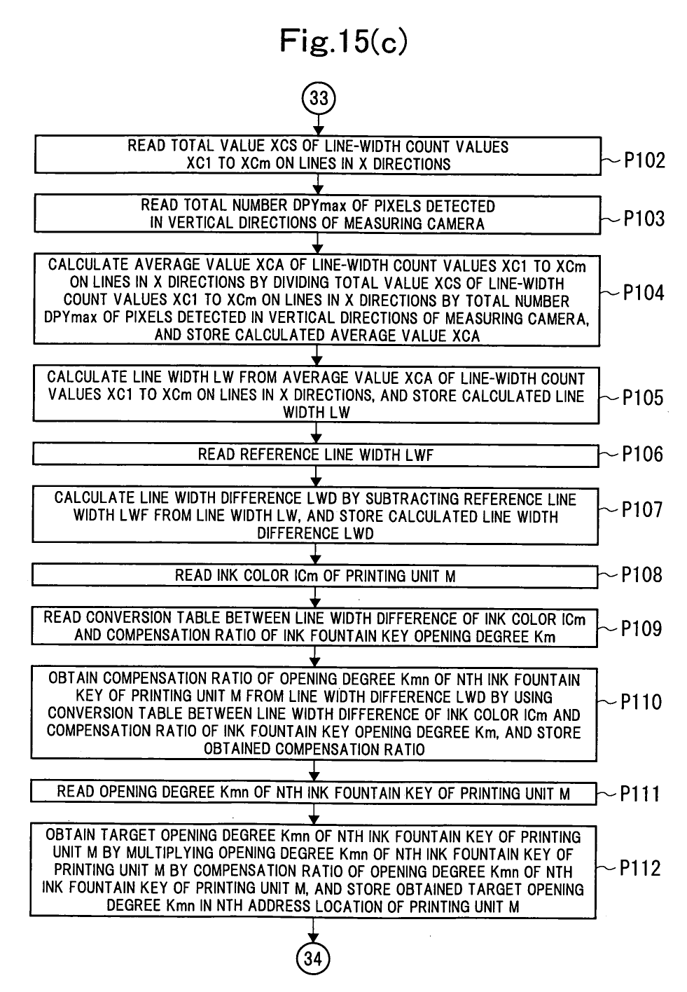

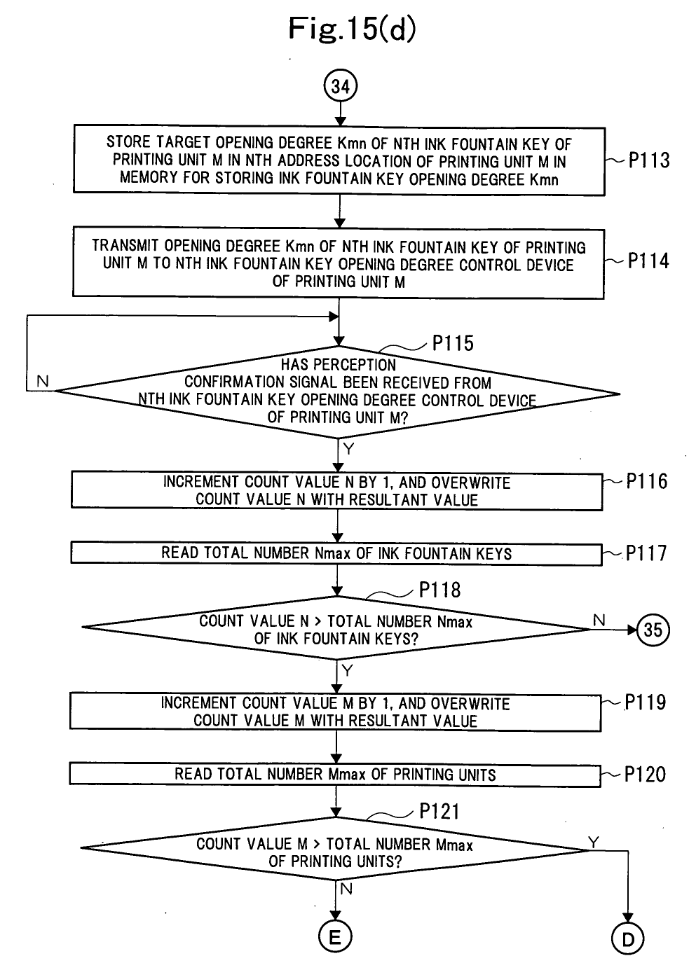

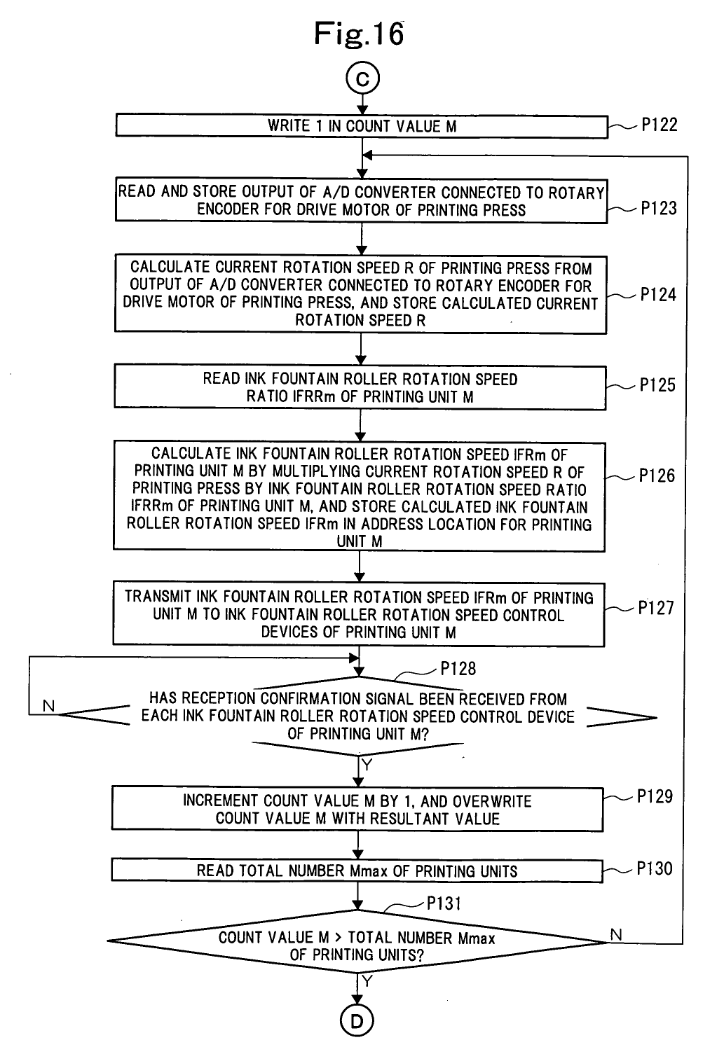

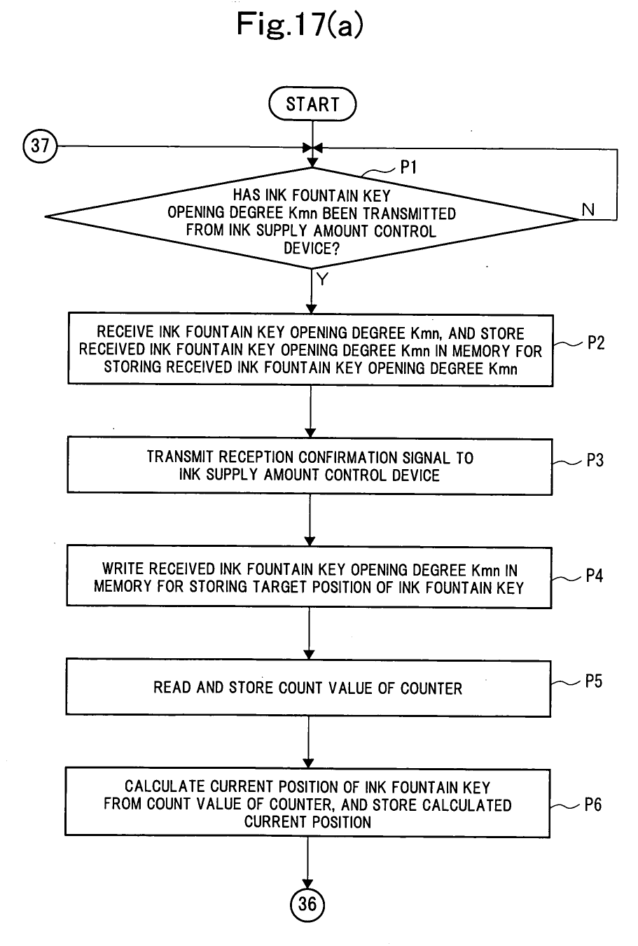

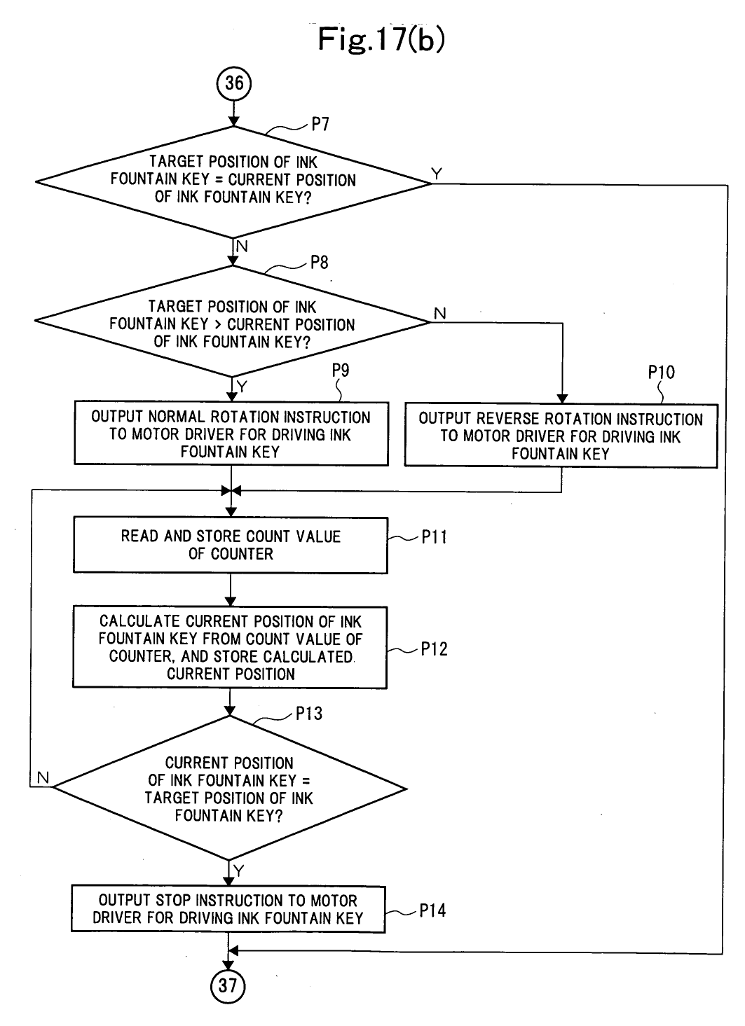

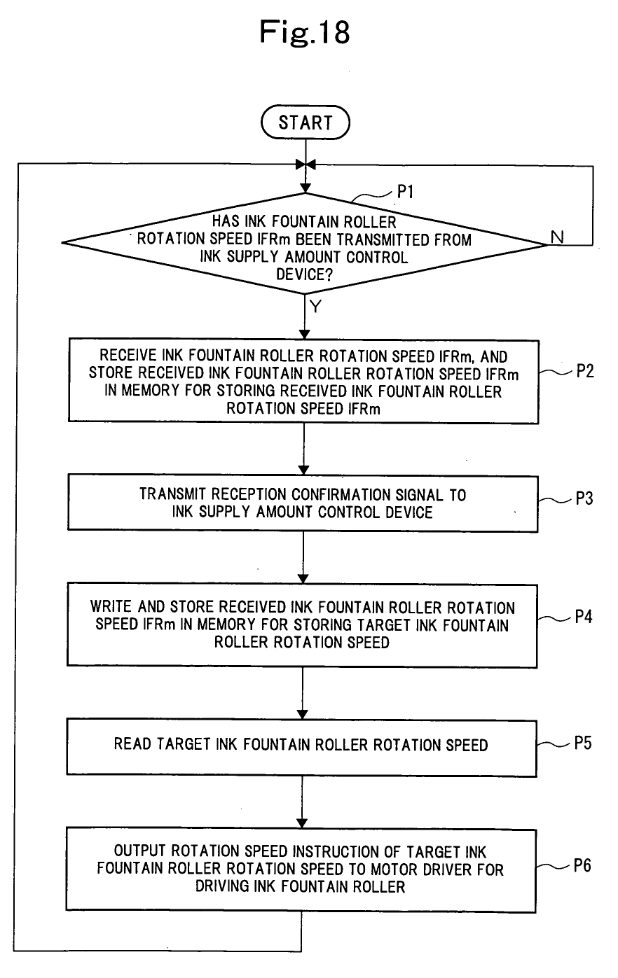

FIGS. 10(a) and 10(b) are control block diagrams of an ink supply amount control device showing a second embodiment of the present invention. FIG. 11 is a control block diagram of each ink fountain key opening degree control device. FIG. 12 is a control block diagram of each ink fountain roller rotation speed control device. FIGS. 13(a) to 13(c), FIGS. 14(a) to 14(d), FIGS. 15(a) to 15(d), and FIG. 16 are operation flowcharts of the ink supply amount control device. FIGS. 17(a) and 17(b) are operation flowcharts of each ink fountain key opening degree control device. FIG. 18 is an operation flowchart of each ink fountain roller rotation speed control device.

The second embodiment is an example in which the opening degrees of the ink fountain keys 3 (3-1 to 3-n) is automatically adjusted on the basis of the average width of the printed line portion, while the ink supply amount control device 30 (or the ink fountain roller rotation speed control devices 70-1 to 70-M, to be exact) automatically adjusts the rotation speed of the ink fountain roller 4 on the basis of the maximum width of the line portion in the first embodiment.

As shown in FIGS. 10(a) and 10(b), in the ink supply amount control device 30, a CPU 31, a RAM 32, a ROM 33, input/output (I/O) devices 34 to 36, and 38, and an interface 37 are connected through a bus 39. Moreover, memories M1 to M10 are connected to the bus 39. In the memory M1, an ink color ICm of a printing unit M is stored. In the memory M2, the image area ratio IRmn of a range corresponding to each ink fountain key is stored. In the memory M3, a count value M is stored. In the memory M4, a count value N is stored. In the memory M5, a conversion table between an image area ratio and an ink fountain key opening degree is stored. In the memory M6, the opening degree Kmn of each ink fountain key is stored. In the memory M7, the total number Nmax of ink fountain keys is stored. In the memory M8, a reference ink fountain roller rotation speed ratio IFRRFm is stored. In the memory M9, an ink fountain roller rotation speed ratio IFRRm is stored. In the memory M10, the total number Mmax of printing units is stored.

Furthermore, memories M11 to M20 are also connected to the bus 39. In the memory M1, a value of a counter for measuring the current position of a line-width measuring camera in the vertical directions is stored. In the memory M12, the current position of the line-width measuring camera in the vertical directions is stored. In the memory M13, the position of a line portion, to be measured by the line-width measuring camera, in the vertical directions is stored. In the memory M14, a value of a counter for measuring the current position of the line-width measuring camera in the horizontal directions is stored. In the memory M15, the current position of the line-width measuring camera in the horizontal directions is stored. In the memory M16, the position of the line portion, to be measured by the line-width measuring camera, in the horizontal directions is stored. In the frame memory M17, a binary image signal is stored. In the memory M18, a count value Y is stored. In the memory M19, a count value X is stored. In the memory M20, a count value C for line-width measurement is stored.

Furthermore, memories M21 to M23, M35 and M36, and M26 to M28 are also connected to the bus 39. In the memory M21, the total number DPXmax of pixels detected in the horizontal directions of the line-width measuring camera is stored. In the memory M22, the total number DPYmax of pixels detected in the vertical directions of the line-width measuring camera is stored. In the memory M23, a line-width count value XCy of a line in the X directions is stored. In the memory M35, the total value XCS of line-width count values XC1 to XCy of lines in X directions is stored. In the memory M36, the average value XCA of line-width count values XC1 to XCy of lines in the X directions is stored. In the memory M26, a line width LW is stored. In the memory M27, a reference line width LWF is stored. In the memory M28, a line width difference LWD is stored.

Furthermore, memories M37 to M39, and M32 to M34 are connected to the bus 39. In the memory M37, a conversion table between a line width difference and a compensation ratio of an ink fountain key opening degree Kmn is stored. In the memory M38, a compensation ratio of the ink fountain key opening degree Kmn is stored. In the memory M39, a target ink fountain key opening degree Kmn is stored. In the memory M32, an output of an A/D convertor connected to a rotary encoder for a drive motor of the printing press is stored. In the memory M33, the current rotation speed R of the printing press is stored. In the memory M34, a rotation speed IFRm of the ink fountain roller is stored.

An input device 40 such as a keyboard, a display device 41 such as a CRT or a display, and an output device 42 such as a printer or a floppy disk (registered trademark) drive are connected to the I/O device 34. A line-width measuring camera (width measurement means) 44 for line-width measurement is connected to the I/O device 35 through a binary OP amplifier 43. Moreover, a rotary encoder 47 for a drive motor of the printing press is connected to the I/O device 36 through an A/D converter 45 and an F/V converter 46.

A motor 91 for vertical movement for line-width measurement is connected to the I/O device 38 through a motor driver 90 for vertical movement for line-width measurement. Moreover, a rotary encoder 93 for the motor for vertical movement for line-width measurement is also connected to the I/O device 38 through a counter 92 for measuring the current position of the line-width measuring camera in the vertical directions, the rotary encoder 93 being connected to and driven by the motor 91. Furthermore, a detector 94 for detecting the home position of the line-width measuring camera in the vertical directions is also connected to the I/O device 38.

In addition, a motor 96 for horizontal movement for line-width measurement is also connected to the I/O device 38 through a motor driver 95 for horizontal movement for line-width measurement. Moreover, a rotary encoder 98 for the motor for horizontal movement for line-width measurement is also connected to the I/O device 38 through a counter 97 for measuring the current position of the line-width measuring camera in the horizontal directions, the rotary encoder 98 being connected to and driven by the motor 96. Furthermore, a detector 99 for detecting the home position of the line-width measuring camera in the horizontal directions is also connected to the I/O device 38.

The first ink fountain key opening degree control device 50-(1-1) of a first printing unit to the Nth ink fountain key opening degree control device 50-(M-N) of an Mth printing unit, and the first (printing unit) ink fountain roller rotation speed control device 70-1 to the Mth (printing unit) ink fountain roller rotation speed control device 70-M are connected to the interface 37.

As shown in FIG. 11, in each of the first ink fountain key opening degree control device 50-(1-1) of the first printing unit to the Nth ink fountain key opening degree control device 50-(M-N) of the Mth printing unit, memories M54 to M57, in addition to a CPU 51, a RAM 52 and a ROM 53, are connected through a bus 60, together with an I/O device 58 and an interface 59. In the memory M54, a received ink fountain key opening degree is stored. In the memory M55, a target ink fountain key opening degree is stored. In the memory M56, a count value of a counter is stored. In the memory M57, a current ink fountain key opening degree is stored.

A motor 61 for driving the ink fountain key is connected to the I/O device 58 through a motor driver 62 for driving the ink fountain key. Moreover, a rotary encoder 63 for the motor for driving the ink fountain key is also connected to the I/O device 58 through a counter 64, the rotary encoder 63 being connected to and driven by the motor 61 for driving the ink fountain key. A detection signal from the rotary encoder 63 for the motor for driving the ink fountain key is also inputted to the motor driver 62 for driving the ink fountain key. Furthermore, the ink supply amount control device 30 is connected to the interface 59.

As shown in FIG. 12, in each of the first ink fountain roller rotation speed control device 70-1 to the Mth ink fountain roller rotation speed control device 70-M, memories M74 and M75, in addition to a CPU 71, a RAM 72 and a ROM 73, are connected through a bus 78 together with an I/O device 76 and an interface 77. In the memory M74, a received ink fountain roller rotation speed is stored. In the memory M75, a target ink fountain roller rotation speed is stored.

A motor 79 for driving the ink fountain roller is connected to the I/O device 76 through a motor driver 80 for driving the ink fountain roller. Moreover, a rotary encoder 81 for the motor for driving the ink fountain roller is also connected to the I/O device 76 through an F/V converter 82 and an A/D converter 83, the rotary encoder 81 being connected to and driven by the motor 79 for driving the ink fountain roller. A detection signal from the rotary encoder 81 for the motor for driving the ink fountain roller is also inputted to the motor driver 80 for driving the ink fountain roller. Furthermore, the ink supply amount control device 30 is connected to the interface 77.

In the second embodiment, the opening degrees of the ink fountain keys 3 (3-1 to 3-n) in the ink supply device in the printing unit of each color can be adjusted (compensated) automatically on the basis of a measurement result obtained by the line-width measuring camera 44 serving as width measurement means for measuring the average width of the line portion printed on paper W, by using the ink supply amount control device 30 (including the first ink fountain key opening degree control device 50-(1-1) of the first printing unit to the Nth ink fountain key opening degree control device 50-(M-N) of the Mth printing unit and the first ink fountain roller rotation speed control device 70-1 to the Mth ink fountain roller rotation speed control device 70-M, to be exact).

The line-width measuring camera 44 is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 38(a) to 38(c), the line-width measuring camera 44 can directly measure the average width of the line portion (the region indicated by hatching in each of FIGS. 38(a) to 38(c)) printed on the paper (print member) W placed on the main body of the checking apparatus (for details, refer to operation flowcharts to be described later). In FIGS. 38(a) to 38(c), LWF denotes a reference line width.

The ink supply amount control device 30 is configured as described above, and operates as in the operation flow shown in FIGS. 13(a) to 13(c), FIGS. 14(a) to 14(d), FIGS. 15(a) to 15(d), and FIG. 16.

Firstly, in Step P1, it is determined whether or not the ink color ICm of the printing unit M and an image area ratio IRmn of a range corresponding to each ink fountain key have been inputted. When the determination in Step P1 is YES, in Step P2, the ink color ICm of the printing unit M and the image area ratio IRmn of the range corresponding to each ink fountain key are inputted and stored respectively in the memories M1 and M2. On the other hand, when the determination in Step P1 is NO, the process proceeds to Step P3.

Then, in Step P3, it is determined whether or not an ink preset switch has been turned on. When the determination in Step P3 is YES, in Step P4, 1 is written in the count value M in the memory M3. When the determination in Step P3 is NO, the process proceeds to Step P30.

In Step P5, 1 is written in the count value N in the memory M4. Thereafter, in Step P6, the ink color ICm of the printing unit M is read from the memory M1. Then, in Step P7, the conversion table between an image area ratio corresponding to the ink color ICm and an ink fountain key opening degree is read from the memory M5.

In Step P8, the image area ratio IRmn of the range corresponding to the Nth ink fountain key of the printing unit M is read from the memory M2. Thereafter, in Step P9, the opening degree Kmn of the Nth ink fountain key of the printing unit M is obtained from the image area ratio IRmn of the range corresponding to the Nth ink fountain key of the printing unit M by using the conversion table between an image area ratio corresponding to the ink color ICm and an ink fountain key opening degree, and is then stored in the Nth address location for the printing unit M in the memory M6 for storing the opening degree Kmn of each ink fountain key.

In Step P10, the count value N in the memory M4 is incremented by 1, and is then overwritten with the resultant value. Thereafter, in Step P11, the total number Nmax of the ink fountain keys of each printing unit is read from the memory M7. Then, in Step P12, it is determined whether or not the count value N is larger than the total number Nmax of the ink fountain keys of each printing unit.

When the determination in Step P12 is YES, in Step P13, the count value M in the memory M3 is incremented by 1, and is then overwritten with the resultant value. On the other hand, when the determination in Step P12 is NO, the process returns to Step P6. Thereafter, in Step P14, the total number Mmax of the printing units is read from the memory M10. Then, in Step P15, it is determined whether or not the count value M is larger than the total number Mmax of the printing units.

When the determination in Step P15 is YES, in Step P16, 1 is written in the count value M in the memory M3. On the other hand, when the determination in Step P15 is NO, the process returns to Step P5. Thereafter, in Step P17, 1 is written in the count value N in the memory M4. Then, in Step P18, the opening degree Kmn of the Nth ink fountain key of the printing unit M is read from the memory M6.

Then, in Step P19, the ink fountain key opening degree Kmn is transmitted to the Nth ink fountain key opening degree control device of the printing unit M. Thereafter, when a reception confirmation signal is received from the Nth ink fountain key opening degree control device of the printing unit M in Step P20, in Step P21, the count value N in the memory M4 is incremented by 1, and is then overwritten with the resultant value.

In Step P22, the total number Nmax of the ink fountain keys of each printing unit is read from the memory M7. Thereafter, in Step P23, it is determined whether or not the count value N is larger than the total number Nmax of the ink fountain keys of each printing unit. When the determination in Step P23 is YES, in Step P24, the ink color ICm of the printing unit M is read from the memory M1. On the other hand, when the determination in Step P23 is NO, the process returns to Step P18.

In Step P25, the reference ink fountain roller rotation speed ratio IFRRFm corresponding to the ink color ICm is read from the memory M8. Thereafter, in Step P26, the reference ink fountain roller rotation speed ratio IFRRFm corresponding to the ink color ICm is written in the address for the printing unit M in the memory M9 for storing the ink fountain roller rotation speed ratio IFRRm.

In Step P27, the count value M in the memory M3 is incremented by 1, and is then overwritten with the resultant value. Thereafter, in Step P28, the total number Mmax of the printing units is read from the memory M10. Then, in Step P29, it is determined whether or not the count value M is larger than the total number Mmax of the printing units. When the determination in Step P29 is YES, the process proceeds to Step P30. On the other hand, when the determination in Step P29 is NO, the process returns to Step P17.

Through the above-described steps, the opening degree Kmn of each ink fountain key is transmitted to the corresponding one of the ink fountain key opening degree control devices 50-(1-1) to 50-(M-N), and a preset value of each ink fountain roller rotation speed ratio IFRRm is obtained.

In Step P30, it is determined whether or not a line-width measurement switch has been turned on. When the determination in Step P30 is YES, 1 is written in the count value M in the memory M3 in Step P31a, and 1 is written in the count value N in the memory M4 in Step P31b. On the other hand, when the determination in Step P30 is NO, the process proceeds to Step P123.

In Step P32, the value of the counter 92 for measuring the current position of the line-width measuring camera in the vertical directions is read, and is then stored in the memory M11. Thereafter, in Step P33, the current position of the line-width measuring camera 44 in the vertical directions is calculated from the read value of the counter 92 for measuring the current position of the line-width measuring camera in the vertical directions, and is then stored in the memory M12.

In Step P34, the position of the Nth line portion in the ink color ICm, to be measured by the line-width measuring camera, in the vertical directions is read from the memory M13. Thereafter, in Step P35, it is determined whether or not the current position of the line-width measuring camera 44 in the vertical directions is equal to the position of the Nth line portion in the ink color ICm, to be measured by the line-width measuring camera, in the vertical directions. When the determination in Step P35 is YES, the process proceeds to Step P49. On the other hand, when the determination in Step P35 is NO, it is determined, in Step P36, whether or not the current position of the line-width measuring camera 44 in the vertical directions is lower than the position of the Nth line portion in the ink color ICm, to be measured by the line-width measuring camera, in the vertical directions.

When the determination in Step P36 is YES, in Step P37, a normal rotation instruction is outputted to the motor driver 90 for vertical movement for line-width measurement. Thereafter, in Step P38, the value of the counter 92 for measuring the current position of the line-width measuring camera in the vertical directions is read, and is then stored in the memory M11.

In Step P39, the current position of the line-width measuring camera 44 in the vertical directions is calculated from the read value of the counter 92 for measuring the current position of the line-width measuring camera in the vertical directions, and is then stored in the memory M12. Thereafter, in Step P40, the position of the Nth line portion in the ink color ICm, to be measured by the line-width measuring camera, in the vertical directions is read from the memory M13.

In Step P41, it is determined whether or not the current position of the line-width measuring camera 44 in the vertical directions is equal to the position of the Nth line portion in the ink color ICm, to be measured by the line-width measuring camera, in the vertical directions. When the determination in Step P41 is YES, in Step P42, the output of the normal rotation instruction to the motor driver 90 for vertical movement for line-width measurement is stopped. Thereafter, the process proceeds to Step P49. On the other hand, when the determination in Step P41 is NO, the process returns to Step P38.

When the determination in Step P36 is NO, in Step P43, a reverse rotation instruction is outputted to the motor driver 90 for vertical movement for line-width measurement. Thereafter, in Step P44, the value of the counter 92 for measuring the current position of the line-width measuring camera in the vertical directions is read, and is then stored in the memory M11.

In Step P45, the current position of the line-width measuring camera 44 in the vertical directions is calculated from the read value of the counter 92 for measuring the current position of the line-width measuring camera in the vertical directions, and is then stored in the memory M12. Thereafter, in Step P46, the position of the Nth line portion in the ink color ICm, to be measured by the line-width measuring camera, in the vertical directions is read from the memory M13.

In Step P47, it is determined whether or not the current position of the line-width measuring camera 44 in the vertical directions is equal to the position of the Nth line portion in the ink color ICm, to be measured by the line-width measuring camera, in the vertical directions. When the determination in Step P47 is YES, in Step P48, the output of the reverse rotation instruction to the motor driver 90 for vertical movement for line-width measurement is stopped. Thereafter, the process proceeds to Step P49. On the other hand, when the determination in Step P47 is NO, the process returns to Step P44.

In Step P49, the value of the counter 97 for measuring the current position of the line-width measuring camera in the horizontal directions is read, and is then stored in the memory M14. Thereafter, in Step P50, the current position of the line-width measuring camera 44 in the horizontal directions is calculated from the read value of the counter 97 for measuring the current position of the line-width measuring camera in the horizontal directions, and is then stored in the memory M15.

In Step P51, the position of the Nth line portion in the ink color ICm, to be measured by the line-width measuring camera, in the horizontal directions is read from the memory M16. Thereafter, in Step P52, it is determined whether or not the current position of the line-width measuring camera 44 in the horizontal directions is equal to the position of the Nth line portion in the ink color ICm, to be measured by the line-width measuring camera, in the horizontal directions. When the determination in Step P52 is YES, the process proceeds to Step P66. On the other hand, when the determination in Step P52 is NO, it is determined, in Step P53, whether or not the current position of the line-width measuring camera 44 in the horizontal directions is smaller than the position of the Nth line portion in the ink color ICm, to be measured by the line-width measuring camera, in the horizontal directions.

When the determination in Step P53 is YES, in Step P54, a normal rotation instruction is outputted to the motor driver 95 for horizontal movement for line-width measurement. Thereafter, in Step P55, the value of the counter 97 for measuring the current position of the line-width measuring camera in the horizontal directions is read, and is then stored in the memory M14.

In Step P56, the current position of the line-width measuring camera 44 in the horizontal directions is calculated from the read value of the counter 97 for measuring the current position of the line-width measuring camera in the horizontal directions, and is then stored in the memory M15. Thereafter, in Step P57, the position of the Nth line portion in the ink color ICm, to be measured by the line-width measuring camera, in the horizontal directions is read from the memory M16.

In Step P58, it is determined whether or not the current position of the line-width measuring camera 44 in the horizontal directions is equal to the position of the Nth line portion in the ink color ICm, to be measured by the line-width measuring camera, in the horizontal directions. When the determination in Step P58 is YES, in Step P59, the output of the normal rotation instruction to the motor driver 95 for horizontal movement for line-width measurement is stopped. Thereafter, the process proceeds to Step P66. On the other hand, when the determination in Step P58 is NO, the process returns to Step P55.

When the determination in Step P53 is NO, in Step P60, a reverse rotation instruction is outputted to the motor driver 95 for horizontal movement for line-width measurement. Thereafter, in Step P61, the value of the counter 97 for measuring the current position of the line-width measuring camera in the horizontal directions is read, and is then stored in the memory M14.

In Step P62, the current position of the line-width measuring camera 44 in the horizontal directions is calculated from the read value of the counter 97 for measuring the current position of the line-width measuring camera in the horizontal directions, and is then stored in the memory M15. Thereafter, in Step P63, the position of the Nth line portion in the ink color ICm, to be measured by the line-width measuring camera, in the horizontal directions is read from the memory M16.

In Step P64, it is determined whether or not the current position of the line-width measuring camera 44 in the horizontal directions is equal to the position of the Nth line portion in the ink color ICm, to be measured by the line-width measuring camera, in the horizontal directions. When the determination in Step P64 is YES, in Step P65, the output of the reverse rotation instruction to the motor driver 95 for horizontal movement for line-width measurement is stopped. Thereafter, the process proceeds to Step P66. On the other hand, when the determination in Step P64 is NO, the process returns to Step P61.

In Step P66, a measurement signal is outputted to the line-width measuring camera 44. Thereafter, in Step P67a, a binary image signal is received from the line-width measuring camera 44, and is then stored in the Nth address location for the ink color ICm in the frame memory M17.

In Step P67b, the count value N in the memory M4 is incremented by 1, and is then overwritten with the resultant value. Thereafter, in Step P67c, the total number Nmax of the ink fountain keys of each printing unit is read from the memory M7. Then, in Step P67d, it is determined whether or not the count value N is larger than the total number Nmax of the ink fountain keys of each printing unit. When the determination in Step P67d is YES, the process proceeds to Step P68. On the other hand, when the determination in Step P67d is NO, the process returns to Step P32.

In Step P68, the count value M in the memory M3 is incremented by 1, and is then overwritten with the resultant value. Thereafter, in Step P69, the total number Mmax of the printing units is read from the memory M10. Then, in Step P70, it is determined whether or not the count value M is larger than the total number Mmax of the printing units.

When the determination in Step P70 is YES, a reverse rotation instruction is outputted to the motor driver 95 for horizontal movement for line-width measurement in Step P71. On the other hand, when the determination in Step P70 is NO, the process returns to Step P31b.

When an output of the detector 99 for detecting the home position of the line-width measuring camera 44 in the horizontal directions is turned on in Step P72, in Step P73, the output of the reverse rotation instruction to the motor driver 95 for horizontal movement for line-width measurement is stopped. In Step P74, a reverse rotation instruction is outputted to the motor driver 90 for vertical movement for line-width measurement.

When an output of the detector 94 for detecting the home position of the line-width measuring camera 44 in the vertical directions is turned on in Step P75, in Step P76, the output of the reverse rotation instruction to the motor driver 90 for vertical movement for line-width measurement is stopped.

Through the above-described steps, the binary image signal of the line portion, corresponding to each ink fountain key, in each ink color ICm, is received from the line-width measuring camera 44.

Next, in Step P77a, 1 is written in the count value M in the memory M3. In Step P77b, 1 is written in the count value N in the memory M4. In Step P78, 1 is written in the count value Y in the memory M18. In Step P79, 1 is written in the count value X in the memory M19. Thereafter, in Step P80, 0 is written in the memory M20 for storing a count value C for line-width measurement.

In Step P81, the ink color ICm of the printing unit M is read from the memory M1. Then, in Step P82, an image data Ixy of the Nth address (X,Y) for the ink color ICm is read from the frame memory M17. Thereafter, in Step P83, it is determined whether or not the image data Ixy is 1.

When the determination in Step P83 is YES, in Step P84, the count value C for line-width measurement is read from the memory M20. On the other hand, when the determination in Step P83 is NO, the process proceeds to Step P86. In Step P85, the count value C for line-width measurement is incremented by 1, and is then overwritten with the resultant value in the memory M20 for storing the count value C for line-width measurement. Thereafter, in Step P86, the count value X in the memory M19 is incremented by 1, and is then overwritten with the resultant value.

In Step P87, the total number DPXmax of the pixels detected in the horizontal directions of the line-width measuring camera is read from the memory M21. Thereafter, in Step P88, it is determined whether or not the count value X is larger than the total number DPXmax of the pixels detected in the horizontal directions of the line-width measuring camera. When the determination in Step 88 is YES, in Step P89, the value is read from the memory M20 for storing the count value C for line-width measurement. On the other hand, when the determination in Step 88 is NO, the process returns to Step P81.

In Step P90, the Yth address location in the memory M23 for storing the line-width count value XCy of the line in the X directions is overwritten with the count value C for line-width measurement. Thereafter, in Step P91, the count value Y in the memory M18 is incremented by 1, and is then overwritten with the resultant value.

In Step P92, the total number DPYmax of pixels detected in the vertical directions of the line-width measuring camera is read from the memory M22. Thereafter, in Step P93, it is determined whether or not the count value Y is larger than the total number DPYmax of pixels in the vertical directions of the line-width measuring camera. When the determination in Step P93 is YES, in Step P94, the memory M35 for storing the total value XCS of the line-width count values XC1 to XCy of the lines in the X directions is initialized. On the other hand, when the determination in Step P93 is NO, the process returns to Step P79.

Through the above-described steps, the pixel numbers corresponding to the widths of the lines in the horizontal directions (X directions) are obtained, the lines being lined in the vertical directions (Y directions).

In Step P95, 1 is written in the count value Yin the memory M18. Thereafter, in Step P96, the value of the Yth address location in the memory M23 for storing line-width count value XCy of the line in the X directions is read. Then, in Step P97, the total value XCS of the line-width count values XC1 to XCy of the lines in X directions is read from the memory M35.

In Step P98, the value of the Yth address location in the memory M23 for storing the line-width count value XCy of the line in the X directions is added to the total value XCS of the line-width count values XC1 to XCy of the lines in the X directions, and the memory M35 for storing the total value XCS of the line-width count values XC1 to XCy of the lines in the X directions is overwritten with the resultant value. Thereafter, in Step P99, the count value Y in the memory M18 is incremented by 1, and is then overwritten with the resultant value.

In Step P100, the total number DPYmax of pixels detected in the vertical directions of the measuring camera is read from the memory M22. Thereafter, in Step P101, it is determined whether or not the count value Y is larger than the total number DPYmax of pixels in the vertical directions of the measuring camera. When the determination in Step P101 is YES, in Step P102, the total value XCS of the line-width count values XC1 to XCy of the lines in the X directions is read from the memory M35. On the other hand, when the determination in Step P101 is NO, the process returns to Step P96.

In Step P103, the total number DPYmax of pixels detected in the vertical directions of the measuring camera is read from the memory M22. Thereafter, in Step P104, the average value XCA of the line-width count values XC1 to XCy of the lines in the X directions is calculated by dividing the total value XCS of the line-width count values XC1 to XCy of the lines in the X directions by the total number DPYmax of pixels detected in the vertical directions of the measuring camera, and is then stored in the memory M36.

Through the above-described steps, the number of pixels corresponding to the average line width of the lines in the horizontal directions (X directions) is obtained.

In Step P105, the line width LW is calculated from the average value XCA of the line-width count values XC1 to XCy of the lines in the X directions, and is then stored in the memory M26. Thereafter, in Step P106, the reference line width LWF is read from the memory M27. Then, in Step P107, the line width difference LWD is calculated by subtracting the reference line width LWF from the line width LW, and is then stored in the memory M28.

In Step P108, the ink color ICm of the printing unit M is read from the memory M1. Thereafter, in Step P109, the conversion table between line width difference of the ink color ICm and a compensation ratio of the ink fountain key opening degree Km is read from the memory M37. In Step P110, the compensation ratio of the opening degree Kmn of the Nth ink fountain key of the printing unit M is obtained from the line width difference LWD by using the conversion table between line width difference of the ink color ICm and a compensation ratio of the ink fountain key opening degree Km, and is then stored in the memory M38. Thereafter, in Step P111, the opening degree Kmn of the Nth ink fountain key of the printing unit M is read from the memory M6.

In Step P112, a target opening degree Kmn of the Nth ink fountain key of the printing unit M is obtained by multiplying the opening degree Kmn of the Nth ink fountain key of the printing unit M by the compensation ratio of the opening degree Kmn of the Nth ink fountain key of the printing unit M, and is then stored in the Nth address location for the printing unit M in the memory M39.

In Step P113, the target opening degree Kmn of the Nth ink fountain key of the printing unit M is stored in the Nth address location for the printing unit M in the memory M6 for storing the ink fountain key opening degree Kmn. Thereafter, in Step P114, the opening degree Kmn of the Nth ink fountain key of the printing unit M is transmitted to the Nth ink fountain key opening degree control device of the printing unit M.

When a reception confirmation signal is transmitted from the Nth ink fountain key opening degree control device of the printing unit M in Step P115, the count value N in the memory M4 is incremented by 1, and is then overwritten with the resultant value, in Step P116. Then, in Step P117, the total number Nmax of the ink fountain keys is read from the memory M7.

In Step P118, it is determined whether or not the count value N is larger than the total number Nmax of the ink fountain keys. When the determination in Step P118 is YES, in Step P119, the count value M in the memory M3 is incremented by 1, and is then overwritten with the resultant value. On the other hand, when the determination in Step P118 is NO, the process returns to Step P78.

In Step P120, the total number Mmax of the printing units is read from the memory M10. Thereafter, in Step P121, it is determined whether or not the count value M is larger than the total number Mmax of the printing units. When the determination in Step P121 is YES, the process returns to Step P1. When the determination in Step P121 is NO, the process returns to Step P77b.

Through the above-described steps, the opening degree Kmn of each ink fountain key of each printing unit is set at the opening degree compensated in accordance with the difference of the average line width of the corresponding line portion.

When the determinations in Step P1, Step P3 and Step P30 are NO, in Step P122, 1 is written in the count value M in the memory M3. Thereafter, in Step P123, an output of the A/D converter 45 connected to the rotary encoder 47 for the drive motor of the printing press is read, and is stored in the memory M32. Then, in Step P124, the current rotation speed R of the printing press is calculated from the output of the A/D converter 45 connected to the rotary encoder 47 for the drive motor of the printing press, and is then stored in the memory M33.

In Step P125, the ink fountain roller rotation speed ratio IFRRm of the printing unit M is read from the memory M9. Thereafter, in Step P126, the ink fountain roller rotation speed IFRm of the printing unit M is calculated by multiplying the current rotation speed R of the printing press by the ink fountain roller rotation speed ratio IFRRm of the printing unit M, and is then stored in the address location for the printing unit M in the memory M34.

In Step P127, the ink fountain roller rotation speed IFRm of the printing unit M is transmitted to the ink fountain roller rotation speed control device of the printing unit M. Thereafter, when a reception confirmation signal is transmitted from the ink fountain roller rotation speed control device of the printing unit M in Step P128, the count value M in the memory M3 is incremented by 1, and is then overwritten with the resultant value, in Step P129.

In Step P130, the total number Mmax of the printing units is read from the memory M10. Thereafter, in Step P131, it is determined whether or not the count value M is larger than the total number Mmax of the printing units. When the determination in Step P131 is YES, the process returns to Step P1. On the other hand, when the determination in Step P131 is NO, the process returns to Step P123. Thereafter, this process is repeated.

Through the above-described steps, the rotation speed IFRm of each ink fountain roller according to the current rotation speed R of the printing press is transmitted to the corresponding one of the ink fountain roller rotation speed control devices 70-1 to 70-M.

The first ink fountain key opening degree control device 50-(1-1) of the first printing unit to the Nth ink fountain key opening degree control device 50-(M-N) of the Mth printing unit each operate as in the operation flow shown in FIGS. 17(a) and 17(b).

Specifically, when an ink fountain key opening degree Kmn is transmitted from the ink supply amount control device 30 in Step P1, in Step P2, the ink fountain key opening degree Kmn is received, and is then stored in the memory M54 for storing the received ink fountain key opening degree Kmn. Thereafter, in Step P3, a reception confirmation signal is transmitted to the ink supply amount control device 30.

In Step P4, the received ink fountain key opening degree Kmn is written in the memory M55 for storing the target ink fountain key opening degree (position). Thereafter, in Step P5, the count value of the counter 64 is read, and is then stored in the memory M56. Then, in Step P6, the current ink fountain key opening degree (position) is calculated from the count value of the counter 64, and is then stored in the memory M57.

In Step P7, it is determined whether or not the target position of the ink fountain key is equal to the current position of the ink fountain key. When the determination in Step P7 is YES, the process returns to Step P1. On the other hand, when the determination in Step P7 is NO, it is determined, in Step P8, whether or not the target position of the ink fountain key is larger than the current position of the ink fountain key.

When the determination in Step P8 is YES, in Step P9 a normal rotation instruction is outputted to the motor driver 62 for driving the ink fountain key. When the determination in Step P8 is NO, in Step P10, a reverse rotation instruction is outputted to the motor driver 62 for driving the ink fountain key.

In Step P11, the count value of the counter 64 is read, and is then stored in the memory M56. Thereafter, in Step P12, the current position of the ink fountain key is calculated from the count value of the counter 64, and is then stored in the memory M57.

In Step P13, it is determined whether or not the current position of the ink fountain key is equal to the target position of the ink fountain key. When the determination in Step P13 is YES, in Step P14 a stop instruction is outputted to the motor driver 62 for driving the ink fountain key. Then, the process returns to Step P1. When the determination in Step P13 is NO, the process returns to Step P11. Thereafter, this process is repeated.

The first ink fountain roller rotation speed control device to the Mth ink fountain roller rotation speed control device each operate as in the operation flow shown in FIG. 18.

Specifically, when an ink fountain roller rotation speed IFRm is transmitted from the ink supply amount control device 30 in Step P1, in Step P2, the ink fountain roller rotation speed IFRm is received, and is then stored in the memory M74 for storing the received ink fountain roller rotation speed IFRm. Thereafter, in Step P3, a reception confirmation signal is transmitted to the ink supply amount control device 30.

In Step P4, the received ink fountain roller rotation speed IFRm is written and stored in the memory M75 for storing the target ink fountain roller rotation speed. Thereafter, in Step P5, the target ink fountain roller rotation speed is read from the memory M75.

In Step P6, a rotation speed instruction of the target ink fountain roller rotation speed is outputted to the motor driver 80 for driving the ink fountain roller. Then, the process returns to Step P1. Thereafter, this process is repeated.

As described above, in the second embodiment, the average width of the printed line portion is measured by the line-width measuring camera 44. Then, the ink supply amount control device 30 (or the ink fountain key opening degree control devices 50-(1-1) to 50-(M-N), to be exact) controls the drive of the motor 61 on the basis of the measurement result. Thereby, the opening degrees of the ink fountain keys 3 (3-1 to 3-n) are automatically adjusted. With this configuration, it is possible to avoid anticipated troubles due to an oversupply or undersupply of ink. The troubles are for example, that ink spreads to the outside of the printing pattern, and that a portion of the pattern is not printed. Consequently, it is possible to reduce the burden of the operator, and also to reduce the amount of waste paper to be produced, by preventing errors in manual adjustment.

### Third Embodiment

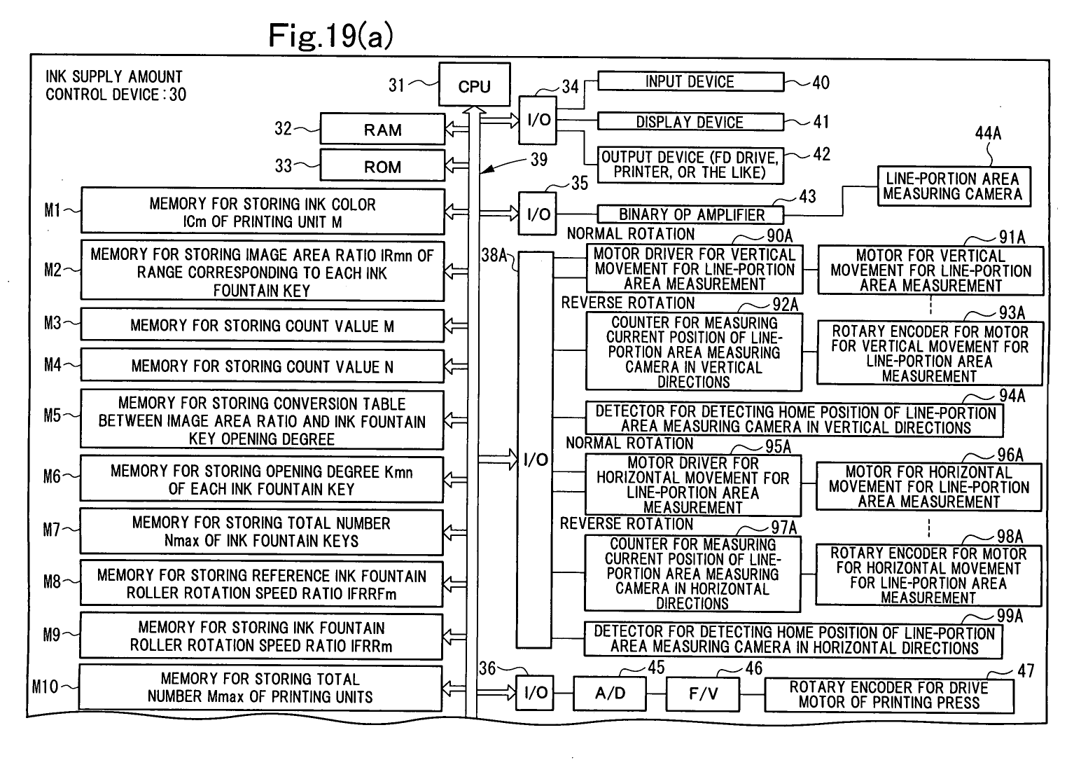

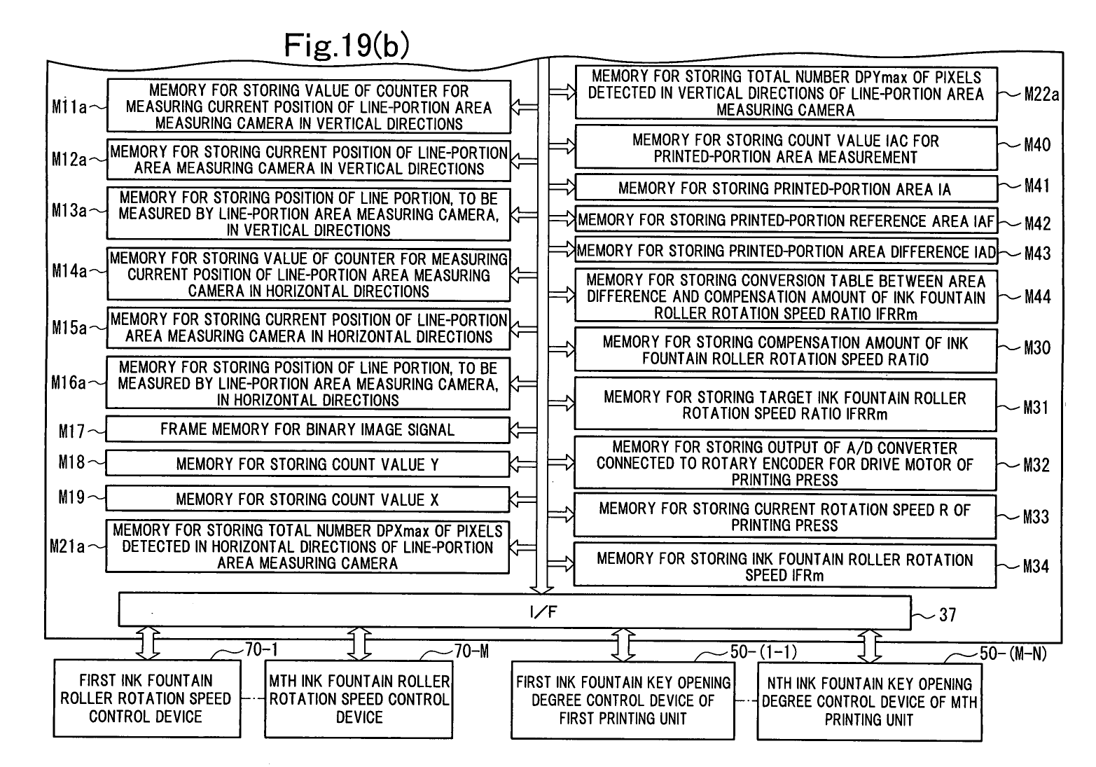

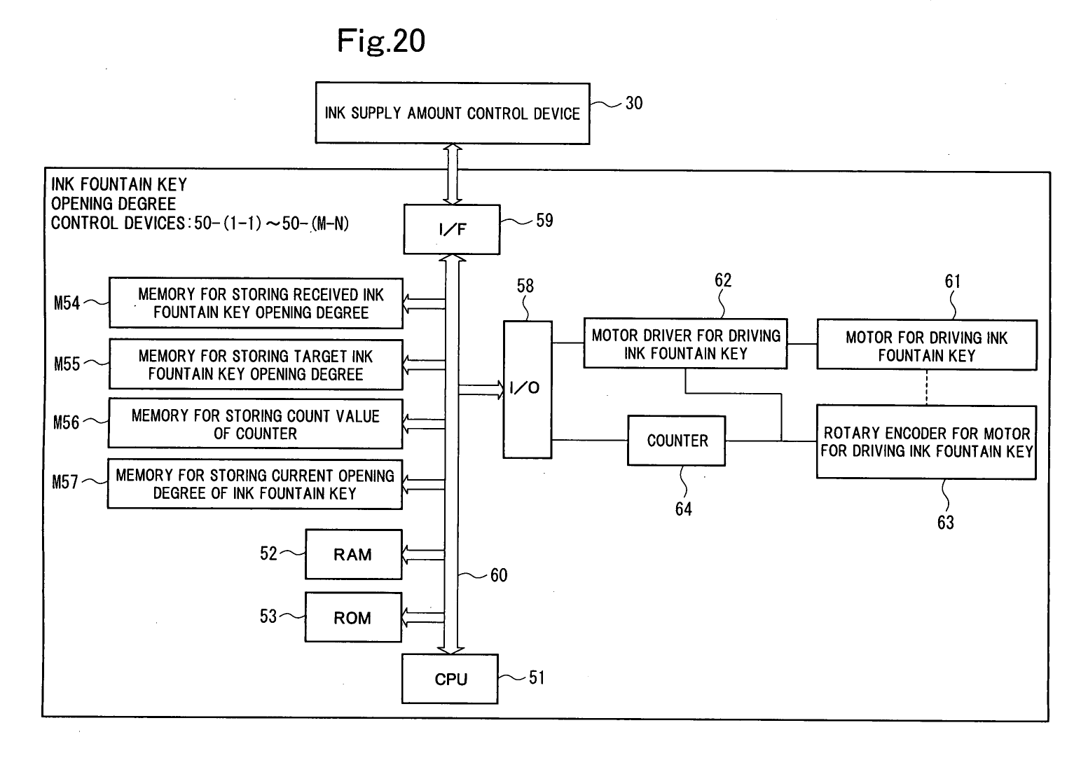

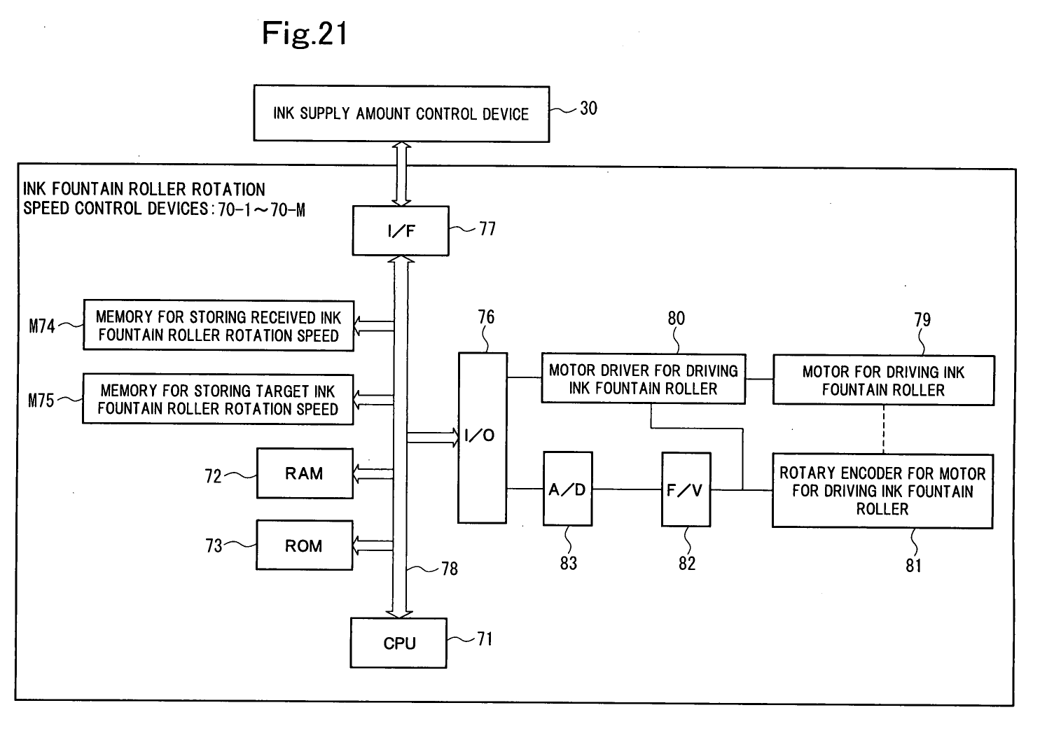

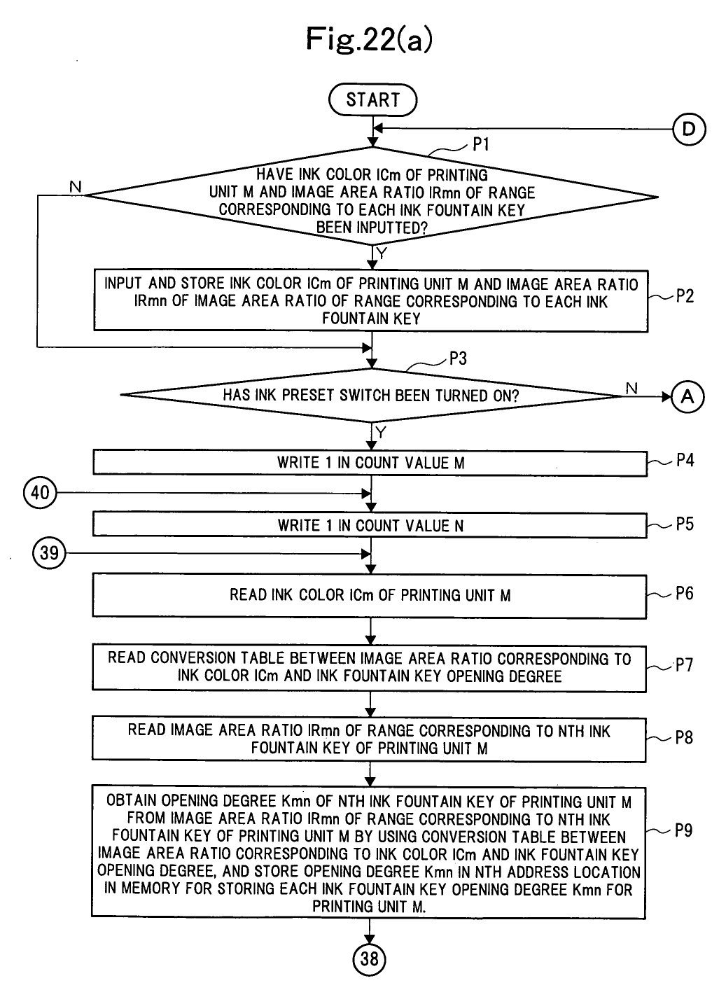

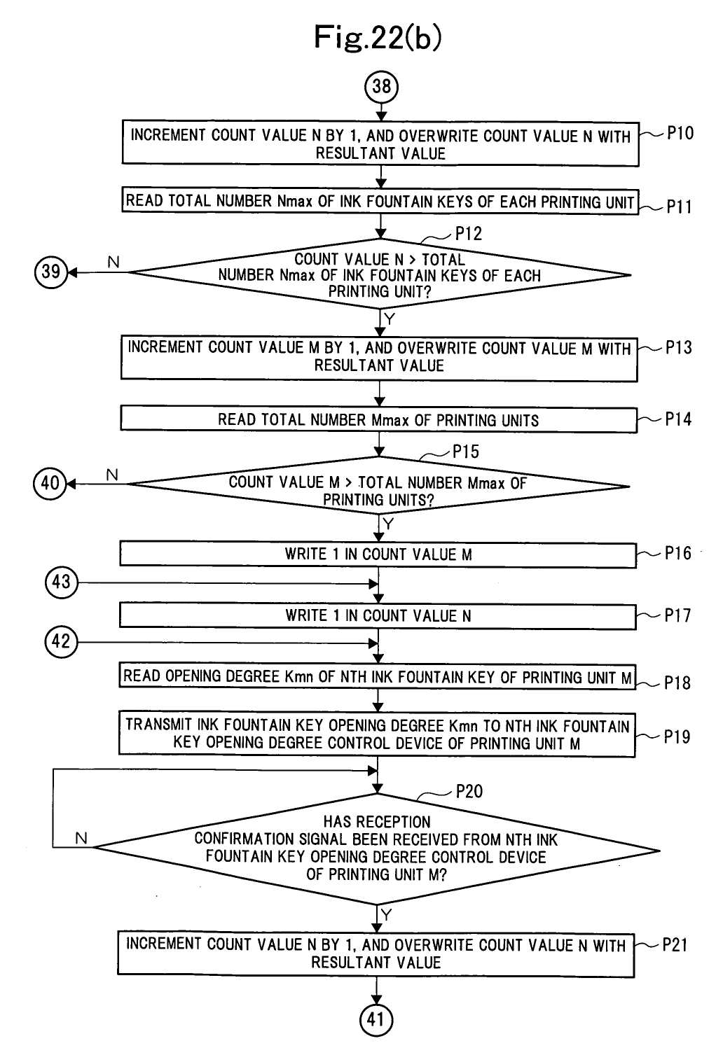

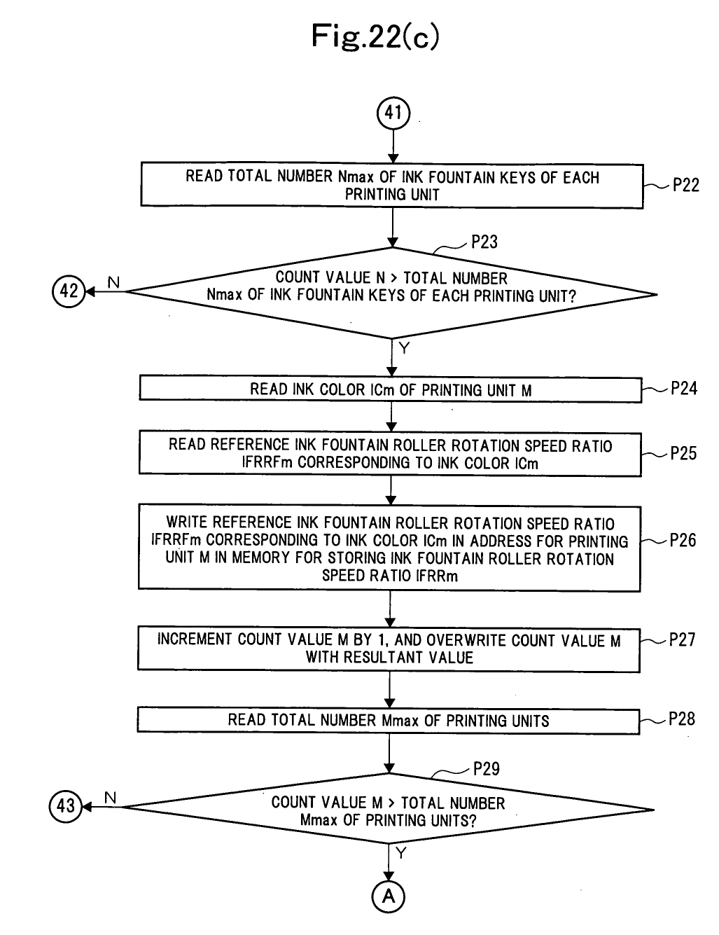

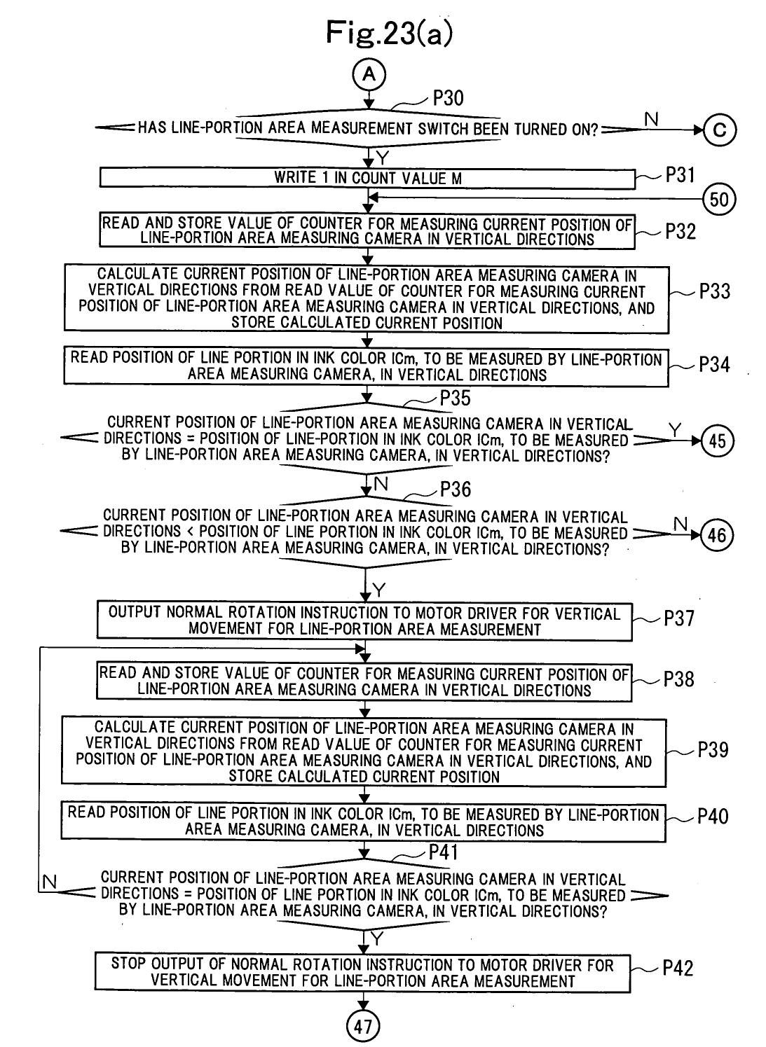

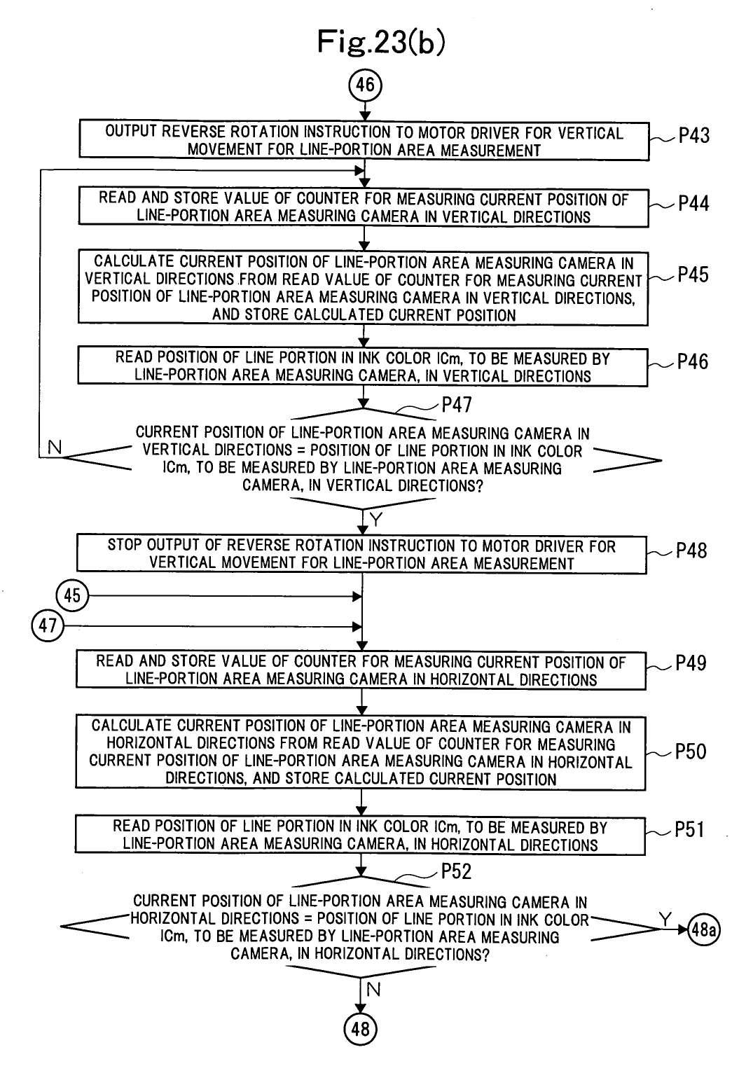

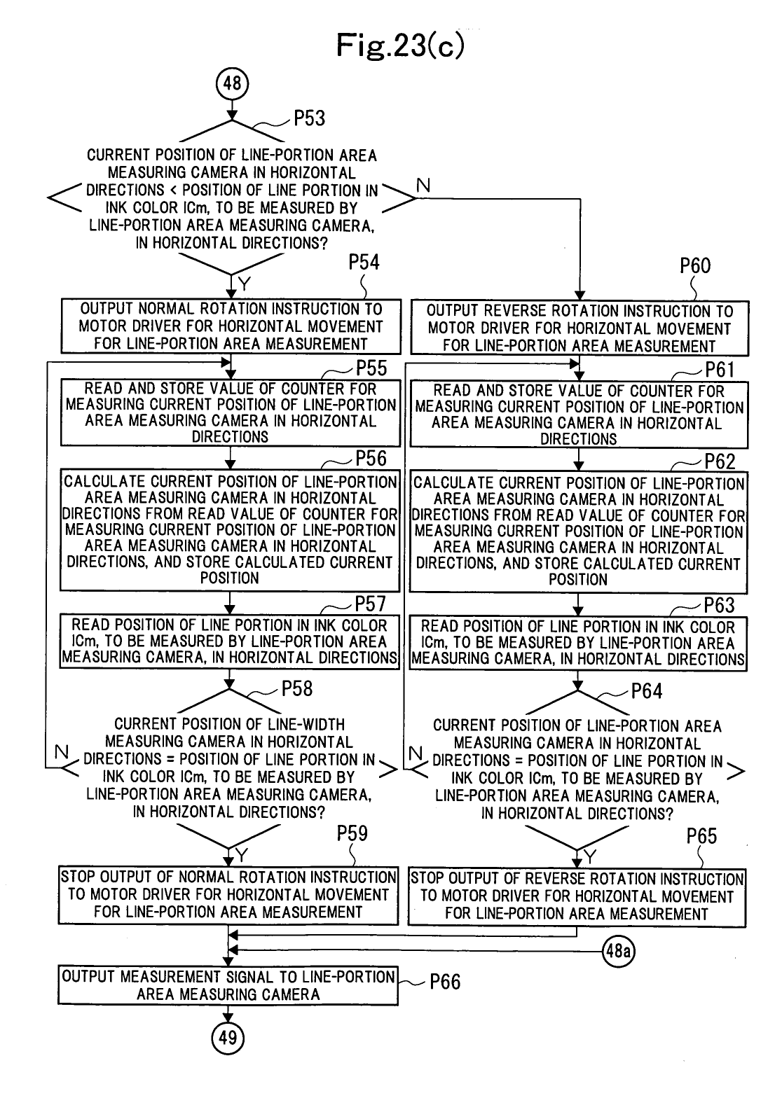

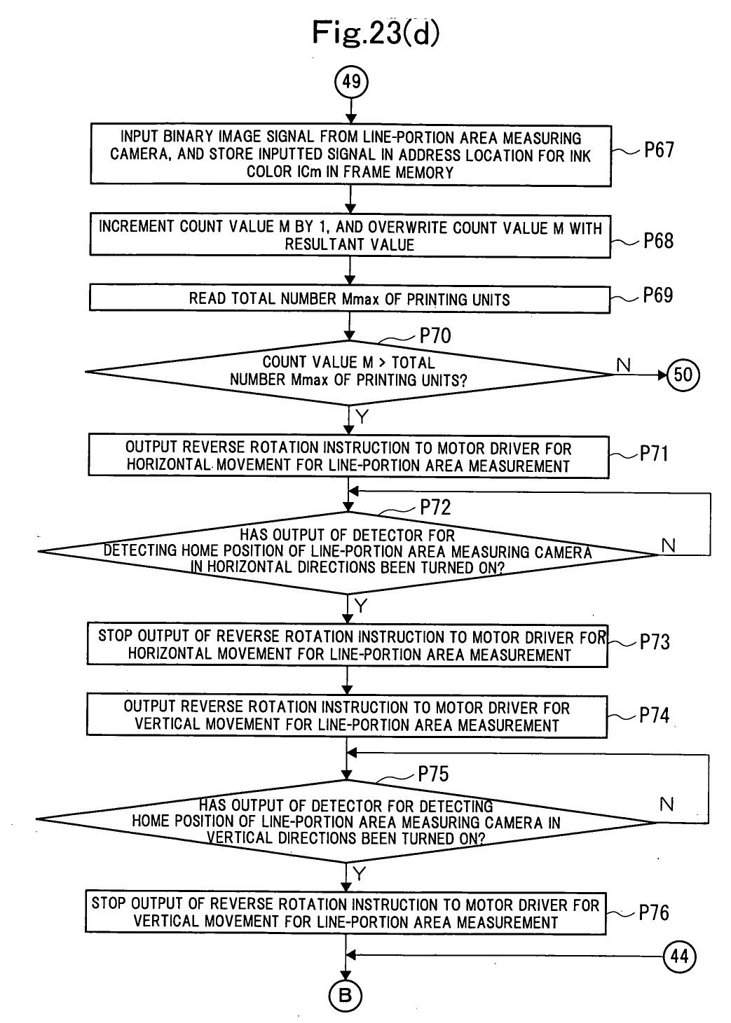

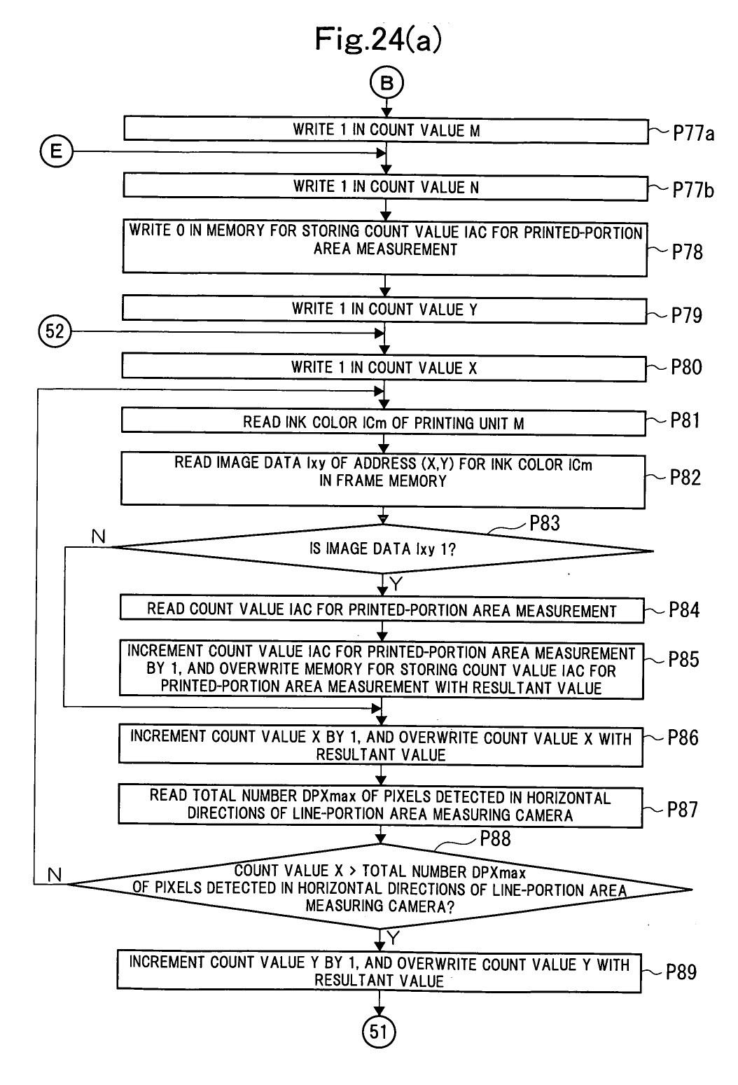

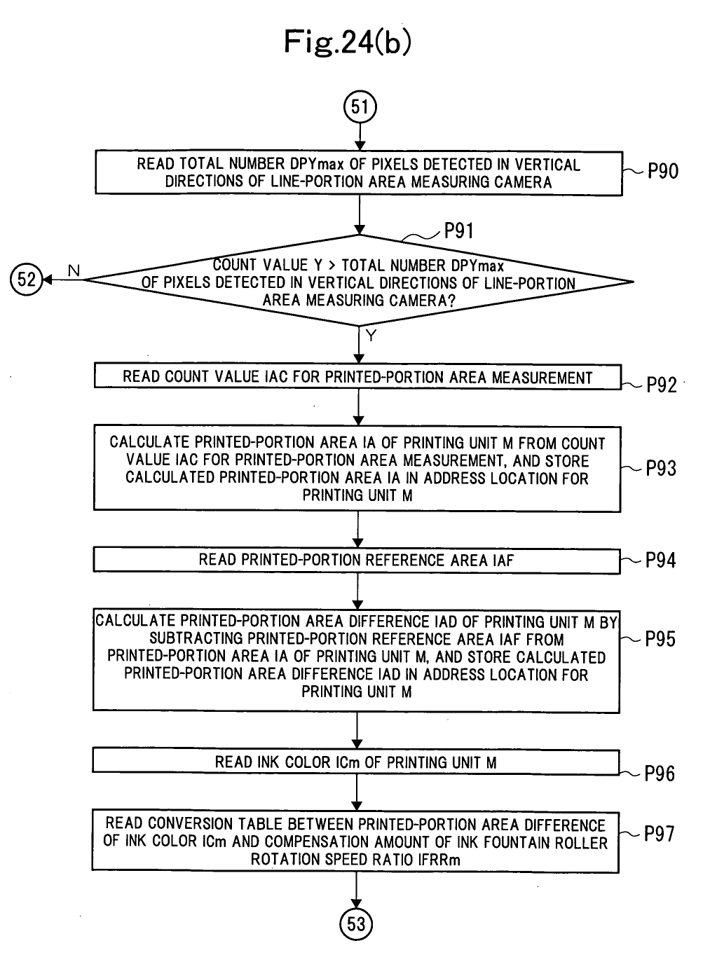

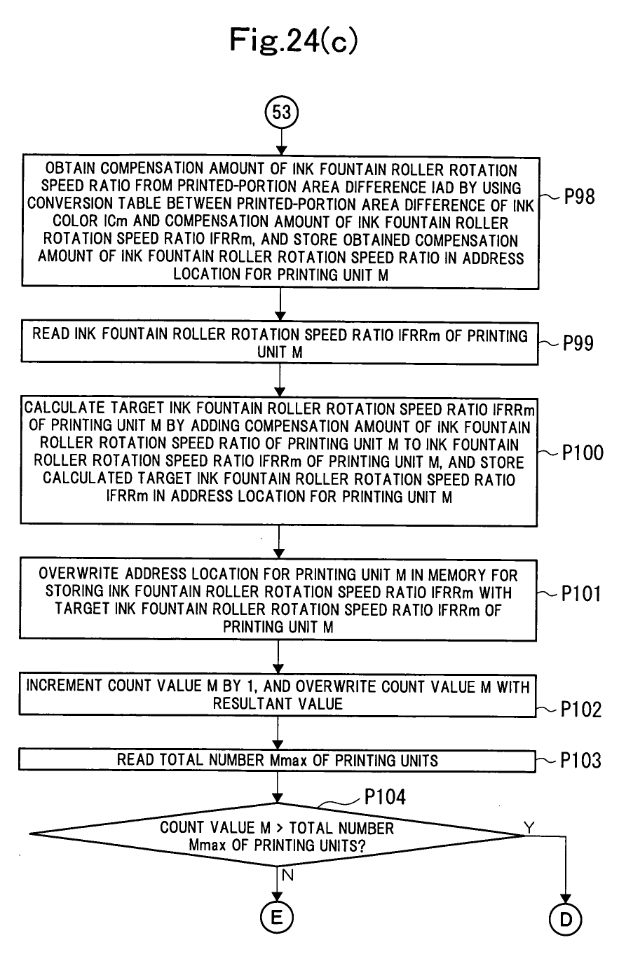

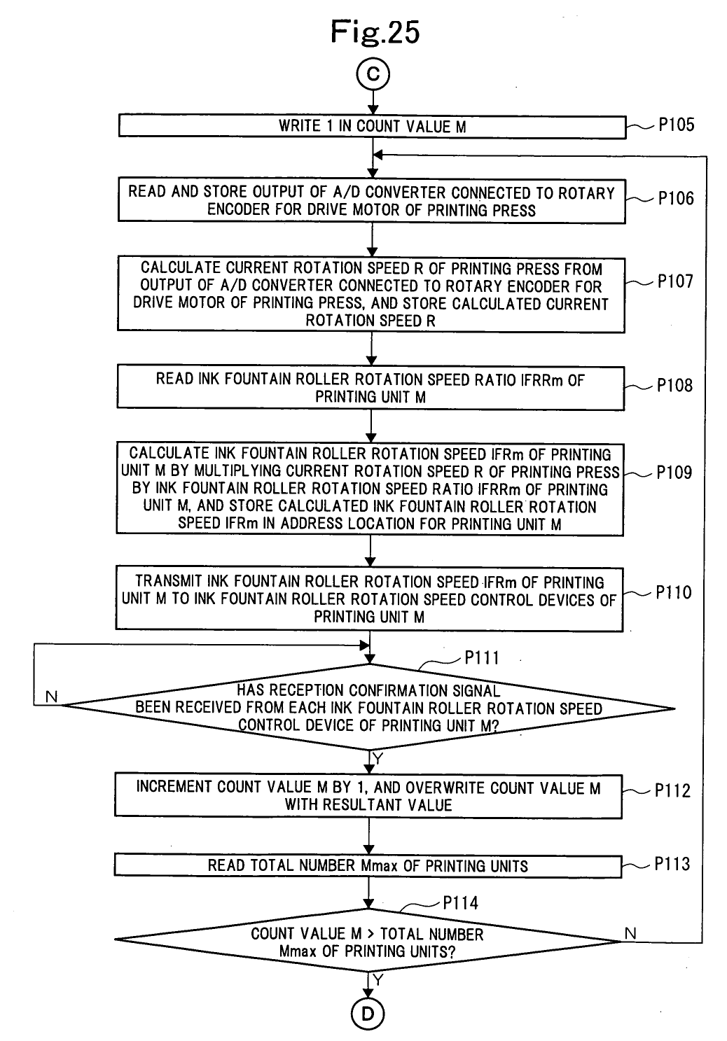

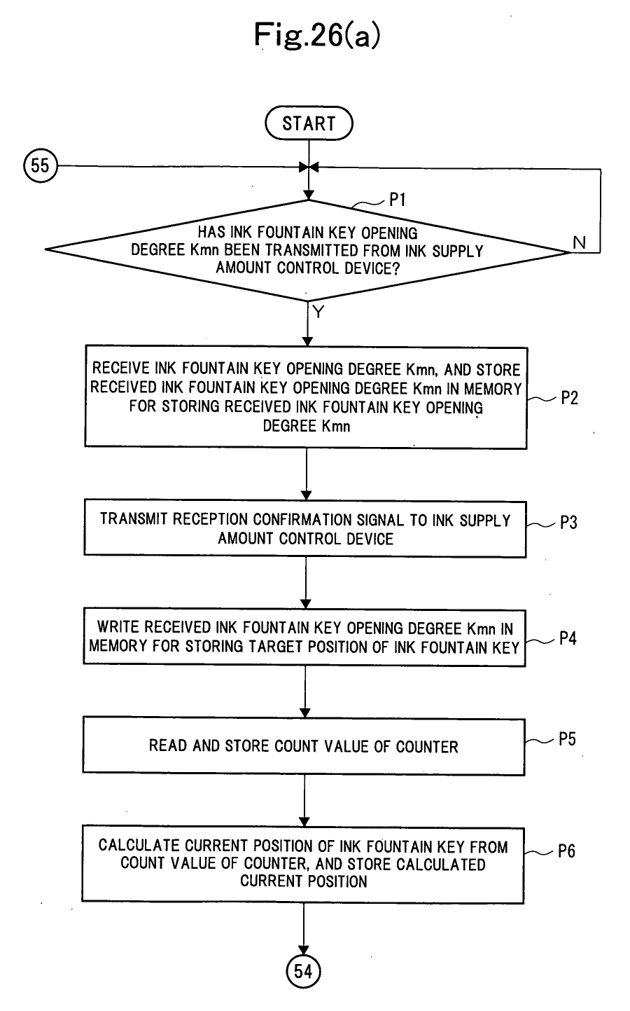

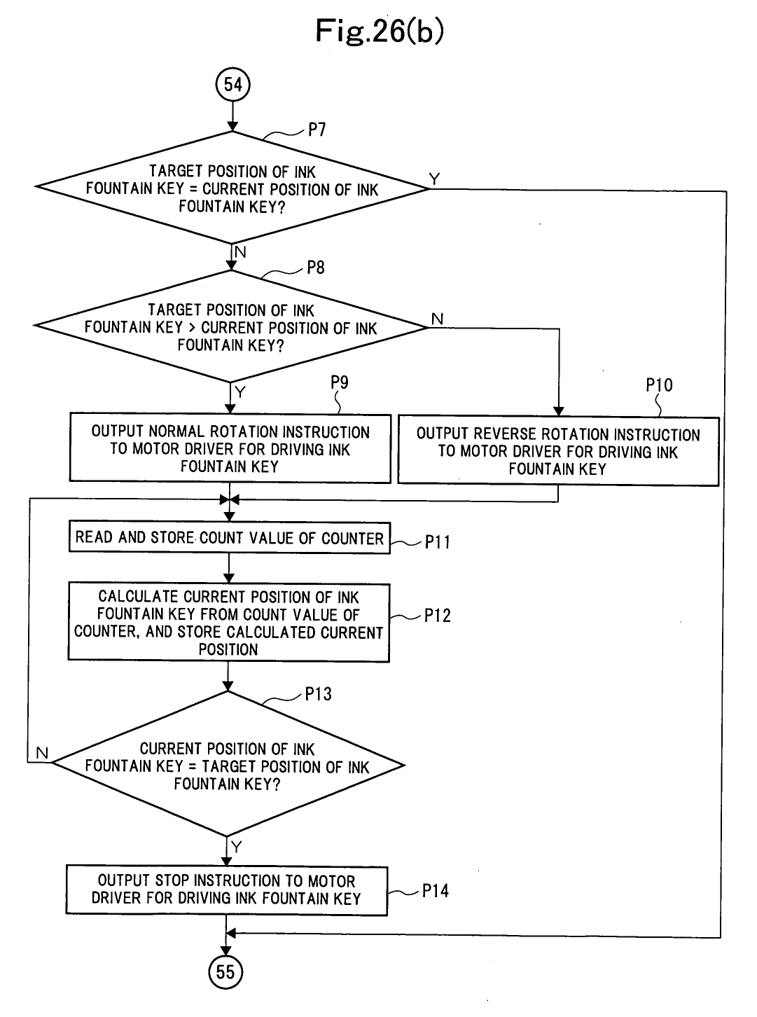

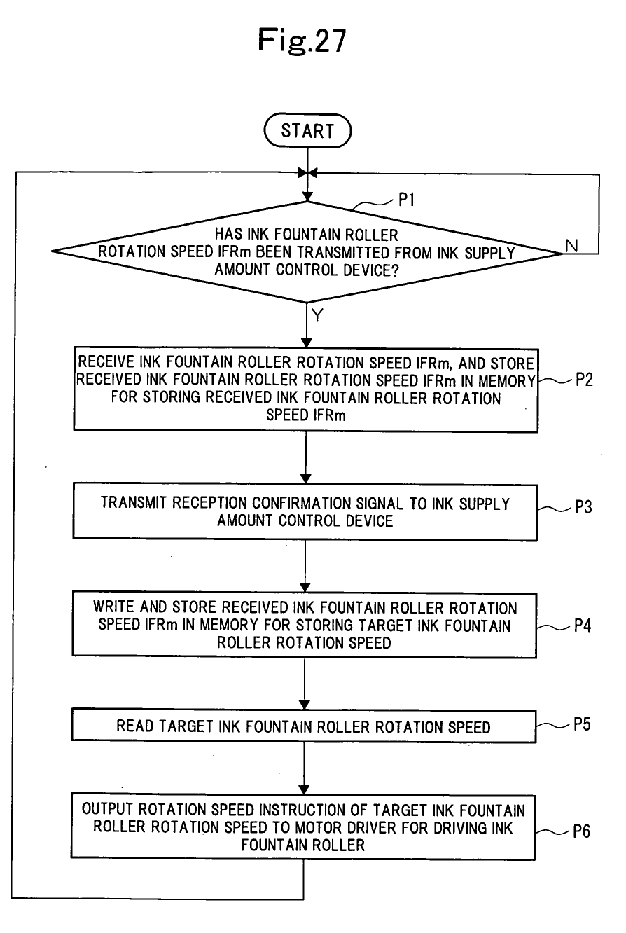

FIGS. 19(a) and 19(b) are control block diagrams of an ink supply amount control device showing a third embodiment of the present invention. FIG. 20 is a control block diagram of each ink fountain key opening degree control device. FIG. 21 is a control block diagram of each ink fountain roller rotation speed control device. FIGS. 22(a) to 22(c), FIGS. 23(a) to 23(d), FIGS. 24(a) to 24(d), and FIG. 25 are operation flowcharts of the ink supply amount control device. FIGS. 26(a) and 26(b) are operation flowcharts of each ink fountain key opening degree control device. FIG. 27 is an operation flowchart of each ink fountain roller rotation speed control device.

The third embodiment is an example in which the rotation speed of the ink fountain roller 4 on the basis of the area of the printed line portion is automatically adjusted, while the ink supply amount control device 30 (or the ink fountain roller rotation speed control devices 70-1 to 70-M, to be exact) automatically adjusts the rotation speed of the ink fountain roller 4 on the basis of the maximum width of the line portion in the first embodiment.

As shown in FIGS. 19(a) and 19(b), in the ink supply amount control device 30, a CPU 31, a RAM 32, a ROM 33, input/output (I/O) devices 34 to 36, and 38A, and an interface 37 are connected through a bus 39. Moreover, memories M1 to M10 are connected to the bus 39. In the memory M1, an ink color ICm of a printing unit M is stored. In the memory M2, the image area ratio IRmn of a range corresponding to each ink fountain key is stored. In the memory M3, a count value M is stored. In the memory M4, a count value N is stored. In the memory M5, a conversion table between an image area ratio and an ink fountain key opening degree is stored. In the memory M6, the opening degree Kmn of each ink fountain key is stored. In the memory M7, the total number Nmax of ink fountain keys is stored. In the memory M8, a reference ink fountain roller rotation speed ratio IFRRFm is stored. In the memory M9, an ink fountain roller rotation speed ratio IFRRm is stored. In the memory M10, the total number Mmax of printing units is stored.

Furthermore, memories M11a, M12a, M13a, M14a, M15a, M16a, M17, M40, M18 and M19 are also connected to the bus 39. In the memory M11a, a value of a counter for measuring the current position of a line-portion area measuring camera in the vertical directions is stored. In the memory M12a, the current position of the line-portion area measuring camera in the vertical directions is stored. In the memory M13a, the position of a line portion, to be measured by the line-portion area measuring camera, in the vertical directions is stored. In the memory M14a, a value of a counter for measuring the current position of the line-portion area measuring camera in the horizontal directions is stored. In the memory M15a, the current position of the line-portion area measuring camera in the horizontal directions is stored. In the memory M16a, the position of the line portion, to be measured by the line-portion area measuring camera, in the horizontal directions is stored. In the frame memory M17, a binary image signal is stored. In the memory M40, a count value IAC for printed-portion area measurement is stored. In the memory M18, a count value Y is stored. In the memory M19, a count value X is stored.

Furthermore, memories M21a, M22a, and M41 to M44 are also connected to the bus 39. In the memory M21a, the total number DPXmax of pixels detected in the horizontal directions of the line-portion area measuring camera is stored. In the memory M22a, the total number DPYmax of pixels detected in the vertical directions of the line-portion area measuring camera is stored. In the memory M41, a printed-portion area IA is stored. In the memory M42, a printed-portion reference area IAF is stored. In the memory M43, a printed-portion area difference IAD is stored. In the memory M44, a conversion table between area difference and a compensation amount of an ink fountain roller rotation speed ratio IFRRm is stored.

Furthermore, memories M30 to M34 are also connected to the bus 39. In the memory M30, a compensation amount of an ink fountain roller rotation speed ratio is stored. In the memory M31, a target ink fountain roller rotation speed ratio IFRRm is stored. In the memory M32, an output of an A/D convertor connected to a rotary encoder for a drive motor of the printing press is stored. In the memory M33, the current rotation speed R of the printing press is stored. In the memory M34, an ink fountain roller rotation speed IFRm is stored.

An input device 40 such as a keyboard, a display device 41 such as a CRT or a display, and an output device 42 such as a printer or a floppy disk (registered trademark) drive are connected to the I/O device 34. A line-portion area measuring camera (area measurement means) 44A for line-portion area measurement is connected to the I/O device 35 through a binary OP amplifier 43. Moreover, a rotary encoder 47 for a drive motor of the printing press is connected to the I/O device 36 through an A/D converter 45 and an F/V converter 46.

A motor 91A for vertical movement for line-portion area measurement is connected to the I/O device 38A through a motor driver 90A for vertical movement for line-portion area measurement. Moreover, a rotary encoder 93A for the motor for vertical movement for line-portion area measurement is also connected to the I/O device 38A through a counter 92A for measuring the current position of the line-portion area measuring camera in the vertical directions, the rotary encoder 93A being connected to and driven by the motor 91A. Furthermore, a detector 94A for detecting the home position of the line-portion area measuring camera in the vertical directions is also connected to the I/O device 38A.

In addition, a motor 96A for horizontal movement for line-portion area measurement is also connected to the I/O device 38A through a motor driver 95A for horizontal movement for line-portion area measurement. Moreover, a rotary encoder 98A for the motor for horizontal movement for line-portion area measurement is also connected to the I/O device 38A through a counter 97A for measuring the current position of the line-portion area measuring camera in horizontal directions, the rotary encoder 98A being connected to and driven by the motor 96A. Furthermore, a detector 99A for detecting the home position of the line-portion area measuring camera in the horizontal directions is also connected to the I/O device 38A.

The first ink fountain key opening degree control device 50-(1-1) of a first printing unit to the Nth ink fountain key opening degree control device 50-(M-N) of an Mth printing unit, and the first (printing unit) ink fountain roller rotation speed control device 70-1 to the Mth (printing unit) ink fountain roller rotation speed control device 70-M are connected to the interface 37.

As shown in FIG. 20, in each of the first ink fountain key opening degree control device 50-(1-1) of the first printing unit to the Nth ink fountain key opening degree control device 50-(M-N) of the Mth printing unit, memories M54 to M57, in addition to a CPU 51, a RAM 52 and a ROM 53, are connected through a bus 60, together with an I/O device 58 and an interface 59. In the memory M54, a received ink fountain key opening degree is stored. In the memory M55, a target ink fountain key opening degree is stored. In the memory M56, a count value of a counter is stored. In the memory M57, a current ink fountain key opening degree is stored.

A motor 61 for driving the ink fountain key is connected to the I/O device 58 through a motor driver 62 for driving the ink fountain key. Moreover, a rotary encoder 63 for the motor for driving the ink fountain key is also connected to the I/O device 58 through a counter 64, the rotary encoder 63 being connected to and driven by the motor 61 for driving the ink fountain key. A detection signal from the rotary encoder 63 for the motor for driving the ink fountain key is also inputted to the motor driver 62 for driving the ink fountain key. Furthermore, the ink supply amount control device 30 is connected to the interface 59.

As shown in FIG. 21, in each of the first ink fountain roller rotation speed control device 70-1 to the Mth ink fountain roller rotation speed control device 70-M, memories M74 and M75, in addition to a CPU 71, a RAM 72 and a ROM 73, are connected through a bus 78 together with an I/O device 76 and an interface 77. In the memory M74, a received ink fountain roller rotation speed is stored. In the memory M75, a target ink fountain roller rotation speed is stored.

A motor 79 for driving the ink fountain roller is connected to the I/O device 76 through a motor driver 80 for driving the ink fountain roller. Moreover, a rotary encoder 81 for the motor for driving the ink fountain roller is also connected to the I/O device 76 through an F/V converter 82 and an A/D converter 83, the rotary encoder 81 being connected to and driven by the motor 79 for driving the ink fountain roller. A detection signal from the rotary encoder 81 for the motor for driving the ink fountain roller is also inputted to the motor driver 80 for driving the ink fountain roller. Furthermore, the ink supply amount control device 30 is connected to the interface 77.

In the third embodiment, the rotation speed of the ink fountain roller 4 in the ink supply device in the printing unit of each color can be adjusted (compensated) automatically on the basis of a measurement result obtained by the line-portion area measuring camera 44A serving as area measurement means for measuring the area of the line portion printed on paper W, by using the ink supply amount control device 30 (including the first ink fountain key opening degree control device 50-(1-1) of the first printing unit to the Nth ink fountain key opening degree control device 50-(M-N) of the Mth printing unit and the first ink fountain roller rotation speed control device 70-1 to the Mth ink fountain roller rotation speed control device 70-M, to be exact).

The line-portion area measuring camera 44A is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 38(a) to 38(c), the line-portion area measuring camera 44A can directly measure the area of the line portion (the region indicated by hatching in each of FIGS. 38(a) to 38(c) printed on the paper (print member) W placed on the main body of the checking apparatus (for details, refer to operation flowcharts to be described later). In FIGS. 38(a) to 38(c), LWF denotes a reference line width.

The ink supply amount control device 30 is configured as described above, and operates as in the operation flow shown in FIGS. 22(a) to 22(c), FIGS. 23(a) to 23(d), FIGS. 24(a) to 24(c), and FIG. 25.

Firstly, in Step P1, it is determined whether or not the ink color ICm of the printing unit M and an image area ratio IRmn of a range corresponding to each ink fountain key have been inputted. When the determination in Step P1 is YES, in Step P2, the ink color ICm of the printing unit M and the image area ratio IRmn of the range corresponding to each ink fountain key are inputted and stored respectively in the memories M1 and M2. On the other hand, when the determination in Step P1 is NO, the process proceeds to Step P3.

Then, in Step P3, it is determined whether or not an ink preset switch has been turned on. When the determination in Step P3 is YES, in Step P4, 1 is written in the count value M in the memory M3. When the determination in Step P3 is NO, the process proceeds to Step P30.

In Step P5, 1 is written in the count value N in the memory M4. Thereafter, in Step P6, the ink color ICm of the printing unit M is read from the memory M1. Then, in Step P7, the conversion table between an image area ratio corresponding to the ink color ICm and an ink fountain key opening degree is read from the memory M5.

In Step P8, the image area ratio IRmn of the range corresponding to the Nth ink fountain key of the printing unit M is read from the memory M2. Thereafter, in Step P9, the opening degree Kmn of the Nth ink fountain key of the printing unit M is obtained from the image area ratio IRmn of the range corresponding to the Nth ink fountain key of the printing unit M by using the conversion table between an image area ratio corresponding to the ink color ICm and an ink fountain key opening degree, and is then stored in the Nth address location for the printing unit M in the memory M6 for storing the opening degree Kmn of each ink fountain key.

In Step P10, the count value N in the memory M4 is incremented by 1, and is then overwritten with the resultant value. Thereafter, in Step P11, the total number Nmax of the ink fountain keys of each printing unit is read from the memory M7. Then, in Step P12, it is determined whether or not the count value N is larger than the total number Nmax of the ink fountain keys of each printing unit.

When the determination in Step P12 is YES, in Step P13, the count value M in the memory M3 is incremented by 1, and is then overwritten with the resultant value. On the other hand, when the determination in Step P12 is NO, the process returns to Step P6. Thereafter, in Step P14, the total number Mmax of the printing units is read from the memory M10. Then, in Step P15, it is determined whether or not the count value M is larger than the total number Mmax of the printing units.

When the determination in Step P15 is YES, in Step P16, 1 is written in the count value M in the memory M3. On the other hand, when the determination in Step P15 is NO, the process returns to Step P5. Thereafter, in Step P17, 1 is written in the count value N in the memory M4. Then, in Stdp P18, the opening degree Kmn of the Nth ink fountain key of the printing unit M is read from the memory M6.

Then, in Step P19, the ink fountain key opening degree Kmn is transmitted to the Nth ink fountain key opening degree control device of the printing unit M. Thereafter, when a reception confirmation signal is received from the Nth ink fountain key opening degree control device of the printing unit M in Step P20, in Step P21, the count value N in the memory M4 is incremented by 1, and is then overwritten with the resultant value.

In Step P22, the total number Nmax of the ink fountain keys of each printing unit is read from the memory M7. Thereafter, in Step P23, it is determined whether or not the count value N is larger than the total number Nmax of the ink fountain keys of each printing unit. When the determination in Step P23 is YES, in Step P24, the ink color ICm of the printing unit M is read from the memory M1. On the other hand, when the determination in Step P23 is NO, the process returns to Step P18.

In Step P25, the reference ink fountain roller rotation speed ratio IFRRFm corresponding to the ink color ICm is read from the memory M8. Thereafter, in Step P26, the reference ink fountain roller rotation speed ratio IFRRFm corresponding to the ink color ICm is written in the address for the printing unit M in the memory M9 for storing the ink fountain roller rotation speed ratio IFRRm.

In Step P27, the count value M in the memory M3 is incremented by 1, and is then overwritten with the resultant value. Thereafter, in Step P28, the total number Mmax of the printing units is read from the memory M10. Then, in Step P29, it is determined whether or not the count value M is larger than the total number Mmax of the printing units. When the determination in Step P29 is YES, the process proceeds to Step P30. On the other hand, when the determination in Step P29 is NO, the process returns to Step P17.

Through the above-described steps, the opening degree Kmn of each ink fountain key is transmitted to the corresponding one of the ink fountain key opening degree control devices 50-(1-1) to 50-(M-N), and a preset value of each ink fountain roller rotation speed ratio IFRRm is obtained.

In Step P30, it is determined whether or not a line-portion area measurement switch has been turned on. When the determination in Step P30 is YES, 1 is written in the count value M in the memory M3 in Step P31. On the other hand, when the determination in Step P30 is NO, the process proceeds to Step P105.

In Step P32, the value of the counter 92A for measuring the current position of the line-portion area measuring camera in the vertical directions is read, and is then stored in the memory M11a. Thereafter, in Step P33, the current position of the line-portion area measuring camera 44A in the vertical directions is calculated from the read value of the counter 92A for measuring the current position of the line-portion area measuring camera in the vertical directions, and is then stored in the memory M12a.

In Step P34, the position of the line portion in the ink color ICm, to be measured by the line-portion area measuring camera, in the vertical directions is read from the memory M13a. Thereafter, in Step P35, it is determined whether or not the current position of the line-portion area measuring camera 44A in the vertical directions is equal to the position of the line portion in the ink color ICm, to be measured by the line-portion area measuring camera, in the vertical directions. When the determination in Step P35 is YES, the process proceeds to Step P49. On the other hand, when the determination in Step P35 is NO, it is determined, in Step P36, whether or not the current position of the line-portion area measuring camera 44A in the vertical directions is lower than the position of the line portion in the ink color ICm, to be measured by the line-portion area measuring camera, in the vertical directions.

When the determination in Step P36 is YES, in Step P37, a normal rotation instruction is outputted to the motor driver 90A for vertical movement for line-portion area measurement. Thereafter, in Step P38, the value of the counter 92A for measuring the current position of the line-portion area measuring camera in the vertical directions is read, and is then stored in the memory M11a.

In Step P39, the current position of the line-portion area measuring camera 44A in the vertical directions is calculated from the read value of the counter 92A for measuring the current position of the line-portion area measuring camera in the vertical directions, and is then stored in the memory M12a. Thereafter, in Step P40, the position of the line portion in the ink color ICm, to be measured by the line-portion area measuring camera, in the vertical directions is read from the memory M13a.

In Step P41, it is determined whether or not the current position of the line-portion area measuring camera 44A in the vertical directions is equal to the position of the line portion in the ink color ICm, to be measured by the line-portion area measuring camera, in the vertical directions. When the determination in Step P41 is YES, in Step P42, the output of the normal rotation instruction to the motor driver 90A for vertical movement for line-portion area measurement is stopped. Thereafter, the process proceeds to Step P49. On the other hand, when the determination in Step P41 is NO, the process returns to Step P38.

When the determination in Step P36 is NO, in Step P43, a reverse rotation instruction is outputted to the motor driver 90A for vertical movement for line-portion area measurement. Thereafter, in Step P44, the value of the counter 92A for measuring the current position of the line-portion area measuring camera in the vertical directions is read, and is then stored in the memory M11a.

In Step P45, the current position of the line-portion area measuring camera 44A in the vertical directions is calculated from the read value of the counter 92A for measuring the current position of the line-portion area measuring camera in the vertical directions, and is then stored in the memory M12a. Thereafter, in Step P46, the position of the line portion in the ink color ICm, to be measured by the line-portion area measuring camera, in the vertical directions is read from the memory M13a.

In Step P47, it is determined whether or not the current position of the line-portion area measuring camera 44A in the vertical directions is equal to the position of the line portion in the ink color ICm, to be measured by the line-portion area measuring camera, in the vertical directions. When the determination in Step P47 is YES, in Step P48, the output of the reverse rotation instruction to the motor driver 90A for vertical movement for line-portion area measurement is stopped. Thereafter, the process proceeds to Step P49. On the other hand, when the determination in Step P47 is NO, the process returns to Step P44.

In Step P49, the value of the counter 97A for measuring the current position of the line-portion area measuring camera in the horizontal directions is read, and is then stored in the memory M14a. Thereafter, in Step P50, the current position of the line-portion area measuring camera 44A in the horizontal directions is calculated from the read value of the counter 97A for measuring the current position of the line-portion area measuring camera in the horizontal directions, and is then stored in the memory M15a.

In Step P51, the position of the line portion in the ink color ICm, to be measured by the line-portion area measuring camera, in the horizontal directions is read from the memory M16a. Thereafter, in Step P52, it is determined whether or not the current position of the line-portion area measuring camera 44A in the horizontal directions is equal to the position of the line portion in the ink color ICm, to be measured by the line-portion area measuring camera, in the horizontal directions. When the determination in Step P52 is YES, the process proceeds to Step P66. On the other hand, when the determination in Step P52 is NO, it is determined, in Step P53, whether or not the current position of the line-portion area measuring camera 44A in the horizontal directions is smaller than the position of the line portion in the ink color ICm, to be measured by the line-portion area measuring camera, in the horizontal directions.

When the determination in Step P53 is YES, in Step P54, a normal rotation instruction is outputted to the motor driver 95A for horizontal movement for line-portion area measurement. Thereafter, in Step P55, the value of the counter 97A for measuring the current position of the line-portion area measuring camera in the horizontal directions is read, and is then stored in the memory M14a.

In Step P56, the current position of the line-portion area measuring camera 44A in the horizontal directions is calculated from the read value of the counter 97A for measuring the current position of the line-portion area measuring camera in the horizontal directions, and is then stored in the memory M15a. Thereafter, in Step P57, the position of the line portion in the ink color ICm, to be measured by the line-portion area measuring camera, in the horizontal directions is read from the memory M16a.

In Step P58, it is determined whether or not the current position of the line-portion area measuring camera 44A in the horizontal directions is equal to the position of the line portion in the ink color ICm, to be measured by the line-portion area measuring camera, in the horizontal directions. When the determination in Step P58 is YES, in Step P59, the output of the normal rotation instruction to the motor driver 95A for horizontal movement for line-portion area measurement is stopped. Thereafter, the process proceeds to Step P66. On the other hand, when the determination in Step P58 is NO, the process returns to Step P55.

When the determination in Step P53 is NO, in Step P60, a reverse rotation instruction is outputted to the motor driver 95A for horizontal movement for line-portion area measurement. Thereafter, in Step P61, the value of the counter 97A for measuring the current position of the line-portion area measuring camera in the horizontal directions is read, and is then stored in the memory M14a.

In Step P62, the current position of the line-portion area measuring camera 44A in the horizontal directions is calculated from the read value of the counter 97A for measuring the current position of the line-portion area measuring camera in the horizontal directions, and is then stored in the memory M15a. Thereafter, in Step P63, the position of the line portion in the ink color ICm, to be measured by the line-portion area measuring camera, in the horizontal directions is read from the memory M16a.

In Step P64, it is determined whether or not the current position of the line-portion area measuring camera 44A in the horizontal directions is equal to the position of the line portion in the ink color ICm, to be measured by the line-portion area measuring camera, in the horizontal directions. When the determination in Step P64 is YES, in Step P65, the output of the reverse rotation instruction to the motor driver 95A for horizontal movement for line-portion area measurement is stopped. Thereafter, the process proceeds to Step P66. On the other hand, when the determination in Step P64 is NO, the process returns to Step P61.

In Step P66, a measurement signal is outputted to the line-portion area measuring camera 44A. Thereafter, in Step P67, a binary image signal is received from the line-portion area measuring camera 44A, and is then stored in the address location for the ink color ICm in the frame memory M17.

In Step P68, the count value M in the memory M3 is incremented by 1, and is then overwritten with the resultant value. Thereafter, in Step P69, the total number Mmax of the printing units is read from the memory M10. Then, in Step P70, it is determined whether or not the count value M is larger than the total number Mmax of the printing units.

When the determination in Step P70 is YES, a reverse rotation instruction is outputted to the motor driver 95A for horizontal movement for line-portion area measurement in Step P71. On the other hand, when the determination in Step P70 is NO, the process returns to Step P32.

When an output of the detector 99A for detecting the home position of the line-portion area measuring camera 44A in the horizontal directions is turned on in Step P72, in Step P73, the output of the reverse rotation instruction to the motor driver 95A for horizontal movement for line-portion area measurement is stopped. In Step P74, a reverse rotation instruction is outputted to the motor driver 90A for vertical movement for line-portion area measurement.

When an output of the detector 94A for detecting the home position of the line-portion area measuring camera 44A in the vertical directions is turned on in Step P75, in Step P76, the output of the reverse rotation instruction to the motor driver 90A for vertical movement for line-portion area measurement is stopped.

Through the above-described steps, the binary image signal of the line portion, corresponding to each ink fountain key, in each ink color ICm, is received from the line-portion area measuring camera 44A.

In Step P77a, 1 is written in the count value M in the memory M3. In Step P77b, 1 is written in the count value N in the memory M4. Thereafter, in Step P78, 0 is written in the memory 40 for storing the count value IAC for printed-portion area measurement. Then, 1 is written in the count value Y in the memory M18 in Step P79, and 1 is written in the count value X in the memory M19 in Step P80.

In Step P81, the ink color ICm of the printing unit M is read from the memory M1. Then, in Step P82, an image data Ixy of the address (X,Y) for the ink color ICm is read from the frame memory M17. Thereafter, in Step P83, it is determined whether or not the image data Ixy is 1.

When the determination in Step P83 is YES, in Step P84 the count value IAC for printed-portion area measurement is read from the memory M40. On the other hand, when the determination in Step P83 is NO, the process proceeds to Step P86.

In Step P85, the count value IAC for printed-portion area measurement is incremented by 1, and the memory M40 for storing the count value IAC for printed-portion measurement is overwritten with the resultant value. Thereafter, in Step P86, the count value X in the memory M19 is incremented by 1, and is then overwritten with the resultant value.

In Step P87, the total number DPXmax of pixels detected in the horizontal directions of the line-portion area measuring camera 44A is read from the memory M21a. Thereafter, in Step P88, it is determined whether or not the count value X is larger than the total number DPXmax of pixels detected in the horizontal directions of the line-portion area measuring camera. When the determination in Step P88 is YES, in Step P89, the count value Y in the memory M18 is incremented by 1, and is then overwritten with the resultant value. On the other hand, when the determination in Step P88 is NO, the process returns to Step P81.

In Step P90, the total number DPYmax of pixels detected in the vertical directions of the line-portion area measuring camera is read from the memory M22a. Thereafter, in Step P91, it is determined whether or not the count value Y is larger than the total number DPYmax of pixels detected in the vertical directions of the line-portion area measuring camera. When the determination in Step P91 is YES, in Step P92 the count value IAC for printed-portion area measurement is read from the memory M40. On the other hand, when the determination in Step P91 is NO, the process returns to Step P80.

In Step P93, the printed-portion area IA of the printing unit M is calculated from the count value IAC for printed-portion area measurement, and is then stored in the address location for the printing unit M in the memory M41. Thereafter, in Step P94, the printed-portion reference area IAF is read from the memory M42.

In Step P95, the printed-portion area difference IAD of the printing unit M is calculated by subtracting the printed-portion reference area IAF from the printed-portion area IA of the printing unit M, and is then stored in the address location for the printing unit M in the memory M43. Thereafter, in Step P96, the ink color ICm of the printing unit M is read from the memory M1.

In Step P97, the conversion table between printed-portion area difference of the ink color ICm and a compensation amount of an ink fountain roller rotation speed ratio IFRRm is read from the memory M44. Thereafter, in Step P98, the compensation amount of the ink fountain roller rotation speed ratio is obtained from the printed-portion area difference IAD by using the conversion table between printed-portion area difference of the ink color ICm and a compensation amount of an ink fountain roller rotation speed ratio IFRRm, and is then stored in the address location for printing unit M in the memory M30.

In Step P99, the ink fountain roller rotation speed ratio IFRRm of the printing unit M is read from the memory M9. Thereafter, in Step P100, a target ink fountain roller rotation speed ratio IFRRm of the printing unit M is calculated by adding the compensation amount of the ink fountain roller rotation speed ratio of the printing unit M to the ink fountain roller rotation speed ratio IFRRm of the printing unit M, and is then stored in the address location for the printing unit M in the memory M31.

In Step P101, the address location for the printing unit M in the memory M9 for storing the ink fountain roller rotation speed ratio IFRRm is overwritten with the target ink fountain roller rotation speed ratio IFRRm of the printing unit M. Thereafter, in Step P102, the count value M in the memory M3 is incremented by 1, and is then overwritten with the resultant value.

In Step P103, the total number Mmax of the printing units is read from the memory M10. Thereafter, in Step P104, it is determined whether or not the count value M is larger than the total number Mmax of the printing units. When the determination in Step P104 is YES, the process returns to Step P1. On the other hand, when the determination in Step P104 is NO, the process returns to Step P78.

Through the above-described steps, the rotation speed ratio IFRRm of each ink fountain roller of each printing unit is obtained, the rotation speed ratio IFRRm being compensated in accordance with the difference of the corresponding printed portion area.

When the determinations in Step P1, Step P3 and Step P30 are NO, in Step P105, 1 is written in the count value M in the memory M3. Thereafter, in Step P106, an output of the A/D converter 45 connected to the rotary encoder 47 for the drive motor of the printing press is read, and is stored in the memory M32. Then, in Step P107, the current rotation speed R of the printing press is calculated from the output of the A/D converter 45 connected to the rotary encoder 47 for the drive motor of the printing press, and is then stored in the memory M33.

In Step P108, the ink fountain roller rotation speed ratio IFRRm of the printing unit M is read from the memory M9. Thereafter, in Step P109, the ink fountain roller rotation speed IFRm of the printing unit M is calculated by multiplying the current rotation speed R of the printing press by the ink fountain roller rotation speed ratio IFRRm of the printing unit M, and is then stored in the address location for the printing unit M in the memory M34.

In Step P110, the ink fountain roller rotation speed IFRm of the printing unit M is transmitted to the ink fountain roller rotation speed control device of the printing unit M. Thereafter, when a reception confirmation signal is transmitted from the ink fountain roller rotation speed control device of the printing unit M in Step P111, the count value M in the memory M3 is incremented by 1, and is then overwritten with the resultant value, in Step P112.

In Step P113, the total number Mmax of the printing units is read from the memory M10. Thereafter, in Step P114, it is determined whether or not the count value M is larger than the total number Mmax of the printing units. When the determination in Step P114 is YES, the process returns to Step P1. On the other hand, when the determination in Step P114 is NO, the process returns to Step P106. Thereafter, this process is repeated.

Through the above-described steps, the rotation speed IFRm of each ink fountain roller according to the current rotation speed R of the printing press is transmitted to the corresponding one of the ink fountain roller rotation speed control devices 70-1 to 70-M.

The first ink fountain key opening degree control device 50-(1-1) of the first printing unit to the Nth ink fountain key opening degree control device 50-(M-N) of the Mth printing unit each operate as in the operation flow shown in FIGS. 26(a) and 26(b).

Specifically, when an ink fountain key opening degree Kmn is transmitted from the ink supply amount control device 30 in Step P1, in Step P2, the ink fountain key opening degree Kmn is received, and is then stored in the memory M54 for storing the received ink fountain key opening degree Kmn. Thereafter, in Step P3, a reception confirmation signal is transmitted to the ink supply amount control device 30.

In Step P4, the received ink fountain key opening degree Kmn is written in the memory M55 for storing the target ink fountain key opening degree (position). Thereafter, in Step P5, the count value of the counter 64 is read, and is then stored in the memory M56. Then, in Step P6, the current ink fountain key opening degree (position) is calculated from the count value of the counter 64, and is then stored in the memory M57.

In Step P7, it is determined whether or not the target position of the ink fountain key is equal to the current position of the ink fountain key. When the determination in Step P7 is YES, the process returns to Step P1. On the other hand, when the determination in Step P7 is NO, it is determined, in Step P8, whether or not the target position of the ink fountain key is larger than the current position of the ink fountain key.

When the determination in Step P8 is YES, in Step P9 a normal rotation instruction is outputted to the motor driver 62 for driving the ink fountain key. When the determination in Step P8 is NO, in Step P10, a reverse rotation instruction is outputted to the motor driver 62 for driving the ink fountain key.

In Step P11, the count value of the counter 64 is read, and is then stored in the memory M56. Thereafter, in Step P12, the current position of the ink fountain key is calculated from the count value of the counter 64, and is then stored in the memory M57.

In Step P13, it is determined whether or not the current position of the ink fountain key is equal to the target position of the ink fountain key. When the determination in Step P13 is YES, in Step P14 a stop instruction is outputted to the motor driver 62 for driving the ink fountain key. Then, the process returns to Step P1. When the determination in Step P13 is NO, the process returns to Step P11. Thereafter, this process is repeated.

The first ink fountain roller rotation speed control device to the Mth ink fountain roller rotation speed control device each operate as in the operation flow shown in FIG. 27.

Specifically, when an ink fountain roller rotation speed IFRm is transmitted from the ink supply amount control device 30 in Step P1, in Step P2, the ink fountain roller rotation speed IFRm is received, and is then stored in the memory M74 for storing the received ink fountain roller rotation speed IFRm. Thereafter, in Step P3, a reception confirmation signal is transmitted to the ink supply amount control device 30.

In Step P4, the received ink fountain roller rotation speed IFRm is written and stored in the memory M75 for storing the target ink fountain roller rotation speed. Thereafter, in Step P5, the target ink fountain roller rotation speed is read from the memory M75.

In Step P6, a rotation speed instruction of the target ink fountain roller rotation speed is outputted to the motor driver 80 for driving the ink fountain roller. Then, the process returns to Step P1. Thereafter, this process is repeated.

As described above, in the third embodiment, the area of the printed line portion is measured by the line-portion area measuring camera 44A. Then, the ink supply amount control device 30 (or the ink fountain roller rotation speed control devices 70-1 to 70-M, to be exact) controls the drive of the motor 79 on the basis of the measurement result. Thereby, the rotation speed of the ink fountain roller 4 is automatically adjusted. With this configuration, it is possible to avoid anticipated troubles due to an oversupply or undersupply of ink. The troubles are for example, that ink spreads to the outside of the printing pattern, and that a portion of the pattern is not printed. Consequently, it is possible to reduce the burden of the operator, and also to reduce the amount of waste paper to be produced, by preventing errors in manual adjustment.

### Fourth Embodiment

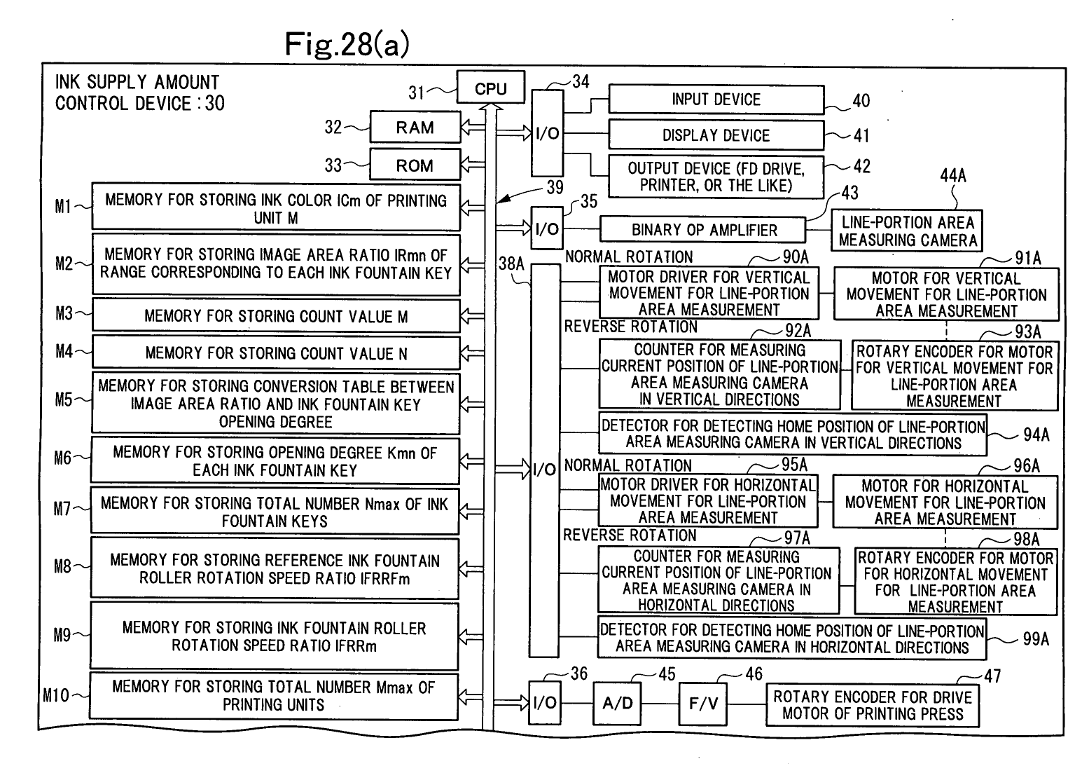

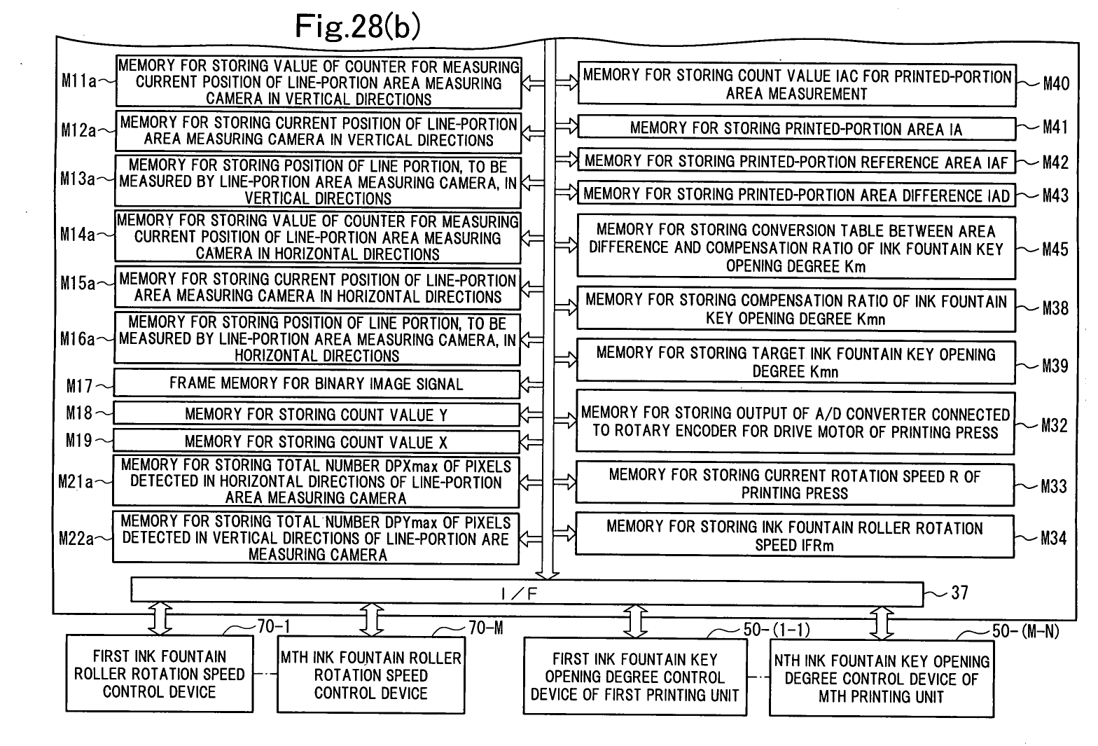

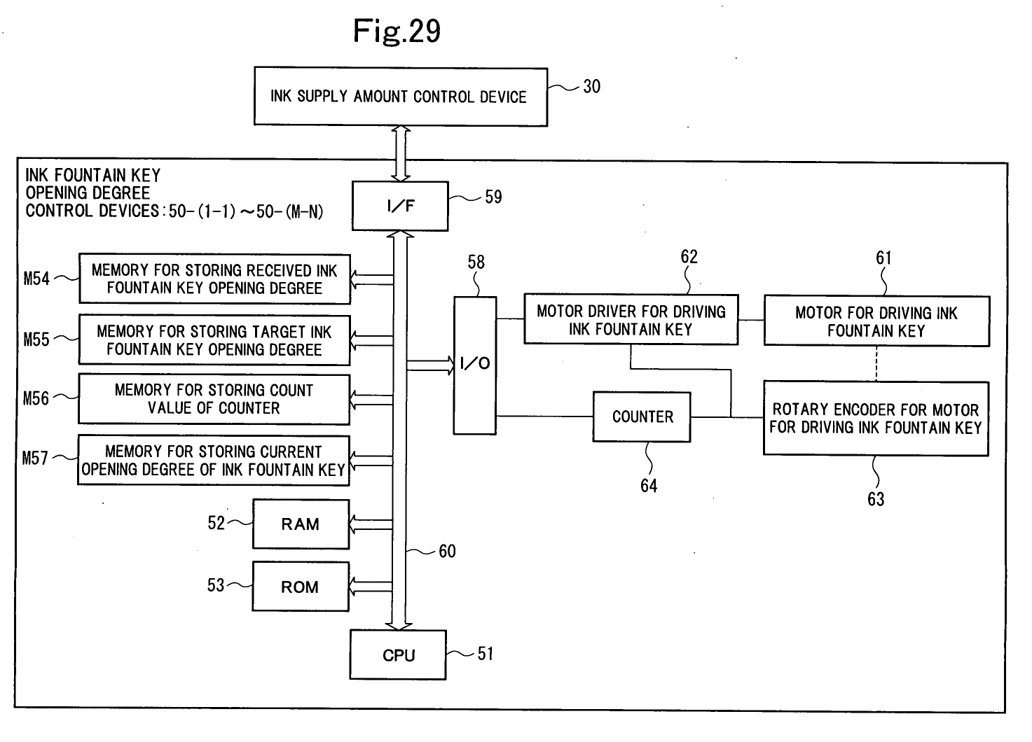

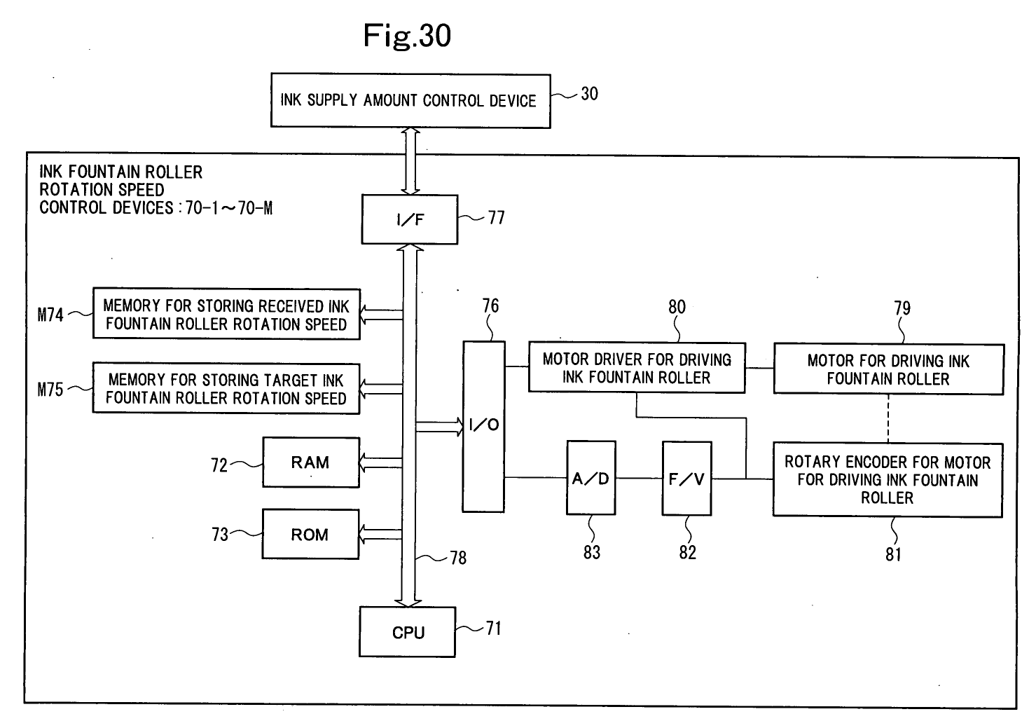

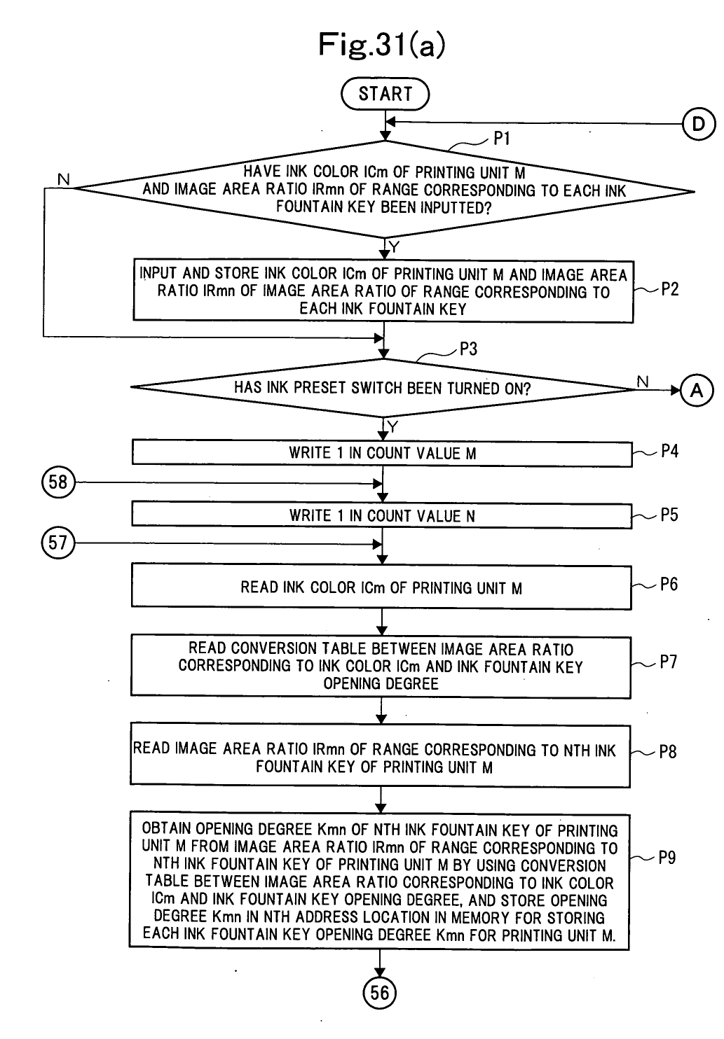

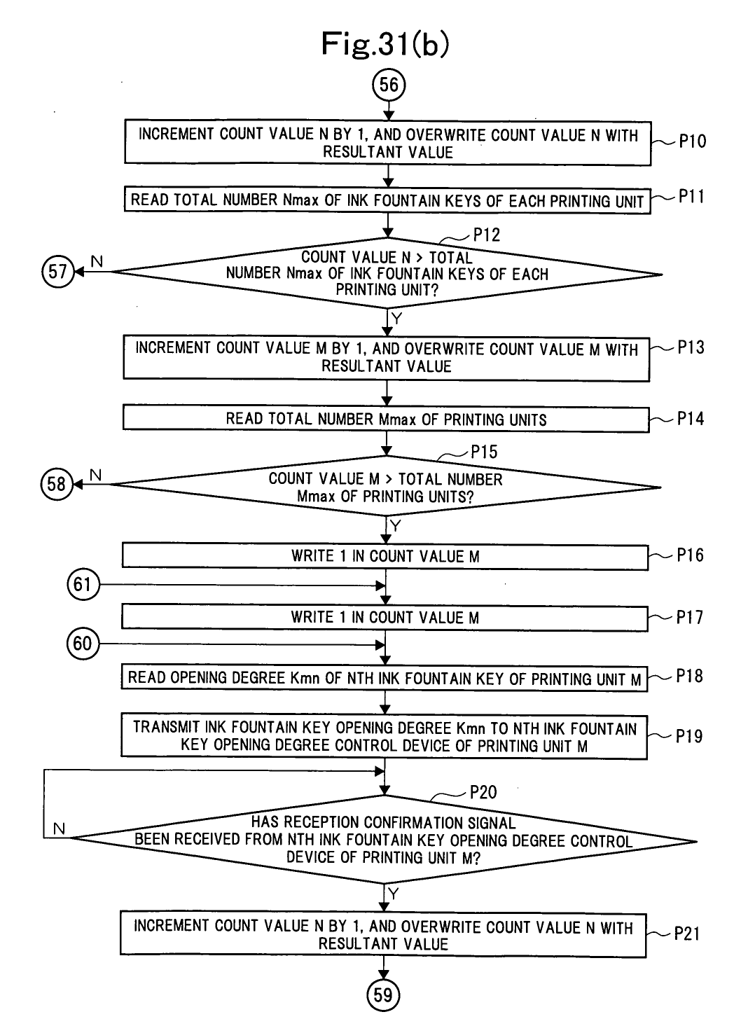

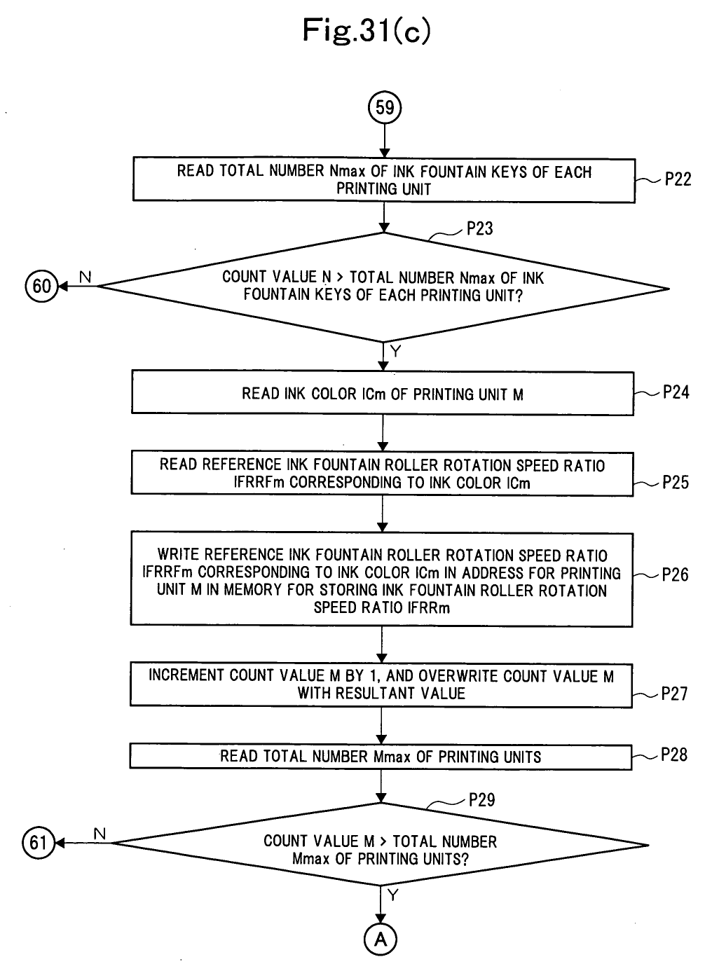

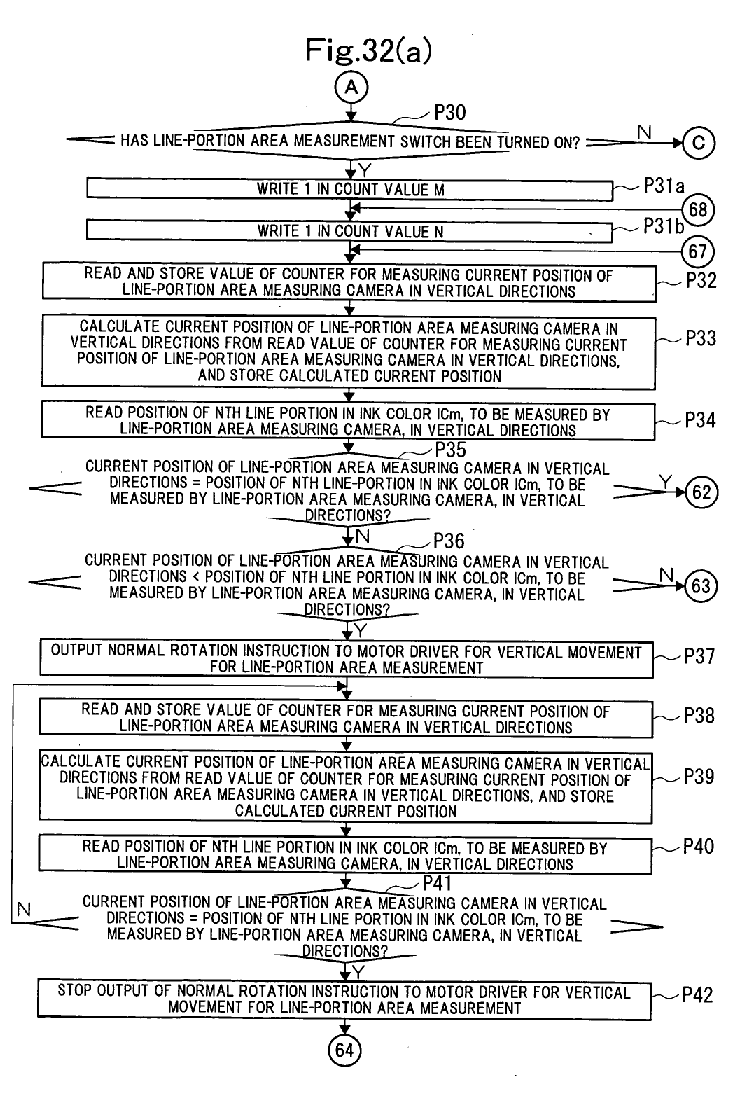

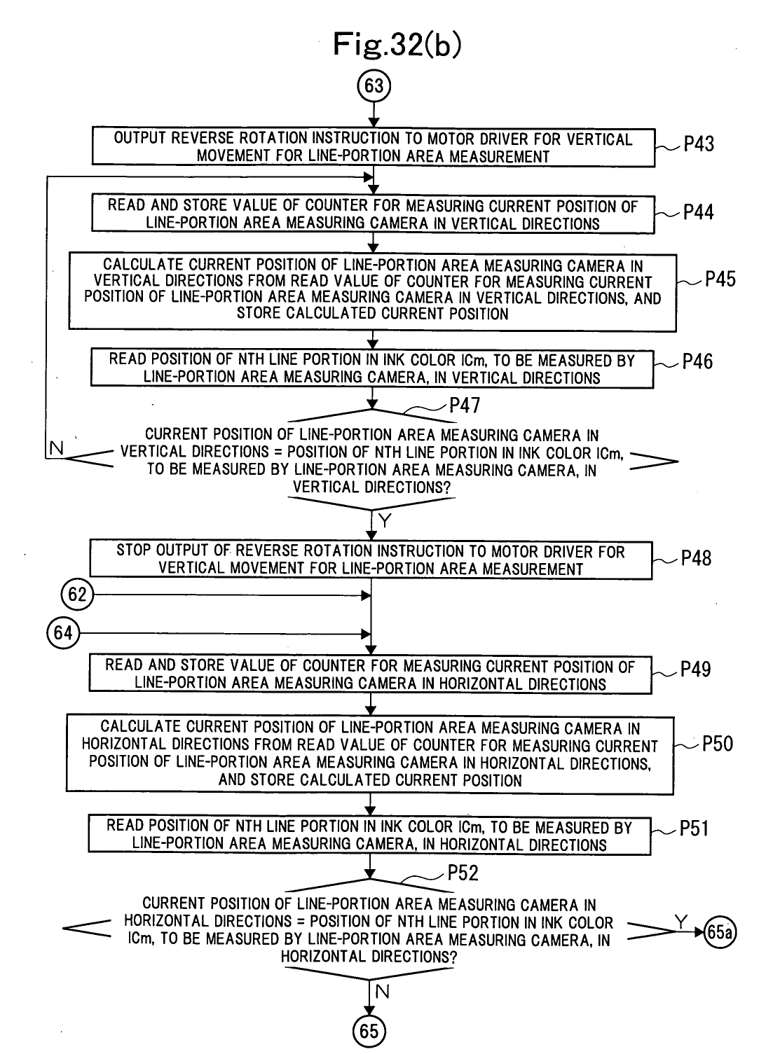

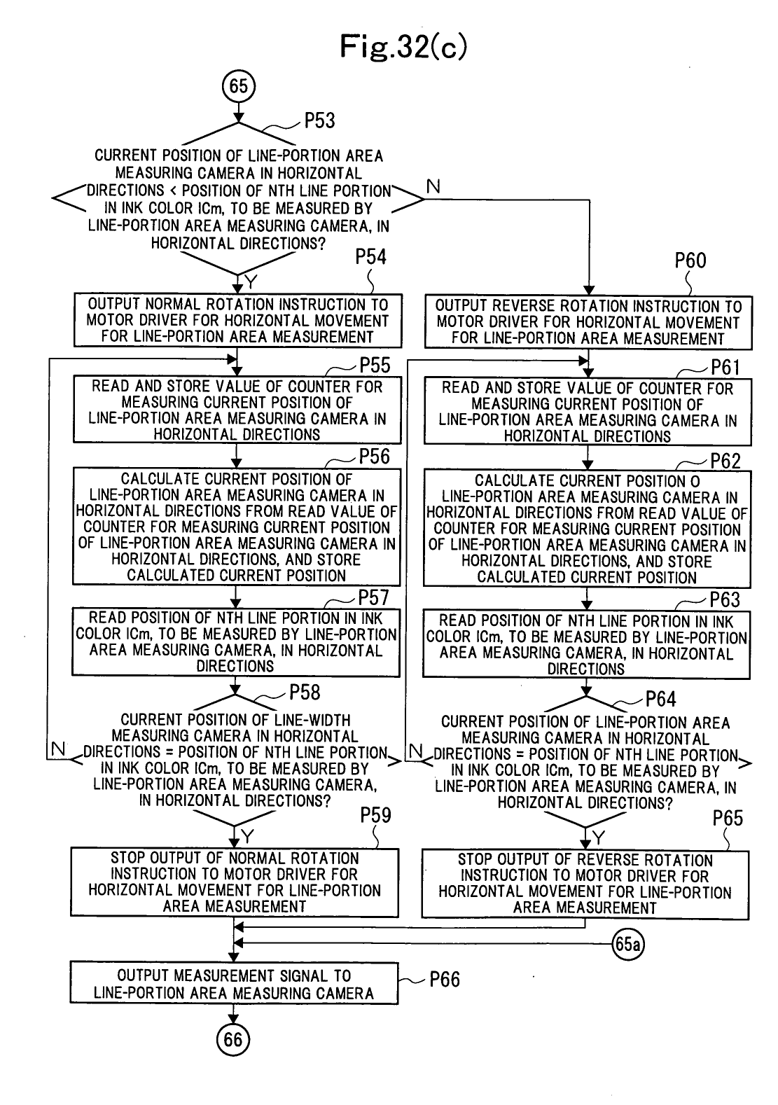

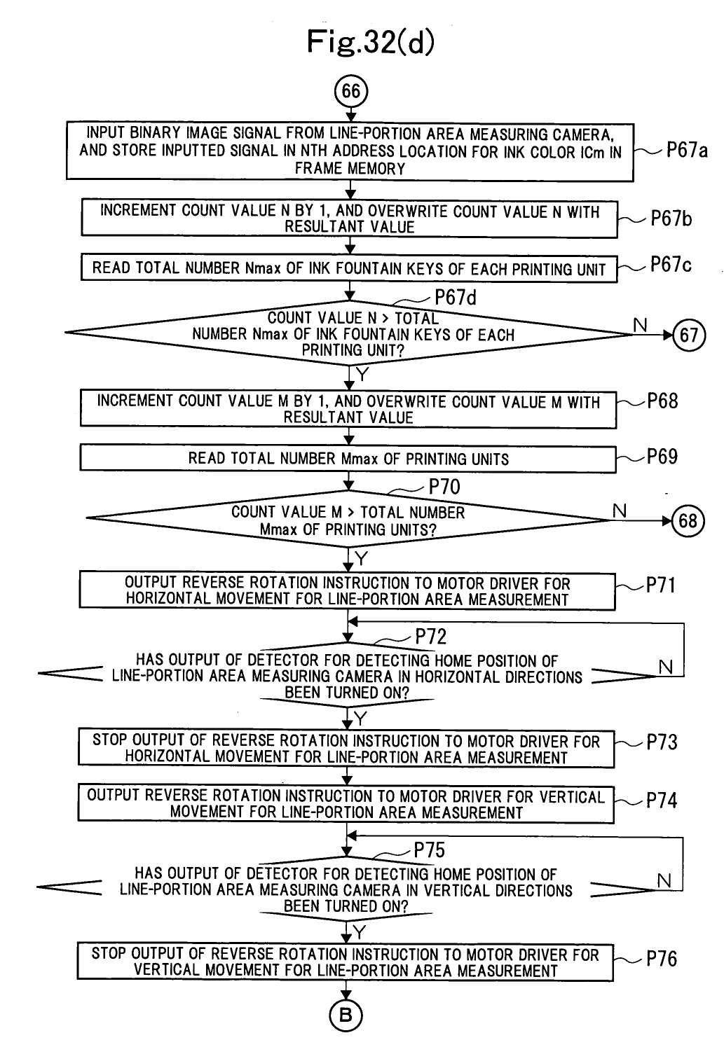

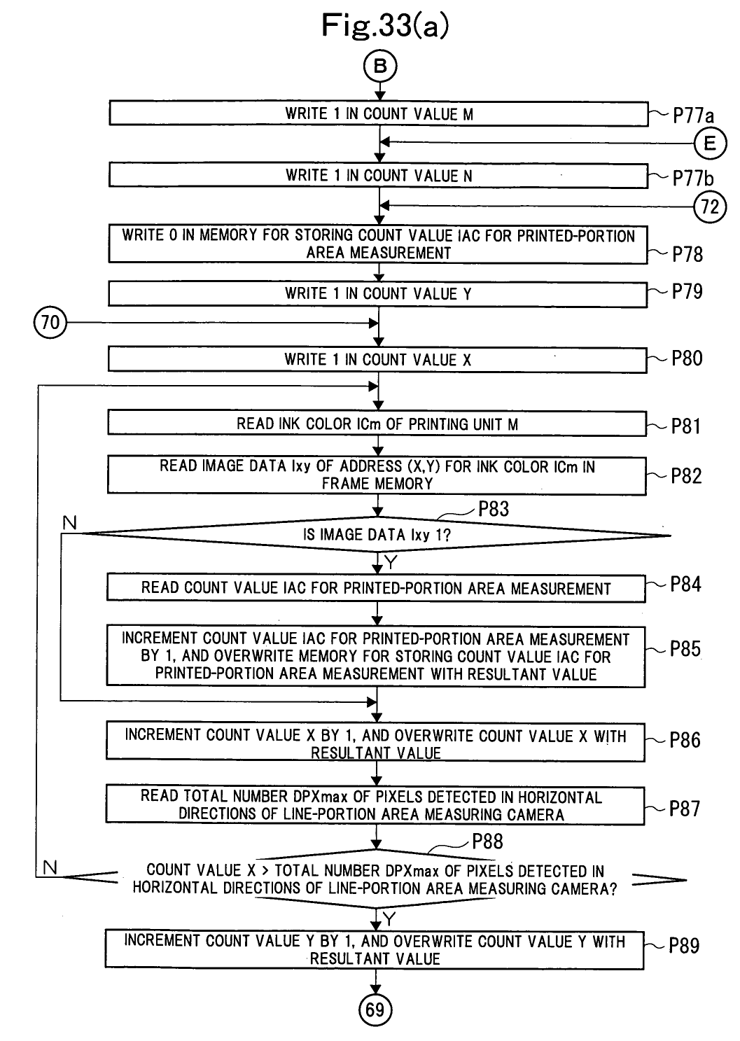

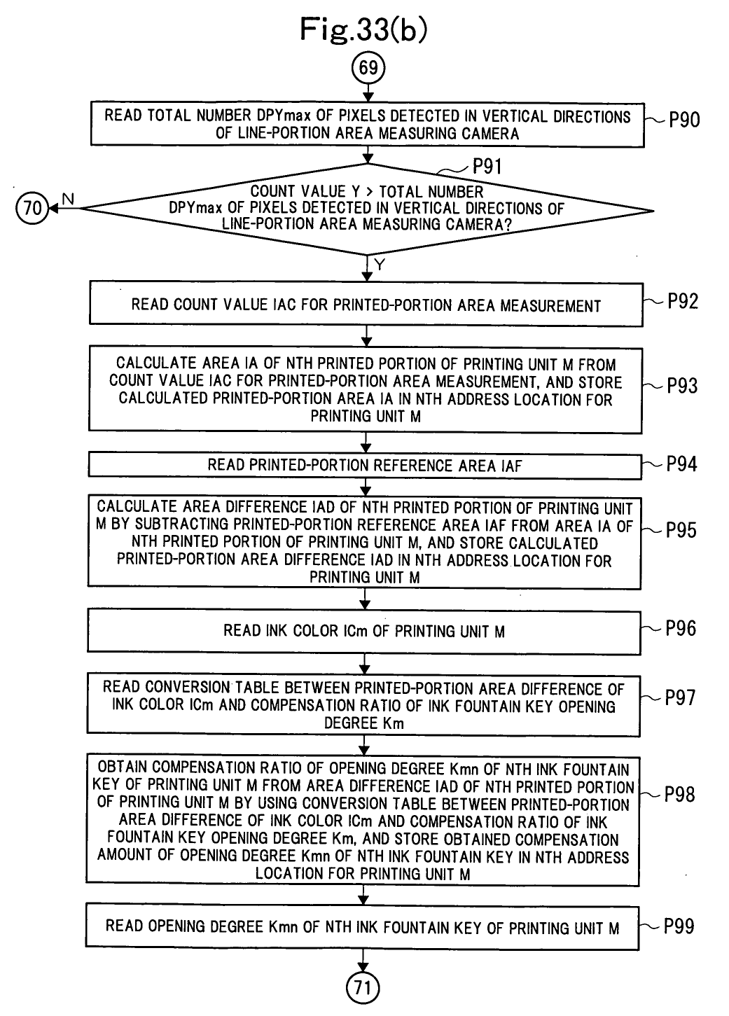

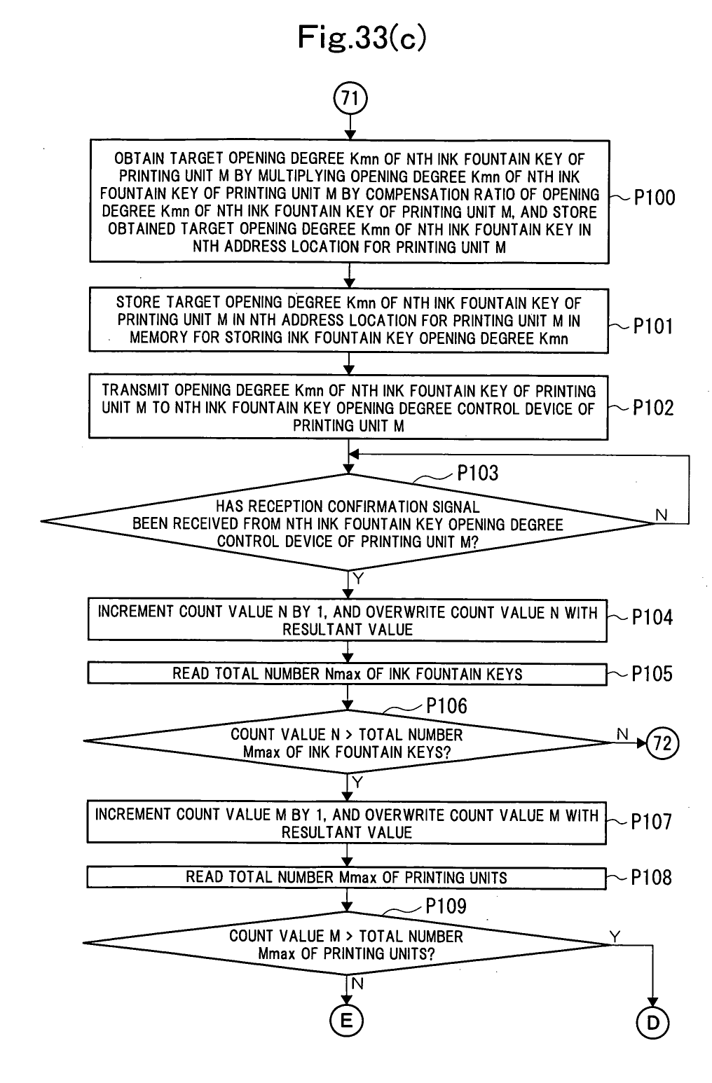

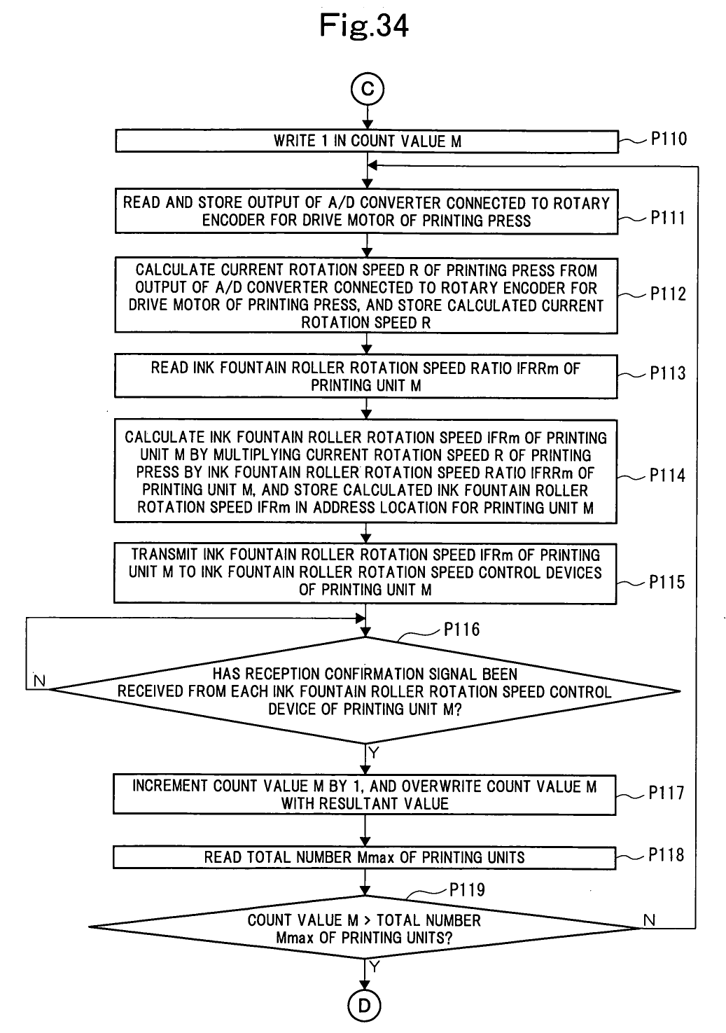

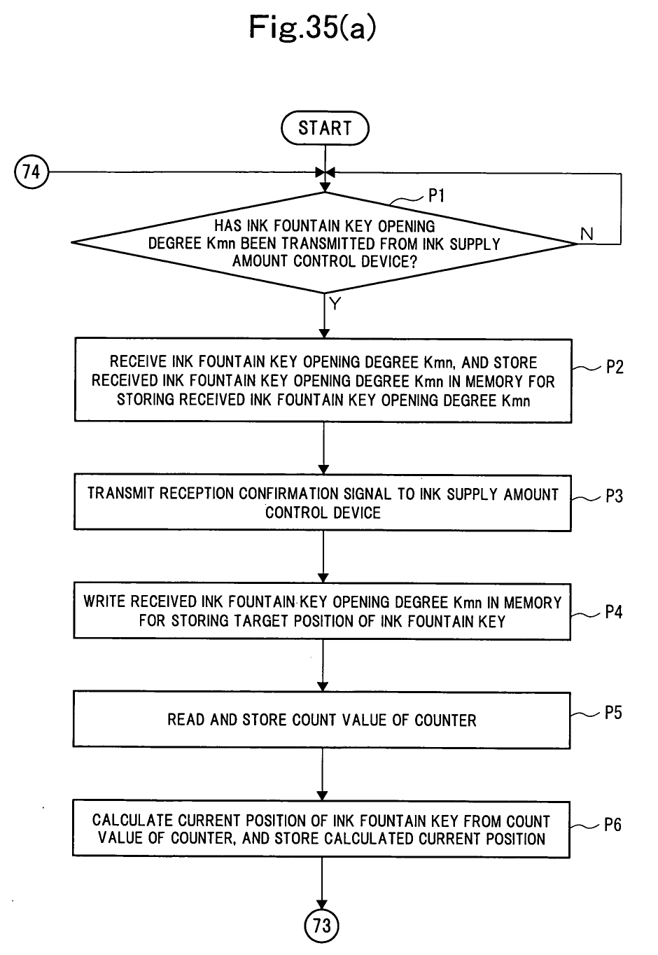

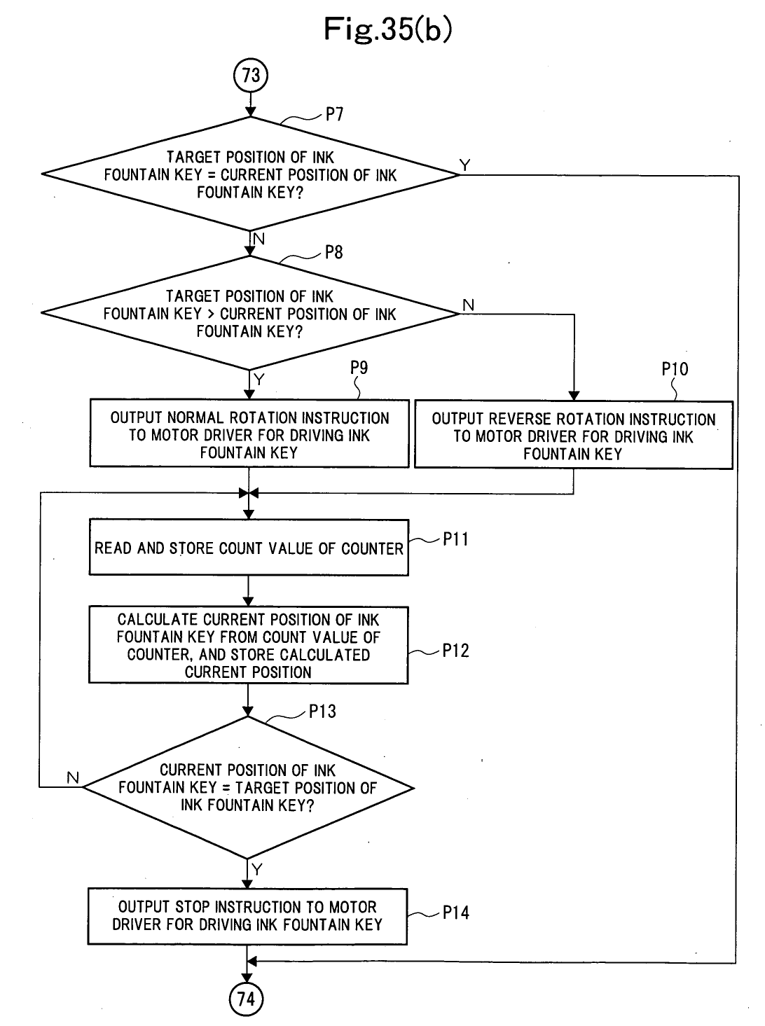

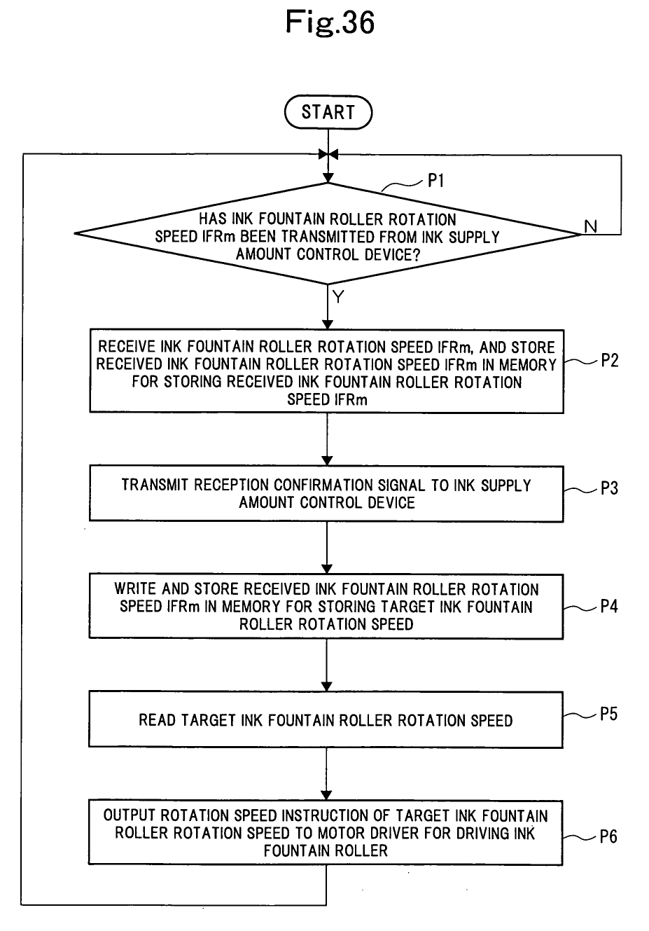

FIGS. 28(a) and 28(b) are control block diagrams of an ink supply amount control device showing a fourth embodiment of the present invention. FIG. 29 is a control block diagram of each ink fountain key opening degree control device. FIG. 30 is a control block diagram of each ink fountain roller rotation speed control device. FIGS. 31(a) to 31(c), FIGS. 32(a) to 32(d), FIGS. 33(a) to 33(c), and FIG. 34 are operation flowcharts of the ink supply amount control device. FIGS. 35(a) and 35(b) are operation flowcharts of each ink fountain key opening degree control device. FIG. 36 is an operation flowchart of each ink fountain roller rotation speed control device.

The fourth embodiment is an example in which the opening degrees of the ink fountain keys 3 (3-1 to 3-n) on the basis of the area of the printed line portion is automatically adjusted, while the ink supply amount control device 30 (or the ink fountain roller rotation speed control devices 70-1 to 70-M, to be exact) automatically adjusts the rotation speed of the ink fountain roller 4 on the basis of the maximum width of the line portion in the first embodiment.

As shown in FIGS. 28(a) and 28(b), in the ink supply amount control device 30, a CPU 31, a RAM 32, a ROM 33, input/output (I/O) devices 34 to 36, and 38A, and an interface 37 are connected through a bus 39. Moreover, memories M1 to M10 are connected to the bus 39. In the memory M1, an ink color ICm of a printing unit M is stored. In the memory M2, the image area ratio IRmn of a range corresponding to each ink fountain key is stored. In the memory M3, a count value M is stored. In the memory M4, a count value N is stored. In the memory M5, a conversion table between an image area ratio and an ink fountain key opening degree is stored. In the memory M6, the opening degree Kmn of each ink fountain key is stored. In the memory M7, the total number Nmax of ink fountain keys is stored. In the memory M8, a reference ink fountain roller rotation speed ratio IFRRFm is stored. In the memory M9, an ink fountain roller rotation speed ratio IFRRm is stored. In the memory M10, the total number Mmax of printing units is stored.

Furthermore, memories M11a, M12a, M13a, M14a, M15a, M16a, M17, M18, M19, and M40 are also connected to the bus 39. In the memory M11a, a value of a counter for measuring the current position of a line-portion area measuring camera in the vertical directions is stored. In the memory M12a, the current position of the line-portion area measuring camera in the vertical directions is stored. In the memory M13a, the position of a line portion, to be measured by the line-portion area measuring camera, in the vertical directions is stored. In the memory M14a, a value of a counter for measuring the current position of the line-portion area measuring camera in the horizontal directions is stored. In the memory M15a, the current position of the line-portion area measuring camera in the horizontal directions is stored. In the memory M16a, the position of the line portion, to be measured by the line-portion area measuring camera, in the horizontal directions is stored. In the frame memory M17, a binary image signal is stored. In the memory M18, a count value Y is stored. In the memory M19, a count value X is stored. In the memory M40, a count value IAC for printed-portion area measurement is stored.

Furthermore, memories M21a, M22a, M41 to M43, and M45 are also connected to the bus 39. In the memory M21a, the total number DPXmax of pixels detected in the horizontal directions of the line-portion area measuring camera is stored. In the memory M22a, the total number DPYmax of pixels detected in the vertical directions of the line-portion area measuring camera is stored. In the memory M41, a printed-portion area IA is stored. In the memory M42, a printed-portion reference area IAF is stored. In the memory M43, a printed-portion area difference IAD is stored. In the memory M45, a conversion table between area difference and a compensation ratio of an ink fountain key opening degree Kmn is stored.

Furthermore, memories M38, M39, and M32 to M34 are also connected to the bus 39. In the memory M38, a compensation ratio of an ink fountain key opening degree Kmn is stored. In the memory M39, a target ink fountain key opening degree Kmn is stored. In the memory M32, an output of an A/D convertor connected to a rotary encoder for a drive motor of the printing press is stored. In the memory M33, the current rotation speed R of the printing press is stored. In the memory M34, an ink fountain roller rotation speed IFRm is stored.

An input device 40 such as a keyboard, a display device 41 such as a CRT or a display, and an output device 42 such as a printer or a floppy disk (registered trademark) drive are connected to the I/O device 34. A line-portion area measuring camera (area measurement means) 44A for line-portion area measurement is connected to the I/O device 35 through a binary OP amplifier 43. Moreover, a rotary encoder 47 for a drive motor of the printing press is connected to the I/O device 36 through an A/D converter 45 and an F/V converter 46.

A motor 91A for vertical movement for line-portion area measurement is connected to the I/O device 38A through a motor driver 90A for vertical movement for line-portion area measurement. Moreover, a rotary encoder 93A for the motor for vertical movement for line-portion area measurement is also connected to the I/O device 38A through a counter 92A for measuring the current position of the line-portion area measuring camera in the vertical directions, the rotary encoder 93A being connected to and driven by the motor 91A. Furthermore, a detector 94A for detecting the home position of the line-portion area measuring camera in the vertical directions is also connected to the I/O device 38A.

In addition, a motor 96A for horizontal movement for line-portion area measurement is also connected to the I/O device 38A through a motor driver 95A for horizontal movement for line-portion area measurement. Moreover, a rotary encoder 98A for the motor for horizontal movement for line-portion area measurement is also connected to the I/O device 38A through a counter 97A for measuring the current position of the line-portion area measuring camera in horizontal directions, the rotary encoder 98A being connected to and driven by the motor 96A. Furthermore, a detector 99A for detecting the home position of the line-portion area measuring camera in the horizontal directions is also connected to the I/O device 38A.

The first ink fountain key opening degree control device 50-(1-1) of a first printing unit to the Nth ink fountain key opening degree control device 50-(M-N) of an Mth printing unit, and the first (printing unit) ink fountain roller rotation speed control device 70-1 to the Mth (printing unit) ink fountain roller rotation speed control device 70-M are connected to the interface 37.

As shown in FIG. 29 in each of the first ink fountain key opening degree control device 50-(1-1) of the first printing unit to the Nth ink fountain key opening degree control device 50-(M-N) of the Mth printing unit, memories M54 to M57, in addition to a CPU 51, a RAM 52 and a ROM 53, are connected through a bus 60, together with an I/O device 58 and an interface 59. In the memory M54, a received ink fountain key opening degree is stored. In the memory M55, a target ink fountain key opening degree is stored. In the memory M56, a count value of a counter is stored. In the memory M57, a current ink fountain key opening degree is stored.

A motor 61 for driving the ink fountain key is connected to the I/O device 58 through a motor driver 62 for driving the ink fountain key. Moreover, a rotary encoder 63 for the motor for driving the ink fountain key is also connected to the I/O device 58 through a counter 64, the rotary encoder 63 being connected to and driven by the motor 61 for driving the ink fountain key. A detection signal from the rotary encoder 63 for the motor for driving the ink fountain key is also inputted to the motor driver 62 for driving the ink fountain key. Furthermore, the ink supply amount control device 30 is connected to the interface 59.

As shown in FIG. 30, in each of the first ink fountain roller rotation speed control device 70-1 to the Mth ink fountain roller rotation speed control device 70-M, memories M74 and M75, in addition to a CPU 71, a RAM 72 and a ROM 73, are connected through a bus 78, together with an I/O device 76 and an interface 77. In the memory M74, a received ink fountain roller rotation speed is stored. In the memory M75, a target ink fountain roller rotation speed is stored.

A motor 79 for driving the ink fountain roller is connected to the I/O device 76 through a motor driver 80 for driving the ink fountain roller. Moreover, a rotary encoder 81 for the motor for driving the ink fountain roller is also connected to the I/O device 76 through an F/V converter 82 and an A/D converter 83, the rotary encoder 81 being connected to and driven by the motor 79 for driving the ink fountain roller. A detection signal from the rotary encoder 81 for the motor for driving the ink fountain roller is also inputted to the motor driver 80 for driving the ink fountain roller. Furthermore, the ink supply amount control device 30 is connected to the interface 77.

In the fourth embodiment, the opening degrees of the ink fountain keys 3 (3-1 to 3-n) in the ink supply device in the printing unit of each color can be adjusted (compensated) automatically on the basis of a measurement result obtained by the line-portion area measuring camera 44A serving as area measurement means for measuring the area of the line portion printed on paper W, by using the ink supply amount control device 30 (including the first ink fountain key opening degree control device 50-(1-1) of the first printing unit to the Nth ink fountain key opening degree control device 50-(M-N) of the Mth printing unit and the first ink fountain roller rotation speed control device 70-1 to the Mth ink fountain roller rotation speed control device 70-M, to be exact).

The line-portion area measuring camera 44A is configured of a CCD camera or the like, and is provided above the main body of an unillustrated external checking apparatus so as to be able to move in the vertical directions and the horizontal directions by means of a motor for vertical movement, a motor for horizontal movement, and the like. As shown in FIGS. 38(a) to 38(c), the line-portion area measuring camera 44A can directly measure the area of the line portion (the region indicated by hatching in each of FIGS. 38(a) to 38(c)) printed on the paper (print member) W placed on the main body of the checking apparatus (for details, refer to operation flowcharts to be described later). In FIGS. 38(a) to 38(c), LWF denotes a reference line width.

The ink supply amount control device 30 is configured as described above, and operates as in the operation flow shown in FIGS. 31(a) to 31(c), FIGS. 32(a) to 32(d), FIGS. 33(a) to 33(c), and FIG. 34.

Firstly, in Step P1, it is determined whether or not the ink color ICm of the printing unit M and an image area ratio IRmn of a range corresponding to each ink fountain key have been inputted. When the determination in Step P1 is YES, in Step P2, the ink color ICm of the printing unit M and the image area ratio IRmn of the range corresponding to each ink fountain key are inputted and stored respectively in the memories M1 and M2. On the other hand, when the determination in Step P1 is NO, the process proceeds to Step P3.

Then, in Step P3, it is determined whether or not an ink preset switch has been turned on. When the determination in Step P3 is YES, in Step P4, 1 is written in the count value M in the memory M3. When the determination in Step P3 is NO, the process proceeds to Step P30.

In Step P5, 1 is written in the count value N in the memory M4. Thereafter, in Step P6, the ink color ICm of the printing unit M is read from the memory M1. Then, in Step P7, the conversion table between an image area ratio corresponding to the ink color ICm and an ink fountain key opening degree is read from the memory M5.

In Step P8, the image area ratio IRmn of the range corresponding to the Nth ink fountain key of the printing unit M is read from the memory M2. Thereafter, in Step P9, the opening degree Kmn of the Nth ink fountain key of the printing unit M is obtained from the image area ratio IRmn of the range corresponding to the Nth ink fountain key of the printing unit M by using the conversion table between an image area ratio corresponding to the ink color ICm and an ink fountain key opening degree, and is then stored in the Nth address location for the printing unit M in the memory M6 for storing the opening degree Kmn of each ink fountain key.

In Step P10, the count value N in the memory M4 is incremented by 1, and is then overwritten with the resultant value. Thereafter, in Step P11, the total number Nmax of the ink fountain keys of each printing unit is read from the memory M7. Then, in Step P12, it is determined whether or not the count value N is larger than the total number Nmax of the ink fountain keys of each printing unit.

When the determination in Step P12 is YES, in Step P13, the count value M in the memory M3 is incremented by 1, and is then overwritten with the resultant value. On the other hand, when the determination in Step P12 is NO, the process returns to Step P6. Thereafter, in Step P14, the total number Mmax of the printing units is read from the memory M10. Then, in Step P15, it is determined whether or not the count value M is larger than the total number Mmax of the printing units.

When the determination in Step P15 is YES, in Step P16, 1 is written in the count value M in the memory M3. On the other hand, when the determination in Step P15 is NO, the process returns to Step P5. Thereafter, in Step P17, 1 is written in the count value N in the memory M4. Then, in Step P18, the opening degree Kmn of the Nth ink fountain key of the printing unit M is read from the memory M6.

Then, in Step P19, the ink fountain key opening degree Kmn is transmitted to the Nth ink fountain key opening degree control device of the printing unit M. Thereafter, when a reception confirmation signal is received from the Nth ink fountain key opening degree control device of the printing unit M in Step P20, in Step P21, the count value N in the memory M4 is incremented by 1, and is then overwritten with the resultant value.

In Step P22, the total number Nmax of the ink fountain keys of each printing unit is read from the memory M7. Thereafter, in Step P23, it is determined whether or not the count value N is larger than the total number Nmax of the ink fountain keys of each printing unit. When the determination in Step P23 is YES, in Step P24, the ink color ICm of the printing unit M is read from the memory M1. On the other hand, when the determination in Step P23 is NO, the process returns to Step P18.

In Step P25, the reference ink fountain roller rotation speed ratio IFRRFm corresponding to the ink color ICm is read from the memory M8. Thereafter, in Step P26, the reference ink fountain roller rotation speed ratio IFRRFm corresponding to the ink color ICm is written in the address for the printing unit M in the memory M9 for storing the ink fountain roller rotation speed ratio IFRRm.

In Step P27, the count value M in the memory M3 is incremented by 1, and is then overwritten with the resultant value. Thereafter, in Step P28, the total number Mmax of the printing units is read from the memory M10. Then, in Step P29, it is determined whether or not the count value M is larger than the total number Mmax of the printing units. When the determination in Step P29 is YES, the process proceeds to Step P30. On the other hand, when the determination in Step P29 is NO, the process returns to Step P17.

Through the above-described steps, the opening degree Kmn of each ink fountain key is transmitted to the corresponding one of the ink fountain key opening degree control devices 50-(1-1) to 50-(M-N), and a preset value of each ink fountain roller rotation speed ratio IFRRm is obtained.

In Step P30, it is determined whether or not a line-portion area measurement switch has been turned on. When the determination in Step P30 is YES, 1 is written in the count value M in the memory M3 in Step P31a, and 1 is written in the count value N in the memory M4 in Step P31b. On the other hand, when the determination in Step P30 is NO, the process proceeds to Step P110.

In Step P32, the value of the counter 92A for measuring the current position of the line-portion area measuring camera in the vertical directions is read, and is then stored in the memory M11a. Thereafter, in Step P33, the current position of the line-portion area measuring camera 44A in the vertical directions is calculated from the read value of the counter 92A for measuring the current position of the line-portion area measuring camera in the vertical directions, and is then stored in the memory M12a.

In Step P34, the position of the Nth line portion in the ink color ICm, to be measured by the line-portion area measuring camera, in the vertical directions is read from the memory M13a. Thereafter, in Step P35, it is determined whether or not the current position of the line-portion area measuring camera 44A in the vertical directions is equal to the position of the Nth line portion in the ink color ICm, to be measured by the line-portion area measuring camera, in the vertical directions. When the determination in Step P35 is YES, the process proceeds to Step P49. On the other hand, when the determination in Step P35 is NO, it is determined, in Step P36, whether or not the current position of the line-portion area measuring-camera 44A in the vertical directions is lower than the position of the Nth line portion in the ink color ICm, to be measured by the line-portion area measuring camera, in the vertical directions.

When the determination in Step P36 is YES, in Step P37, a normal rotation instruction is outputted to the motor driver 90A for vertical movement for line-portion area measurement. Thereafter, in Step P38, the value of the counter 92A for measuring the current position of the line-portion area measuring camera in the vertical directions is read, and is then stored in the memory M11a.

In Step P39, the current position of the line-portion area measuring camera 44A in the vertical directions is calculated from the read value of the counter 92A for measuring the current position of the line-portion area measuring camera in the vertical directions, and is then stored in the memory M12a. Thereafter, in Step P40, the position of the Nth line portion in the ink color ICm, to be measured by the line-portion area measuring camera, in the vertical directions is read from the memory M13a.

In Step P41, it is determined whether or not the current position of the line-portion area measuring camera 44A in the vertical directions is equal to the position of the Nth line portion in the ink color ICm, to be measured by the line-portion area measuring camera, in the vertical directions. When the determination in Step P41 is YES, in Step P42, the output of the normal rotation instruction to the motor driver 90A for vertical movement for line-portion area measurement is stopped. Thereafter, the process proceeds to Step P49. On the other hand, when the determination in Step P41 is NO, the process returns to Step P38.

When the determination in Step P36 is NO, in Step P43, a reverse rotation instruction is outputted to the motor driver 90A for vertical movement for line-portion area measurement. Thereafter, in Step P44, the value of the counter 92A for measuring the current position of the line-portion area measuring camera in the vertical directions is read, and is then stored in the memory M11a.

In Step P45, the current position of the line-portion area measuring camera 44A in the vertical directions is calculated from the read value of the counter 92A for measuring the current position of the line-portion area measuring camera in the vertical directions, and is then stored in the memory M12a. Thereafter, in Step P46, the position of the Nth line portion in the ink color ICm, to be measured by the line-portion area measuring camera, in the vertical directions is read from the memory M13a.

In Step P47, it is determined whether or not the current position of the line-portion area measuring camera 44A in the vertical directions is equal to the position of the Nth line portion in the ink color ICm, to be measured by the line-portion area measuring camera, in the vertical directions. When the determination in Step P47 is YES, in Step P48, the output of the reverse rotation instruction to the motor driver 90A for vertical movement for line-portion area measurement is stopped. Thereafter, the process proceeds to Step P49. On the other hand, when the determination in Step P47 is NO, the process returns to Step P44.

In Step P49, the value of the counter 97A for measuring the current position of the line-portion area measuring camera in the horizontal directions is read, and is then stored in the memory M14a. Thereafter, in Step P50, the current position of the line-portion area measuring camera 44A in the horizontal directions is calculated from the read value of the counter 97A for measuring the current position of the line-portion area measuring camera in the horizontal directions, and is then stored in the memory M15a.

In Step P51, the position of the Nth line portion in the ink color ICm, to be measured by the line-portion area measuring camera, in the horizontal directions is read from the memory M16a. Thereafter, in Step P52, it is determined whether or not the current position of the line-portion area measuring camera 44A in the horizontal directions is equal to the position of the Nth line portion in the ink color ICm, to be measured by the line-portion area measuring camera, in the horizontal directions. When the determination in Step P52 is YES, the process proceeds to Step P66. On the other hand, when the determination in Step P52 is NO, it is determined, in Step P53, whether or not the current position of the line-portion area measuring camera 44A in the horizontal directions is smaller than the position of the Nth line portion in the ink color ICm, to be measured by the line-portion area measuring camera, in the horizontal directions.

When the determination in Step P53 is YES, in Step P54, a normal rotation instruction is outputted to the motor driver 95A for horizontal movement for line-portion area measurement. Thereafter, in Step P55, the value of the counter 97A for measuring the current position of the line-portion area measuring camera in the horizontal directions is read, and is then stored in the memory M14a.

In Step P56, the current position of the line-portion area measuring camera 44A in the horizontal directions is calculated from the read value of the counter 97A for measuring the current position of the line-portion area measuring camera in the horizontal directions, and is then stored in the memory M15a. Thereafter, in Step P57, the position of the Nth line portion in the ink color ICm, to be measured by the line-portion area measuring camera, in the horizontal directions is read from the memory M16a.

In Step P58, it is determined whether or not the current position of the line-portion area measuring camera 44A in the horizontal directions is equal to the position of the Nth line portion in the ink color ICm, to be measured by the line-portion area measuring camera, in the horizontal directions. When the determination in Step P58 is YES, in Step P59, the output of the normal rotation instruction to the motor driver 95A for horizontal movement for line-portion area measurement is stopped. Thereafter, the process proceeds to Step P66. On the other hand, when the determination in Step P58 is NO, the process returns to Step P55.

When the determination in Step P53 is NO, in Step P60, a reverse rotation instruction is outputted to the motor driver 95A for horizontal movement for line-portion area measurement. Thereafter, in Step P61, the value of the counter 97A for measuring the current position of the line-portion area measuring camera in the horizontal directions is read, and is then stored in the memory M14a.

In Step P62, the current position of the line-portion area measuring camera 44A in the horizontal directions is calculated from the read value of the counter 97A for measuring the current position of the line-portion area measuring camera in the horizontal directions, and is then stored in the memory M15a. Thereafter, in Step P63, the position of the Nth line portion in the ink color ICm, to be measured by the line-portion area measuring camera, in the horizontal directions is read from the memory M16a.

In Step P64, it is determined whether or not the current position of the line-portion area measuring camera 44A in the horizontal directions is equal to the position of the Nth line portion in the ink color ICm, to be measured by the line-portion area measuring camera, in the horizontal directions. When the determination in Step P64 is YES, in Step P65, the output of the reverse rotation instruction to the motor driver 95A for horizontal movement for line-portion area measurement is stopped. Thereafter, the process proceeds to Step P66. On the other hand, when the determination in Step P64 is NO, the process returns to Step P61.

In Step P66, a measurement signal is outputted to the line-portion area measuring camera 44A. Thereafter, in Step P67a, a binary image signal is received from the line-portion area measuring camera 44A, and is then stored in the Nth address location for the ink color ICm in the frame memory M17.

In Step P67b, the count value N in the memory M4 is incremented by 1, and is then overwritten with the resultant value. Thereafter, in Step P67c, the total number Nmax of the ink fountain keys of each printing unit is read from the memory M7. Then, in Step P67d, it is determined whether or not the count value N is larger than the total number Nmax of the ink fountain keys of each printing unit. When the determination in Step P67d is YES, the process proceeds to Step P68. On the other hand, when the determination in Step P67d is NO, the process returns to Step P32.

In Step P68, the count value M in the memory M3 is incremented by 1, and is then overwritten with the resultant value. Thereafter, in Step P69, the total number Mmax of the printing units is read from the memory M10. Then, in Step P70, it is determined whether or not the count value M is larger than the total number Mmax of the printing units.

When the determination in Step P70 is YES, a reverse rotation instruction is outputted to the motor driver 95A for horizontal movement for line-portion area measurement in Step P71. On the other hand, when the determination in Step P70 is NO, the process returns to Step P31b.

When an output of the detector 99A for detecting the home position of the line-portion area measuring camera 44A in the horizontal directions is turned on in Step P72, in Step P73, the output of the reverse rotation instruction to the motor driver 95A for horizontal movement for line-portion area measurement is stopped. In Step P74, a reverse rotation instruction is outputted to the motor driver 90A for vertical movement for line-portion area measurement.

When an output of the detector 94A for detecting the home position of the line-portion area measuring camera 44A in the vertical directions is turned on in Step P75, in Step P76, the output of the reverse rotation instruction to the motor driver 90A for vertical movement for line-portion area measurement is stopped.

Through the above-described steps, the binary image signal of the line portion, corresponding to each ink fountain key, in each ink color ICm, is received from the line-portion area measuring camera 44A.

In Step P77a, 1 is written in the count value M in the memory M3. Thereafter, in Step P77b, 1 is written in the count value N in the memory M4. Then, in Step P78, 0 is written in the memory M40 for storing the count value IAC for printed-portion area measurement.

In Step P79, 1 is written in the count value Yin the memory M18. Thereafter, in Step P80, 1 is written in the count value X in the memory M19. Then, in Step P81, the ink color ICm of the printing unit M is read from the memory M1.

In Step P82, an image data Ixy of the Nth address (X,Y) for the ink color ICm is read from the frame memory M17. Thereafter, in Step P83, it is determined whether or not the image data Ixy is 1. When the determination in Step P83 is YES, in Step P84, the count value IAC for printed-portion area measurement is read from the memory M40. On the other hand, when the determination in Step P83 is NO, the process proceeds to Step P86.

In Step P85, the count value IAC for printed-portion area measurement is incremented by 1, and the memory M40 for storing the count value IAC for printed-portion measurement is overwritten with the resultant value. Thereafter, in Step P86, the count value X in the memory M19 is incremented by 1, and is then overwritten with the resultant value.

In Step P87, the total number DPXmax of pixels detected in the horizontal directions of the line-portion area measuring camera 44A is read from the memory M21a. Thereafter, in Step P88, it is determined whether or not the count value X is larger than the total number DPXmax of pixels detected in the horizontal directions of the line-portion area measuring camera. When the determination in Step P88 is YES, in Step P89, the count value Y in the memory M18 is incremented by 1, and is then overwritten with the resultant value. On the other hand, when the determination in Step P88 is NO, the process returns to Step P81.

In Step P90, the total number DPYmax of pixels detected in the vertical directions of the line-portion area measuring camera is read from the memory M22a. Thereafter, in Step P91, it is determined whether or not the count value Y is larger than the total number DPYmax of pixels detected in the vertical directions of the line-portion area measuring camera. When the determination in Step P91 is YES, the process proceeds to Step P92. On the other hand, when the determination in Step P91 is NO, the process returns to Step P80.

In Step P92, the count value IAC for printed-portion area measurement is read from the memory M40. Thereafter, in Step P93, the area IA of the Nth printed portion of the printing unit M is calculated from the count value IAC of printed-portion area measurement, and is then stored in the Nth address location for the printing unit M in the memory M41.

In Step P94, the printed-portion reference area IAF is read from the memory M42. Thereafter, in Step P95, the area difference IAD of the Nth printed portion of the printing unit M is calculated by subtracting the printed-portion reference area IAF from the area IA of the Nth printed portion of the printing unit M, and is then stored in the Nth address location for the printing unit M in the memory M43.

In Step P96, the ink color ICm of the printing unit M is read from the memory M1. Thereafter, in Step P97, the conversion table between printed-portion area difference of the ink color ICm and an ink fountain key opening degree Km is read from the memory M45.

In Step P98, the compensation ratio of the opening degree Km of the Nth ink fountain key of the printing unit M is obtained from the area difference IAD of the Nth printed portion of the printing unit M by using the conversion table between printed-portion area difference of the ink color ICm and a compensation ratio of an ink fountain key opening degree Km, and is then stored in the Nth address location for the printing unit M in the memory M38. Thereafter, in Step P99, the opening degree Kmn of the Nth ink fountain key of the printing unit M is read from the memory M6.

In Step P100, a target opening degree Kmn of the Nth ink fountain key of the printing unit M is obtained by multiplying the opening degree Kmn of the Nth ink fountain key of the printing unit M by the compensation ratio of the opening degree Kmn of the Nth ink fountain key of the printing unit M, and is then stored in the Nth address location of the printing unit M in the memory M39. Thereafter, in Step P101, the target opening degree Kmn of the Nth ink fountain key of the printing unit M is stored in the Nth address location of the printing unit M in the memory M6 for storing the ink fountain key opening degree Kmn.

In Step P102, the opening degree Kmn of the Nth ink fountain key of the printing unit M is transmitted to the Nth ink fountain key opening degree control devices 50-(1-1) to 50-(M-N) of the printing unit M. Thereafter, when a reception confirmation signal has been received from each of the Nth ink fountain key opening degree control devices 50-(1-1) to 50-(M-N) of the printing unit M in Step P103, in Step P104, the count value N in the memory M4 is incremented by 1, and is then overwritten with the resultant value.

In Step P105, the total number Nmax of the ink fountain keys is read from the memory M7. Thereafter, in Step P106, it is determined whether or not the count value N is larger than the total number Nmax of the ink fountain keys. When the determination in Step P106 is YES, in Step P107 the count value M in the memory M3 is incremented by 1, and is then overwritten with the resultant value. On the other hand, when the determination in Step P106 is NO, the process returns to Step P78.

In Step P108, the total number Mmax of the printing units is read from the memory M10. Thereafter, in Step P109, it is determined whether or not the count value M is larger than the total number Mmax of the printing units. When the determination in Step P109 is YES, the process returns to Step P1. On the other hand, when the determination in Step P109 is NO, the process returns to Step P77b.

Through the above-described steps, the opening degree Kmn of each ink fountain key of each printing unit is set at the opening degree compensated in accordance with the difference of area of the corresponding line portion.

When the determinations in Step P1, Step P3 and Step P30 are NO, in Step P110, 1 is written in the count value M in the memory M3. Thereafter, in Step P111, an output of the A/D converter 45 connected to the rotary encoder 47 for the drive motor of the printing press is read, and is stored in the memory M32. Then, in Step P112, the current rotation speed R of the printing press is calculated from the output of the A/D converter 45 connected to the rotary encoder 47 for the drive motor of the printing press, and is then stored in the memory M33.

In Step P113, the ink fountain roller rotation speed ratio IFRRm of the printing unit M is read from the memory M9. Thereafter, in Step P114, the ink fountain roller rotation speed IFRm of the printing unit M is calculated by multiplying the current rotation speed R of the printing press by the ink fountain roller rotation speed ratio IFRRm of the printing unit M, and is then stored in the address location for the printing unit M in the memory M34.

In Step P115, the ink fountain roller rotation speed IFRm of the printing unit M is transmitted to the ink fountain roller rotation speed control device of the printing unit M. Thereafter, when a reception confirmation signal is transmitted from the ink fountain roller rotation speed control device of the printing unit M in Step P116, the count value M in the memory M3 is incremented by 1, and is then overwritten with the resultant value, in Step P117.

In Step P118, the total number Mmax of the printing units is read from the memory M10. Thereafter, in Step P132, it is determined whether or not the count value M is larger than the total number Mmax of the printing units. When the determination in Step P132 is YES, the process returns to Step P1. On the other hand, when the determination in Step P132 is NO, the process returns to Step P111. Thereafter, this process is repeated.

Through the above-described steps, the rotation speed IFRm of each ink fountain roller according to the current rotation speed R of the printing press is transmitted to the corresponding one of the ink fountain roller rotation speed control devices 70-1 to 70-M.

The first ink fountain key opening degree control device 50-(1-1) of the first printing unit to the Nth ink fountain key opening degree control device 50-(M-N) of the Mth printing unit each operate as in the operation flow shown in FIGS. 35A and 35B.

Specifically, when an ink fountain key opening degree Kmn is transmitted from the ink supply amount control device 30 in Step P1, in Step P2, the ink fountain key opening degree Kmn is received, and is then stored in the memory M54 for storing the received ink fountain key opening degree Kmn. Thereafter, in Step P3, a reception confirmation signal is transmitted to the ink supply amount control device 30.

In Step P4, the received ink fountain key opening degree Kmn is written in the memory M55 for storing the target ink fountain key opening degree (position). Thereafter, in Step P5, the count value of the counter 64 is read, and is then stored in the memory M56. Then, in Step P6, the current ink fountain key opening degree (position) is calculated from the count value of the counter 64, and is then stored in the memory M57.

In Step P7, it is determined whether or not the target position of the ink fountain key is equal to the current position of the ink fountain key. When the determination in Step P7 is YES, the process returns to Step P1. On the other hand, when the determination in Step P7 is NO, it is determined, in Step P8, whether or not the target position of the ink fountain key is larger than the current position of the ink fountain key.

When the determination in Step P8 is YES, in Step P9 a normal rotation instruction is outputted to the motor driver 62 for driving the ink fountain key. When the determination in Step P8 is NO, in Step P10, a reverse rotation instruction is outputted to the motor driver 62 for driving the ink fountain key.

In Step P11, the count value of the counter 64 is read, and is then stored in the memory M56. Thereafter, in Step P12, the current position of the ink fountain key is calculated from the count value of the counter 64, and is then stored in the memory M57.

In Step P13, it is determined whether or not the current position of the ink fountain key is equal to the target position of the ink fountain key. When the determination in Step P13 is YES, in Step P14 a stop instruction is outputted to the motor driver 62 for driving the ink fountain key. Then, the process returns to Step P1. When the determination in Step P13 is NO, the process returns to Step P11. Thereafter, this process is repeated.

The first ink fountain roller rotation speed control device to the Mth ink fountain roller rotation speed control device each operate as in the operation flow shown in FIG. 36.

Specifically, when an ink fountain roller rotation speed IFRm is transmitted from the ink supply amount control device 30 in Step P1, in Step P2, the ink fountain roller rotation speed IFRm is received, and is then stored in the memory M74 for storing the received ink fountain roller rotation speed IFRm. Thereafter, in Step P3, a reception confirmation signal is transmitted to the ink supply amount control device 30.

In Step P4, the received ink fountain roller rotation speed IFRm is written and stored in the memory M75 for storing the target ink fountain roller rotation speed. Thereafter, in Step P5, the target ink fountain roller rotation speed is read from the memory M75.

In Step P6, a rotation speed instruction of the target ink fountain roller rotation speed is outputted to the motor driver 80 for driving the ink fountain roller. Then, the process returns to Step P1. Thereafter, this process is repeated.

As described above, in the fourth embodiment, the area of the printed line portion is measured by the line-portion area measuring camera 44A. Then, the ink supply amount control device 30 (or the ink fountain key opening degree control devices 50-(1-1) to 50-(M-N), to be exact) controls the drive of the motor 61 on the basis of the measurement result. Thereby, the opening degrees of the ink fountain keys 3 (3-1 to 3-n) are automatically adjusted. With this configuration, it is possible to avoid anticipated troubles due to an oversupply or undersupply of ink. The troubles are for example, that ink spreads to the outside of the printing pattern, and that a portion of the pattern is not printed. Consequently, it is possible to reduce the burden of the operator, and also to reduce the amount of waste paper to be produced, by preventing errors in manual adjustment.

It should be noted that the present invention is not limited to the above-described embodiments, and it is obvious that various modifications are possible without departing from the scope of the present invention. For example, in the first embodiment, the ink supply amount control device 30 (or ink fountain roller rotation speed control device 70-1 to 70-M, to be exact) may be configured to control the drive of the motor 79 on the basis of the average width of the printed line portion, and thereby to automatically adjust the rotation speed of the ink fountain roller 4. Moreover, in the second embodiment, the ink supply amount control device 30 (or ink fountain key opening degree control devices 50-(1-1) to 50-(M-N), to be exact) may be configured to control the drive of the motor 61 on the basis of the maximum width of the printed line portion, and thereby to automatically adjust the opening degrees of the ink fountain keys 3(3-1 to 3-n).

What is claimed is:

1. An ink supply amount adjustment method for a relief printing press including: an ink storage in which ink is stored; and ink supply amount adjustment means for adjusting the amount of ink to be supplied from the ink storage, the ink supply amount adjustment method comprising:
measuring the width of a line portion printed on a print member by the relief printing press; and
controlling the ink supply amount adjustment means on the basis of the width of the line portion thus measured.

2. An ink supply amount adjustment method for a relief printing press including: an ink storage in which ink is stored; and ink supply amount adjustment means for adjusting the amount of ink to be supplied from the ink storage, the ink supply amount adjustment method comprising:
measuring the area of a printed portion printed on a predetermined section of a printed member by using the relief printing press; and
controlling the ink supply amount adjustment means on the basis of the area of the printed portion thus measured.

3. An ink supply amount adjustment system for a relief printing press including: an ink storage in which ink is stored; and ink supply amount adjustment means for adjusting the amount of ink to be supplied from the ink storage, the ink supply amount adjustment system comprising:
width measurement means for measuring the width of a line portion printed on a print member by the relief printing press; and
control means for controlling the ink supply amount adjustment means on the basis of the width of the line portion measured by the width measurement means.

4. An ink supply amount adjustment system for a relief printing press including: an ink storage in which ink is stored; and ink supply amount adjustment means for adjusting the amount of ink to be supplied from the ink storage, the ink supply amount adjustment system comprising:
area measurement means for measuring the area of a printed portion printed on a predetermined section of a printed member by using the relief printing press; and
control means for controlling the ink supply amount adjustment means on the basis of the area of the printed portion measured by the area measurement means.

5. A relief printing press, comprising:
an ink storage in which ink is stored;
ink supply amount adjustment means for adjusting the amount of ink to be supplied from the ink storage;
width measurement means for measuring the width of a line portion printed on a print member by the relief printing press; and
control means for controlling the ink supply amount adjustment means on the basis of the width of the line portion measured by the width measurement means.

6. A relief printing press, comprising:
an ink storage in which ink is stored;
ink supply amount adjustment means for adjusting the amount of ink to be supplied from the ink storage;
area measurement means for measuring the area of a printed portion printed on a predetermined section of a printed member by using the relief printing press; and
control means for controlling the ink supply amount adjustment means on the basis of the area of the printed portion measured by the area measurement means.
